(19) United States
(12) Patent Application Publication
(10) Pub. No.: US 2015/0261541 A1
(43) Pub. Date: Sep. 17, 2015

(54) DYNAMIC REGISTER MACHINE

(71) Applicant: AEMEA, Inc., Las Vegas, NV (US)

(72) Inventor: Michael Stephen Fiske, San Francisco, CA (US)

(73) Assignee: AEMEA, Inc.

(21) Appl. No.: 14/696,467

(22) Filed: Apr. 26, 2015

Related U.S. Application Data
(63) Continuation-in-part of application No. 12/499,749, filed on Sep. 14, 2009, now Pat. No. 9,026,768.

(51) Int. Cl. G06F 9/30

(52) U.S. Cl. CPC G06F 9/30181; G06F 9/30098

(57) ABSTRACT

In one embodiment, a dynamic register machine that edits program instructions while the instructions are running on the machine is disclosed. In another embodiment, an execution node pair machine is disclosed that represents programs as collections of execution node pairs. In another embodiment, computer program instructions are represented as matrices, which are multiplied together to represent sequences of instructions applied to specific input data, which facilitate finding situations resulting in infinite loops having a periodic behavior. In an embodiment, infinite loops in a general computer program are detected, via the dynamic register machine, by exploring combinations of sequences of linked execution-node-pairs, thereby obtaining the results of executing sequence of computer program instructions is disclosed.

### CROSS-REFERENCE TO RELATED APPLICATIONS

This application is a continuation-in-part of U.S. application Ser. No. 12/499,749 (Docket # BP-2), entitled “Executing Machine Instructions Comprising Input/Output Pairs of Execution Node,” filed Sep. 14, 2009, by Michael Stephen Fiske, which is incorporated herein by reference.

### FIELD

This specification generally relates to different types of computers and computing techniques.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Classical Turing machines are well known. However, classical Turing machines rely on a linear tape, and moving to locations beyond the nearest tape positions is time consuming. Consequently, in the prior art, classical Turing machines are thought of as slow machines that are not practical to build. Nonetheless, it can be shown that the operations of any standard register machine may be reduce to that of a Turing machine, and because of the relative mathematical simplicity of computing operations on a classical Turing machine, classical Turing machines are discussed in the prior art primarily on a theoretical basis.

A problem with computers in general is it can be difficult to detect infinite loops. In fact, the undecidability of the Halting Problem suggests that whether or not a program has an infinite loop is not in general predictable a priori. One can make various heuristic tests, such as checking the exit conditions of various loops (of do-while or loop-until clauses) to make sure that it would appear that the loop will eventually exit, and follow certain practices, such as making sure that every loop has an index and every index has a maximum value after which the loop ends, which will reduce the likelihood of inadvertently putting an infinite loop into a program, however, such practices limit the capability of the programs (e.g., perhaps there really is a need to run the loop more time than the self imposed maximum), and are not fool proof.

In conventional computing, a machine runs a computer program, which includes a set of instructions, which does not change while the machine is running. This specification recognizes that the not allowing the computer program to change while the machine is running is constraint that limits the possibilities of what the computer can accomplish. Additionally, increasing the speed at which a computer can perform computations is often desirable.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows and example of a dynamic register machine.

FIG. 2A shows an example of a method of executing the jump instruction of the dynamic register machine of FIG. 1.

FIGS. 2B and 2C show the contents of the registers and the list of instructions in the program before and after the execution of the each instruction.

FIG. 3 shows an example of a method of implement update instruction of the dynamic register machine of FIG. 1.

FIG. 4 shows an example of a Turing machine.

FIG. 5 shows an example of a classical Turning machine tape.

FIG. 6 is an example of Turing machine table.

FIG. 7 shows a Turing machine with tape and tape head.

FIG. 8. shows four tape squares with contents a₁, a₂, a₂, b₁.

FIG. 9 shows a block diagram of a computer having a collection of execution nodes.

FIG. 10 shows an example of an execution node pair 1000 that may be used in the execution node pair machine of FIG. 10.

FIG. 11 shows a flowchart of a method of running an execution node pair machine of FIG. 10

FIG. 12 shows a flowchart of an embodiment of a method of performing overlap matching and edge substitution.

FIG. 13 shows a flowchart of an example of a method of finding prime directed edges.

FIG. 14A shows a more detailed example of a method of finding prime directed edges.

FIG. 14B shows a flowchart of an example of a method for creating a linked list of prime directed edges.

FIG. 15A shows an example of a method for finding immortal periodic points (infinite loops with a periodic behavior).

FIG. 15B shows an example of an execution node pair that copies the a bit string from one memory location associated with one variable to another memory location associated with another variable.

FIG. 15C shows another example of an execution node pair that copies the bit string from one memory location associated with one variable to another memory location associated with another variable.

FIG. 15D shows an example of a table that contains the information for constructing pairs of execution nodes that perform four bit addition.

FIG. 15E shows an example of instantiation of one member of the table in FIG. 15D.

FIG. 15F shows and example of a head node and tail node that adds two numbers.

FIG. 15G shows a table which contains the information for pairs of execution nodes that perform four bit less than operation.

FIG. 15H shows a pair of execution nodes derived from the table in 15G that compares two numbers.

FIG. 15I shows another pair of execution nodes derived from the table in 15G that compares two numbers.

FIG. 16 shows an example of an active element machine.

FIG. 17 shows a block diagram of a machine that may run any of the methods, algorithms, and/or other machine of this specification

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### INTRODUCTION

A new computing machines and new mathematical concepts and methods of computing, executing and solving heretofore unknown computational problems are presented here. One computing machine, called a Dynamic Register Machine, is applied to hardware and software technology. The new machine and methods enable advances in machine learning, new and more powerful programming languages, and more powerful and flexible compilers and interpreters.

A dynamic register machine is described at the beginning of the specification. Towards the end of the specification, the design of a dynamic register machine program presented is explained. Then, a dynamic register machine program, called the IDYNAMIC REGISTER MACHINE, composed of 1590 dynamic register machine instructions is presented that can determine in a finite number of computational steps whether a given periodic Turing machine has any immortal configurations.

The other sections, describe and demonstrate mathematical concepts and computational methods for addressing the Turing Immortality problem for periodic Turing Machines and other computational problems. The Turing Immortality problem is unable to be solved by Turing machines. Furthermore, current computing machine implementations and software applications have been unable to solve this problem and other computing problems.

### Detecting Infinite Loops in Periodic Machine

### Dynamic Register Machine

The undecidability of the Halting Problem states that it cannot be determined by a Turing Machine whether a Turing machine computation has definitive end, which suggests that one cannot develop a system for determining whether a program has an infinite loop. In this section, a dynamic register machine (DYNAMIC REGISTER MACHINE) is presented. Then in a later section a dynamic register machine program is demonstrated that can perform the following computation: for a periodic Turing machine (Q, A, η) as input, the dynamic register machine program can execute method 8.36 in a finite number of computational steps, and presents a method of finding infinite loop exhibiting a periodicity.

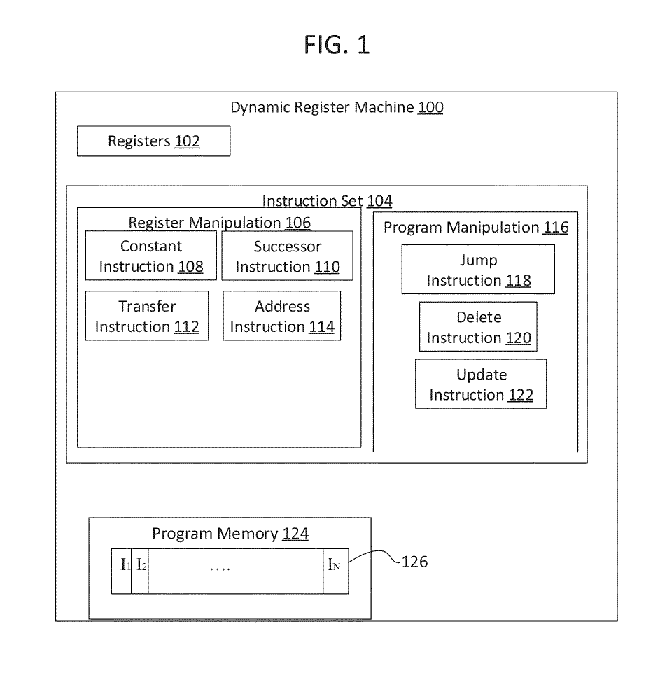

FIG. 1 shows and example of a dynamic register machine 100. Dynamic register machine 100 may include registers 102, set of instructions 104, which may include instructions manipulating data 106, which in turn may include a constant instruction 108, successor instruction 110, transfer instruction 112, and address instruction 114. Set of instructions 104 may also include instructions for program manipulation 116, which in turn may include a jump instruction 118, delete instruction 120, and an update instruction 122. Dynamic register machine 100 may also include program memory 124, which may include program 126. In other embodiments, dynamic register machine 100 may include additional components and/or may not include all of the components listed above.

The dynamic register machine 100 is a new computing machine in which the program that is running on the dynamic register machine can change while the machine is executing. While the program is being executing, new instructions may be added to the program and/or instructions may be removed from the program. Dynamic register machine 100 is an enhancement of the register machine (John L. Hennessy and David A. Patterson. Computer Architecture. A Quantitative Approach. Fifth Edition. Elsevier, 2012). By allowing the programs to change mid-execution, the dynamic register machine 100 has fewer constraints on the types of operations that may be performed, which give the programmer more flexibility. Further, the program may become harder to understand, which may be useful in deterring malware and hackers.

Registers 102 are registers used for storing data, which a program running on dynamic register machine 100 operates. For example, if the program is a word processor, such as MS Word® or WordPerfect®, the data may include files that are documents prepared by the program. In an embodiment, registers 102 of the dynamic register machine 100 has a large enough number of registers, such that there are more registers than are needed for executing a program of interest, so that the number of registers is effectively unbounded. In this specification, the registers may be labeled R₀, R₁, R₂, . . . each of which contains a natural number. In an alternative embodiment, some of the registers may contain other symbols. In an embodiment, the formal language for the dynamic register machine is represented as S-expressions: register Rₙ as (R n). The contents of all of the registers may be represented as a list of natural numbers, for example (17 3 22 5 . . . ), which are the contents of registers R₀, R₁, R₂, R₃, . . . , respectively, which may also be written as registers, (R 0), (R 1), (R 2), (R 3), . . . , respectively.

Set of instructions 104 are the basic set of instructions that are native to dynamic register machine 100. For example, set of instructions 104 may be hardwired and/or preprogrammed into the processor of dynamic register machine 104 or hardwired preprogrammed into the dynamic register machine in other ways.

Instructions manipulating data 106 may include those instructions that manipulate the data stored in registers 104. In an embodiment, the instructions can be divided into two categories—the first category is instructions that affect the content of the registers that store data, instructions manipulating data 106, and the second category is instructions that affect the lines of the program, which will be discussed below. A finite sequence of instructions is a dynamic register machine program, which maybe denoted as P. In an embodiment, the formal language for the dynamic register machine is represented as S-expressions: register Rₙ as (R n).

### Constant Instruction 108 (Instruction #1)

In an embodiment, there may be a Constant Instruction 108 writes a constant value to one of the registers. For example, Constant Instruction 108 may be represented as (C m v). For each pair of natural numbers m and v, the constant instruction 108 (C m v) stores natural number v in register (R m) i.e. the contents of register Rₘ=v.

For example, if the contents of the registers are (17 2 671 3 81 95 . . . ), then the instruction (C 1 55) stores 55 in register (R 1). Afterward, the contents of the registers are (17 55 671 3 81 95 . . . ).

### Successor Instruction 110 (S M) (Instruction #2)

Successor instruction 108 adds a 1 to the value of a register. For example, for natural number m, the successor instruction110 (S m) adds 1 to register (R m). For example, if the current state of the registers is (26 0 2 678 12 78 . . . ) then the instruction (S 3) adds 1 to 678 so the register contents afterward are (26 0 2 679 12 78 . . . ).

### Transfer Instruction 112 (T M N) (Instruction #3)

Transfer instruction 112 performs a copy operation. Transfer instruction 112 reads the value of a first register and writes the value read to a second register. For example, for natural numbers m, n the transfer instruction 100 (T m n) may copy the contents of register (R n) to register (R m), while leaving all other registers unchanged. If the current state of the registers is (17 0 2 679 3 81 . . . ) then the instruction (T 0 4) replaces (R 0) containing 17 with (R 4) which is 3 so the register contents are now (3 0 2 679 3 81 . . . ).

### Address Instruction 114 (A m n) (Instruction #4)

Address instruction 114 is also a copy instruction, but instead of the register being copied a fixed register, the value of the address of the register being copied is effectively a variable. For example, the address instruction stores 114 the destination address in another register. In an embodiment, for natural numbers m, n the address instruction 114 (A m n) copies the contents of register (R (R n)) to register (R m). Thus, if at a first instance of executing (A m n) the value stored register (R n) is 3, the content of register (R 3) is copied to register (R m), if at a first instance of executing (A m n) the value stored register (R n) is 14, the content of register (R 14) is copied to register (R m). All other registers are left unchanged.

If the current state of the registers is (17 0 2 679 3 81 . . . ) then (R 4)=3 and (R (R 4))=679. Thus, instruction (A 5 4) replaces (R 5) containing 81 with 679. After the execution of instruction (A 5 4) the register contents are (17 0 2 679 3 679 . . . ).

Program manipulation 116 are instructions that manipulate a program, thereby changing the manner in which the program runs, even while the program is in the midst of running.

Allowing the program to edit itself allows the program to perform tasks that a Turing machine cannot perform and facilitates machine learning. For instance, the program can experiment with random and/or carefully planned variations of its own code, perform tests, collect data on the performance of the code with the variations to provide metrics, so that the program can gauge whether the change was an improvement or a degradation of the program's performance, and then based on the metrics, reject or accept the change.

For example, similar to the android, Data from StarTrek®, building his own emotion algorithm/chip and then installing that algorithm/chip into himself, while he is still running, a bot programmed for interacting with humans could optically scan facial expressions, sense changes in the human's body temperature, acoustically detect changes heart beat, detect different degrees of perspiration, and/or detect changes in body odor, for example, as the program is interacting with the human. Then based on pattern recognition and/or other criteria, the program could determine whether the human is responding positively or negatively to the tone of voice, volume of the voice, other qualities of the voice, particular wording of the statements, images displayed to the human while the human is interacting with the program, and/or types of output provided to the human.

Based on the human response, the program can then determine whether the program is interacting with the human in a manner that the human finds pleasant, distasteful, humorous, relaxing, and/or stressful, for example. Next, the program could change those aspects and/or variations to attempt to better achieve the desired result as measured by the facial expression of the human.

### Jump Instruction 118 (J M N Q) (Instruction #5)

Jump instruction 118 changes which instruction will execute next. For example, for natural numbers m, n, q, if the contents of register Rₘ equals the contents of register Rₙ i.e. (R m)=(R n), then the jump instruction 118 (J m n q) causes the program execution to jump to the instruction stored in (R q) i.e. the contents of register R_{q}. Otherwise, if (R m)≠(R n) the next instruction following instruction (J m n q) is executed. In the special case where (R q) is beyond the last instruction in program P, then the execution of program P terminates (halts).

### Delete Instruction 120 (D M N) (Instruction #6)

Delete instruction 120 deletes the contents of a user-specified number of instructions of a program. Deleting the instructions of a program may simply involve changing a pointer associated with the prior instruction from pointing to the deleted instructions to pointing to a different instruction. For example, delete instruction 120 (D M N) reads the value, v, stored in register (R n), then starting with instruction (R m) delete instruction 114 (D M N) deletes the next v instructions. If the value of (R n), v=0, then no instructions are deleted.

If (R n)+(R m)−1 points to or is beyond the last instruction of the current program P, then the execution of delete instruction 120 (D m n) deletes instruction (R m) and all of the instructions in program P that follow instruction (R m). As a consequence, if the last instruction deleted is the end of the program and if the first instruction deleted precedes, includes, or immediately follows instruction (D m n) the execution of program P will halt, because after executing instruction (D m n) the program attempts to execute the next instruction, but there is no next instruction.

### Update Instruction 122 (U k n q) (Instruction #7)

At execution time, the update instruction 122 (U k n q) inserts (R n) instructions at line (R q) into program P. The information determining the type of instructions and the arguments for the instructions are taken from a series of registers, starting with register k according to the following rules:
The (R n) inserted instructions and their corresponding arguments are determined by (R k), (R k+1), (R k+2), . . . [the contents of registers k, k+1, k+2, . . . ] until (R n) instructions are completely determined.
If (R n)=0, then no instructions are inserted.
The type of the inserted instruction is determined by the table of equivalence classes:

| C | S | T | A | J | D | U |
|---|---|---|---|---|---|---|
| [0] | [1] | [2] | [3] | [4] | [5] | [6] |

where [n]={m: m is a natural number and 7 divides m}
The contents of register k, (R k), lies in exactly one of the table entries [0], [1], [2], [3], [4], [5], [6]. Thus, the type of instruction is unambiguously determined by the previous table from the value in register (R k).
The 1^{st} argument m in (C m n), (S m), (T m n), (A m n), (J m n q), (D m n), (U m n q) is determined by (R k+1), which is the contents of register k+1.
If the value stored in register (R n)>1 and it is a Successor instruction, then the contents of register k+2 determine the type of the second instruction. Otherwise, the contents of register k+2 determines the value n in one of the instructions (C m n), (T m n), (A m n), (J m n q), (D m n), (U m n q).
If the value stored in register (R n)>1 and the type of the first inserted instruction is a Constant, Transfer, Address or Delete instruction, then the contents of register k+3 determines the type of the second inserted instruction.
If the type of the first inserted instruction is a Jump or Update instruction, then the contents of register k+3 determines the value of q in the instruction (J m n q) or (U m n q).
If the value stored in (R n)>1 and the first inserted instruction is Jump or Update, then the contents of register k+4 determine the type of the second inserted instruction.
The type and arguments of the 2^{nd} instruction, 3^{rd} instruction, . . . , up to the (R n) instruction are determined inductively according to the previous rules—using consecutive registers starting at
   i. Register k+2 if (R k) lies in the table entry [1] i.e. (S m) is the first instruction.
   ii. Register k+3 if (R k) lies in any of the table entries [0], [2], [3], or [5] or, worded differently, lies in [0]∪[2]∪[3]∪[5] i.e. the first instruction is (C m n), (T m n), (A m n), or (D m n).
   iii. Register k+4 if (R k) lies in [4]∪[6] i.e. the first instruction is (J m n q) or (U m n q).

In other words, the register (R k) determines the type of instruction to insert, the successive registers are used as the arguments of the instruction. Once the argument of the instruction are all filled, if another instructions needs to be inserted the next register is used to determine the type of the next instruction, and the registers the next successive registers are used as the argument of the second instruction until all of the instructions are filled. The process of determining instructions to insert and retrieving the next argument for the current instruction continues until all of the instructions that need to be inserted have been determined and their arguments filled. The indexes of the program instructions after the instructions inserted need to be incremented by the number of instructions inserted. For example if n the instructions are inserted instruction (P k), the instructions have indexes k+1, k+2, and k+3, and each of the instructions following the last instruction inserted are incremented by the number 3, and (P k+1)_{old} becomes (P k+4)_{New}.

Although in the current embodiment, there are seven types of instructions included in the dynamic register machine, in other embodiments there may be fewer or more type of instructions. However, in another embodiment there may also be instructions that affect both the content of the registers and the content of the program simultaneously in addition to or instead of the instructions that only affect the content of the registers and/or the instructions that only affect the contents of the program.

Program memory 124 may store one or more programs. In an embodiment, when executing a program dynamic register machine 100 inspects program memory 124 to find the program being executed and to find the next instruction in the program being executed.

Although in FIG. 1 there is only one program stored in program memory 124, in other embodiments, there may be more than one program stored in the program memory. Program 126 is a program that dynamic register machine 100 runs. In the embodiment of FIG. each instruction is indicated by I1, I2, . . . , In. The instructions are illustrated a one list to indicate that in an embodiment the instructions form one link list, in which each instruction points to the next instruction, so that after executing one instruction the next instruction in the list is executing, unless executing the current instruction (e.g., jump instruction 118) performs an operation that changes what operation is performed next.

### Executing a Dynamic Register Machine Program Execution

In an embodiment, program 126, a dynamic register machine program P, is a finite sequence of instructions such that each instruction in the program is either a Successor, Constant, Transfer, Address, Jump, Update, or Delete instruction. In an embodiment, before the execution of program 126 begins, the value of every register is 0 (or another value indicating that no data is present). In other words, in an embodiment, initially, (R k)=0 for every k.

The instructions in the program P (program 126) may be referenced by the Jump, Update, or Delete instructions in the following way. At the time of the execution of one of the Jump, Update, or Delete instructions, the first instruction in P (program 126) is the 0^{th} instruction denoted as (P 0). In an embodiment, the instructions are each numbered consecutively from (P 0) to (P N). The next instruction after (P 0), if it exists, in P is (P 1). Inductively, the next instruction after (P k), if it exists, is (P k+1).

When the program P (program 126) begins execution, the 0^{th} instruction (P 0) is executed first, if it exists. In an embodiment, if at some execution step program P (program 126) has no instructions, then the dynamic register machine execution of program P (program 126) halts. (It is possible for a Delete instruction to delete the whole program or the initial program P may be empty.)

Inductively, if the k^{th} instruction, (P k), is being executed and it is not a Jump, Update, or Delete instruction, then the next instruction executed is (P k+1). If the instruction (P k+1) does not exist, the dynamic register machine execution of program P halts.

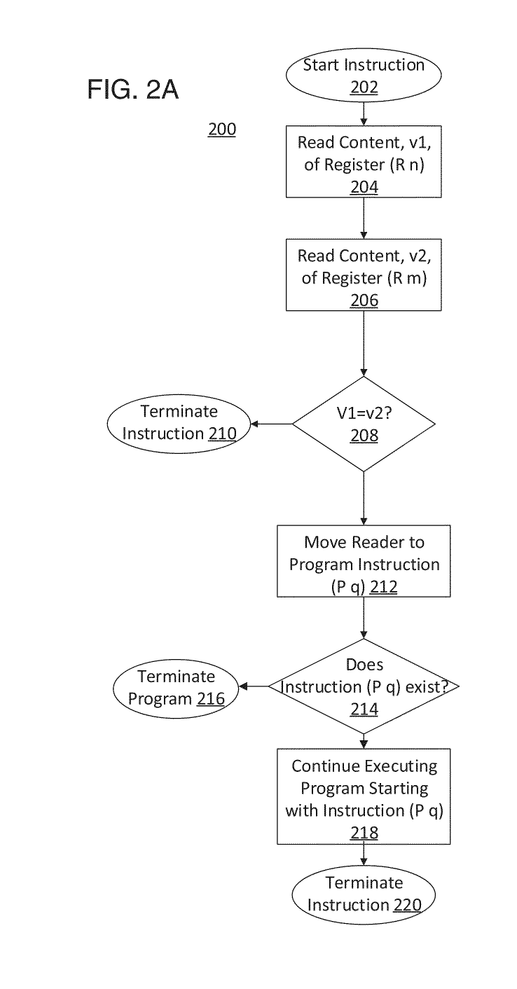

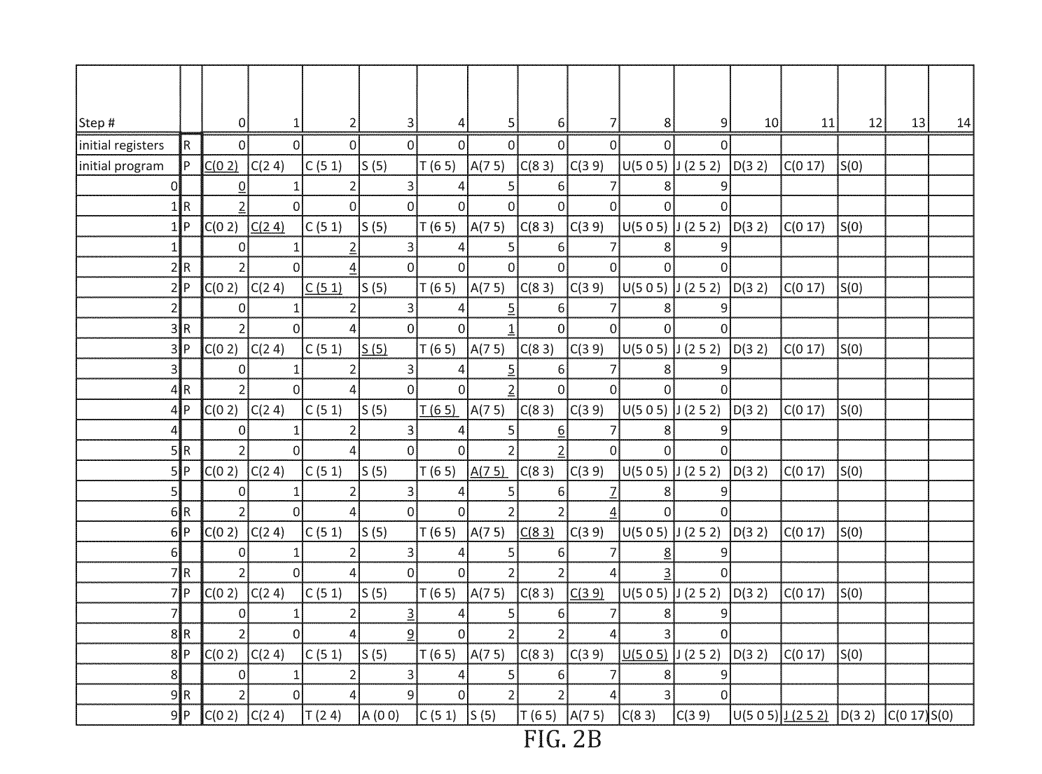

FIG. 2A shows an example of a method 200 of executing the jump instruction 120. In step 202, the execution of jump instruction begins. Jump instruction 120 may begin as a result of being the next instruction in the program after the prior instruction that was executed, as a result of being the first instruction in the program, or as a result of prior jump altering the order of execution of the program, such as by changing the location of a pointer that points to the next instruction to execute. In step 204, the value v1 of a first register (R n) is read. In step 206, the value v2 of a first register (R m) is read. In an embodiment, the values v1 and v2 may represent symbols and/or numbers. In step 208, a determination is made as to whether v1 is the same value as v2. In v1 and v2 are not the same, the instruction proceeds to step 210, where the instruction terminates (without performing any jump).

Returning to step 208, if v1=v2, then the instruction proceeds to step 212. In step 212, the reader of the instructions is moved to program instruction (P k). If the program memory is matrix addressed flash memory, for example, the reader of the instruction are the x-y address read circuits (which may apply a sense current or sense voltage to determine the contents of memory locations representing instruction (P k). If the program memory is an optical and/or magnetic disc for example, the read head is moved to the appropriate track(s) having the memory locations where (P k) is stored. Next in step 214, a determination is made whether instruction (P k) exists. If instruction P k) does not exist jump instruction proceeds to step 216, where the program terminates.

Returning to step 214, if instruction (P k) exists, the jump instruction proceeds to step 218, where the jump instruction terminates. Whether termination of the jump instruction occurred in step 210 or 218, after termination of the jump instruction, (or any instruction) the next instruction that reader reads is executed. Steps 214-218 are optional. As a result of reading a location in program memory 124 where there is no instruction, since there is no instruction to execute dynamic execution machine 100 may shut down and/or a timer may be set during which dynamic register machine 100 continues to re-read the instruction (in case there was a read error) and after the time times out, the machine stops attempting to continue to execute the program.

In an embodiment, each of the steps of method 200 is a distinct step. In another embodiment, although depicted as distinct steps in FIG. 2A, step 202-218 may not be distinct steps. In other embodiments, method 200 may not have all of the above steps and/or may have other steps in addition to or instead of those listed above. The steps of method 200 may be performed in another order. Subsets of the steps listed above as part of method 200 may be used to form their own method.

### Jump Execution

In an embodiment, if (P k) is being executed and (P k)=(J m n q) then (R m) and (R n) are compared. If (R m)≠(R n) then the next instruction executed, if it exists, is (P k+1). If (P k+1) does not exist, then execution of program P halts.

In an embodiment, if (R m)=(R n) then the next instruction executed, if it exists, is (P (R q)). In other words, instruction (P j) is executed where j=(R q). If (P j) does not exist, then execution of program P halts.

Before presenting the rules that describe the execution of the Delete and Update instructions, in an embodiment, the deletion and insertion of instructions is that execution of the program P behaves like and/or may be stored in a linked list of instructions. Each time an instructions is deleted or changes the program P changes (which is the linked list). In an embodiment, if one or more instructions are deleted from the linked list P_{old}, then the instruction executed next is the one that immediately follows—in the sense of the new linked list P_{new}—the previous instruction (D m n)=(P_{old} k) executed in the program P_{old}. If one or more instructions are inserted into the linked list P_{old}, then the instruction executed next is the one that immediately follows in the new linked list P_{new}. The previous instruction (U m n q)=(P_{old} k) that was executed, executed in the old linked list P_{old}.

Below, an example of a dynamic register machine is presented first that illustrates the linked list behavior of the Delete and Update instructions. Then the formal rules are presented for determining the next instruction that is executed after a Delete or Update instruction.

Example of Dynamic Register Machine Program with Update, Delete Instructions

| Instruction Number | Instruction | Program Comments |
|---|---|---|
| 0 > | (C 0 2) | Store 2 in register 0. Set (R 0) = 2. |
| 1 | (C 2 4) | Store 4 in register 2. |
| 2 | (C 5 1) | Store 1 in register 5. |
| 3 | (S 5) | Add 1 to register 5. |
| 4 | (T 6 5) | Copy contents of register 5 to register 6. |
| 5 | (A 7 5) | Copy (R (R 5)) to register 7. |
| 6 | (C 8 3) | Set (R 8) = 3. |
| 7 | (C 3 9) | Set (R 3) = 9. |
| 8 | (U 5 0 5) | Insert (R 0) instructions at (P (R 5)) |
| | | with instruction translation starting |
| | | at (R 5) |
| 9 | (J 2 5 2) | Jump to (R 2) if (R 2) is equal to (R 5) |
| 10 | (D 3 2) | Delete (R 2) instructions beginning at |
| | | (P (R 3)) |
| 11 | (C 0 17) | Set (R 0) = 17. |
| 12 | (S 0) | Add 1 to register 0. |

FIGS. 2B and 2C show the contents of the registers and the list of instructions in the program before and after the execution of the each instruction. The rows are grouped together is sets of three. The first row in each group labeled “R” lists the contents of the registers. The next row, labeled “P,” is the list of instructions of the program. The third row lists the labels of the registers. The rows are labeled according to which step in the execution of the program the rows are associated with. Although not labeled as 0, the first two R and P rows, show the registers and the program before the program starts execution, which are the 0^{th} step. The next row shows the registers after executing the first instruction in the 0^{th} step. The program instruction that is underlined is the current program instruction that is about to be executed. The underlined register is the register whose content was changed by the underlined program instruction of the previous step, which is just above.

The above program begins execution with the instruction (P 0) which is (C 0 2). The third column headed by Program Comments describes the results of executing that instruction. After instruction (T 6 5), executes, the contents of the registers is (2 0 4 0 0 2 2 0 0 . . . ). Before instruction (A 7 5) executes, (R 5)=2 and (R 2)=4. Thus, the execution of (A 7 5) sets (R 7)=4. After instruction (A 7 5) executes, the contents of the registers are (2 0 4 0 0 2 2 4 0 0 . . . ).

After instruction (C 3 9) executes, the contents of the registers are (2 0 4 9 0 2 2 4 3 0 0 . . . ). Thus, when the instruction (U 5 0 5) executes (R 5)=2, (R 0)=2, (R 6)=2, (R 7)=4, and (R 8)=3 Thus, two instructions are inserted at (P 2) where they are determined starting at register 5. Since (R 5)=2, the first inserted instruction is a transfer instruction, as indicted by the table of equivalence classes. The arguments for the transfer instruction are indicated by the next two registers, which are (R 6) and (R 7).

Since (R 6)=2 and (R 7)=4 the first inserted instruction is (T 2 4). Since register 7 completes the first inserted instruction, the next register (R 8) determines the type of the next instruction. Since (R 8)=3, looking up 3 in the table of equivalence classes, the second inserted instruction is an address instruction, which requires two arguments. Consequently, the next two resisters, (R 9) and (R 10), are used to determine the arguments of the instruction. Consequently, the second inserted instruction is (A 0 0), because (R 9)=(R 10)=0. Thus instructions (T 2 4) and (A 0 0) are inserted. The insertions are performed without overwriting any instruction, thereby increasing the length of the program by two instructions.

After instruction (U 5 0 5) has executed, the next instruction executed is (J 2 5 2). The table on the following page shows program P before it executes instruction (J 2 5 2) and after it has been updated by the execution of instruction (U 5 0 5):

| Instruction Number | Instruction |
|---|---|
| 0 | (C 0 2) |
| 1 | (C 2 4) |
| 2 | (T 2 4) |
| 3 | (A 0 0) |
| 4 | (C 5 1) |
| 5 | (S 5) |
| 6 | (T 6 5) |
| 7 | (A 7 5) |
| 8 | (C 8 3) |
| 9 | (C 3 9) |
| 10 | (U 5 0 5) |
| 11 | > (J 2 5 2) |
| 12 | (D 3 2) |
| 13 | (C 0 17) |
| 14 | (S 0) |

When instruction (J 2 5 2) is executed, 4=(R 2)≠(R 5)=2 so the next instruction executed is (D 3 2). Since (R 2)=4 and (R 3)=9, four instructions are deleted from program P starting at instruction (P 9). As a result, instructions (C 3 9), (U 5 0 5), (J 2 5 2), and (D 3 2) are deleted from program P and the current program is shown in the following table after (D 3 2) is executed:

| Instruction Number | Instruction |
|---|---|
| 0 | (C 0 2) |
| 1 | (C 2 4) |
| 2 | (T 2 4) |
| 3 | (A 0 0) |
| 4 | (C 5 1) |
| 5 | (S 5) |
| 6 | (T 6 5) |
| 7 | (A 7 5) |
| 8 | (C 83) |
| 9 | > (C 0 17) |
| 10 | (S 0) |

The next instruction executed is (C 0 17). After instruction (S 0) is executed, there are no more instructions that follow (S 0), so the program execution halts. The final program is the same as in the previous table. When the program execution halts, the content of the registers is (18 0 4 9 0 2 2 4 3 0 . . . ).

### Executing the Delete Instruction

If (P_{old} k) is being executed and (P_{old} k)=(D m n), then there are three cases for determining the next instruction that is executed. To define the three cases, it is first determined whether the execution of the delete command deletes itself—the kth instruction from P_{old}. The formal conditions for this to be true is that (R m)≦k<(R m)+(R n). If this condition is true, then CASE A shown below determines the next instruction that is executed.

CASE A. (R m)≦k<(R m)+(R n). After the deletion of the (R n) instruction(s) from program P_{old} starting at instruction (R m) in program P_{old}, the new program is P_{new}, and the next instruction executed is (P_{new} (R m)).

CASE B. k<(R m). The next instruction executed is (P_{new} k+1). In other words, since k is an instruction that occurs earlier in the program than the first instructions deleted, (R m), the next instruction is the k+1 instruction, which would have been the next instruction in P_{old} also. Additionally, since the instructions deleted occur after the kth instruction, the index value numbering the kth instruction has not changed, and remains k, and consequently the next instruction executed has index k+1.

CASE C. (R m)+(R n)≦k. The next instruction executed is (P_{new} k+1−(R n)). In other words, in Case C, the instructions deleted are instructions that precede the kth instruction. Although the next instruction has not changed (and is the same in both P_{new} and P_{old}), the index of the next instruction has changed, because there are fewer instruction in the program. Since after renumbering the instructions so that the instructions are consecutively numbered and since the instructions deleted preceded the kth instruction, the index of the kth instruction is decreased by the number of instructions deleted. Since the number of instructions deleted is (R n), the decrement in the kth index is (R n), and consequently next instruction now has the index value k+1−(R n).

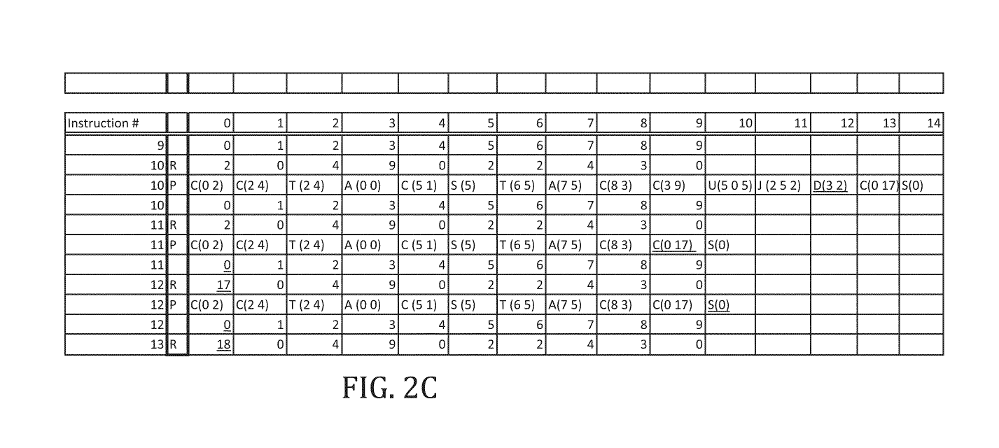

FIG. 3 shows an example of a method 300 of implement update instruction 122. In step 302, the update instruction starts. As with the jump instruction, the update instruction may be the next instruction the list of instructions or a jump may have change which instruction is to be executed next and as a result the update instruction starts. In step 304, the value, v1, of the register is read. The value of v1 indicates how many instructions to add to the program. In step 306, a determination of whether the value of v1 is greater than 0. If the value is not greater than zero, then the method proceeds to step 308, and because there are no instructions to add into the program, the update instruction terminates.

Returning to step 306, if v1 is greater than 0, the method proceeds to step 310. Next, in step 310, an index i is set equal to k, where k is the parameter of the update instructions that indicates where to insert the new instructions in the program. The index i is used to keep track of the registers from which the information to determine the details of the instruction are stored (in another embodiment, there may be an offset between k and i or the value of is may be determined in a different manner as a result of the information being stored in different registers).

The parameter k is also used as an index of the instructions being added. A parameter kmax is also set equal to k+v1. The parameter indicates what the value of k will be after the last instruction is inserted. As part of step 310, each of the original program instructions, starting with instruction (P k) have their index values incremented be v1+1, so that instruction (P k) become new instruction (P k+v1+1), thereby making room for the new v1 instructions that are about to be inserted.

In step 312, the value v2, stored in the register (R i), is read. The value v2 indicates the type of instructions the first added instruction will be. In step 314 a determination is made whether the value v1 is greater than 7. If v2 is greater than or equal to 7, method 300 proceeds to step 316, where v2 is divided by 7. After step 314, the method returns to step 312. In another embodiment, if v2 is greater than or equal to 7, the program terminates and optionally produces an error message, because it is assumed that v2 being greater than or equal to 7 is a result of a programming error.

In step 312, if v2 is less then 7, then the method proceeds to step 318. In step 318, the type of instruction is determined based on the value of v2. Step 312 may involve performing a lookup in a lookup table for example or performing a series of decisions to determine which function the value v2 corresponds to.

In step 320, based on the type of instruction determined in step 318, the number of arguments, v3, needed of the instruction are determined. Step 320 may also involve performing a lookup in a lookup table that indicates the number of arguments each instruction requires or performing a series of decisions to determine the number of the argument based on the type of function. Step 320 is optional, because the same lookup or series of decisions used to determine the type of function may also be used to supply the number of argument as the same time.

In step 322, an index j is set to 1. The index j keeps track whether all of the argument for the current function being added have been determined. In step 324, register (R i+j) is read, and the value read is used as the jth parameter of the function (the first time through the current loop the value read is used as the first parameter of the function. Next in step 326 a determination is made whether j is greater than or equal to v3. If j is not greater than or equal to v3 then there are more arguments to the current function that need values, so method 300 proceeds to step 328, where j is incremented by 1, and steps 324 and 326 are repeated.

If in step 326, j is equal or greater than v3, then all of the arguments of the current function have been determined, each one read from the next register, and so method 300 proceeds to step 330. In step 330, the new instruction is inserted just after position (P k−1), so that the new instruction is (P k). In step 332, a determination is made as to whether k is greater than or equal to kmax. If k is greater than or equal to kmax, the update instruction proceeds to step 334 where the update instruction terminates, because all of the instructions indicated by the update instruction were inserted.

Returning to step 332, if k is less then kmax, then there are more functions to insert. Consequently, the method proceeds to step 336, increments k by 1, so that the next program instruction is inserted in the k+1 position and index I is incremented by v3, so that the next register to read is after the last register containing an argument of the last function. After step 336, method 300 returns to step 312 to determine the type of the next function to insert, and steps 312 to 336 are repeated until k=kmax and the update instruction terminates at step 334. After step method 300 terminates, the next instruction, just after the last instruction inserted, is performed (if there is any such instruction).

There are many other ways of performing the insert instruction. For examples, the registers where the information about the program instructions to be inserted could be located and therefore labeled differently, which would change the indexes used during method 300. Alternatively, no indexes needs to necessarily be set, by a series of decisions (e.g., if statements) could be performed to accomplish the same thing. Also, the program could be left untouched until after the all of the information for each of the functions is determined and then old program steps could be relabeled and the new functions could be inserted all at once.

In an embodiment, each of the steps of method 300 is a distinct step. In another embodiment, although depicted as distinct steps in FIG. 3, step 302-334 may not be distinct steps. In other embodiments, method 300 may not have all of the above steps and/or may have other steps in addition to or instead of those listed above. The steps of method 300 may be performed in another order. Subsets of the steps listed above as part of method 300 may be used to form their own method.

### Executing the Update Instruction

If (P_{old} k) is being executed and (P_{old} k)=(U m n q), then there are three cases for determining the next instruction that is executed. To define the three cases, before (U m n q) is executed, consider the instruction (P_{old} k+1) the instruction that immediately follows (P_{old} k) in program P_{old} right before the instructions are inserted.

CASE A. (R q)≦k. After the (R n) instructions are inserted into program P_{old} at location (R q), then instruction (P_{old} k+1) now in P_{new} is executed next. In other words, the next instruction executed is (P_{new} k+1+(R n)).

CASE B. (R q)=k. After the (R n) instructions are inserted into program P_{old} at location (R q), then the first instruction inserted is executed next.

CASE C. (R q)>k. After the (R n) instructions are inserted into program P_{old} at location (R q), then instruction (P_{old} k+1) is executed next. In other words, the next instruction executed is (P_{new} k+1).

In other embodiments, other instructions sets may be used instead o the above seven instructions. In the above embodiment, the reason why there are seven instructions is it can be shown that with just three basic instructions any type of manipulation of the content can be achieved. In the interest of keeping the instruction set small, there are only three instructions that are included in the instructions for manipulating the lines of the program. Similarly, in the interest of keeping the instruction set small, there are only four instructions for manipulating the contents of the registers. Of the four instructions, the successor instruction is optional, and could be built from the other instructions. However, since the successor instruction is so useful, in this embodiment, the addition instruction is provided in the basic instruction set rather than requiring the user to build the addition instruction from the other instructions.

Although the dynamic register machine 100 has many other uses, as just one example of the use of the dynamic register machine 100, in this specification it is shown, among other things, how to use the dynamic register machine 100 to find infinite loops. However, before proceeding further a discussion of Turing machines is useful.

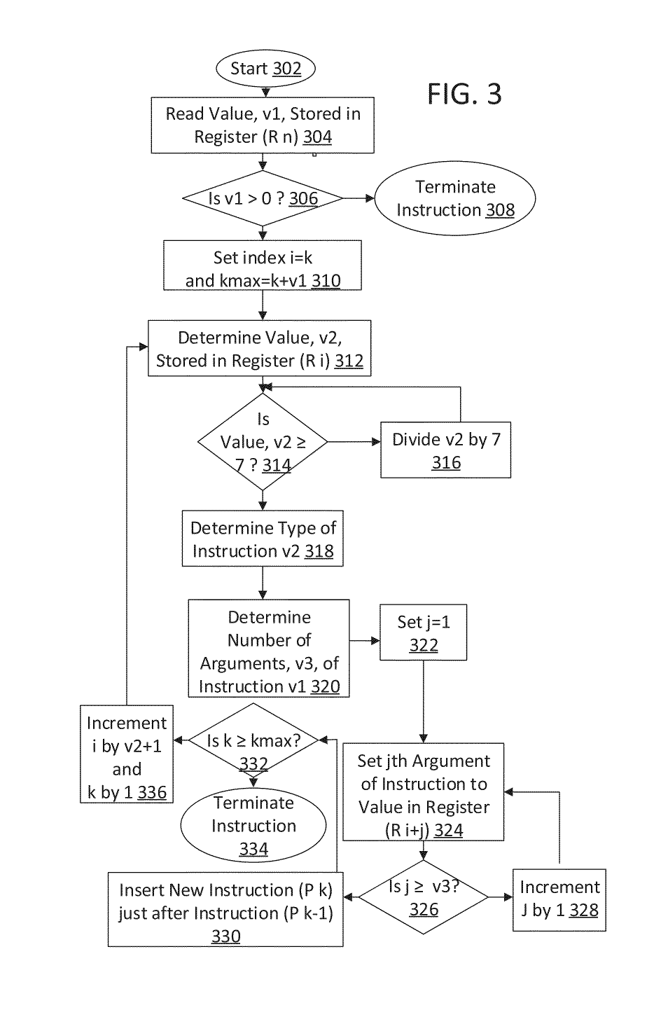

FIG. 4 shows an example of a Turing machine 400. Turing machine 400 may include head 402, data memory 404, real 406a, real 406b, controller 408a, controller 408b, control line 410a, control line 410b, data lines 411, and processor 412 include cache 414 having state 416. Turing machine 400 may also include program memory 418 having memory 420 storing program 422. In other embodiments, non-prior art variations of Turing machine 400 may include additional components and/or may not include all of the components listed above.

Turing machine 400 is an example of one type of Turing machine that may be used with inventive methods of this specification. Other Turing machine may also be used. Head 402 reads and writes data to the data memory. In one embodiment head 402 may be a read-write head that reads and writes data to the data memory. In other embodiments, head 402 may be replaced with other mechanisms for reading memory, such as sensors that measure the change in resistance, capacitance, opacity, index of refraction, birefringence, and/or other properties in response to a current, heat, light, electric field, and/or magnetic field for example.

Data memory 404 may store data that is operated upon by a program. In an embodiment, data memory 404 is a magnetic tape. In other embodiments, the magnetic tape may be replaced with an optical drive, magnetic drive, flash drive, RAM and/or any other type of memory. In this specification, although the terms “tape” and “head” may be used, any other type of memory and mechanism for reading the memory may be substituted anywhere where the terms tape and head are used to obtain different embodiments.

Real 406a and real 406b are optional, and are not necessary in embodiments in which data memory 404 is not a tape. In an embodiment in which data memory 404 is a tape, real 406a holds one end of the tape and real 406b holds another end of the tape. Controller 408a and controller 408b control the portion of memory that is currently being read. In an embodiment in which data memory 404 is tape, controller 408a and controller 408b are motors that control the position of the tape.

Control line 410a sends control signals from a processor to controller 408a, and control line 410b sends control signals from a processor to controller 408b. Data line 411 carries signals from the head 402 to the processor. Processor 412 processes signals from the head 402 reading memory determines whether to send a signal to the head to write and determines whether to send a signal to controllers 480a and/or 408b to positions the head 402 at a different memory location. In the embodiment in which data memory 404 is tape, processor 412 sends signals to controller 408a and 408b to move the tape.

Cache 414 is an onboard memory within processor 412, which stores information that is needed frequently for performing tasks. Cache 414 may be accessed by processor 412 faster than other forms of memory. By storing information in cache 414, tasks requirement that information may be performed faster. State 416 is the state of the machine, which may be a single symbol. In an embodiment state 416 is store in cache 414. In other embodiments, state 414 is stored elsewhere. Program memory 418 stores a program that is currently running Program memory 418 may be RAM and/or flash memory for example, so that the program may be accessed quickly. In an embodiment when the program is not running the program is stored elsewhere.

Instructions 420 are machine instructions (e.g., a computer program), which determine how processor 412 behaves. Processor 412 reads data from data memory 404, and then uses that data as input to instructions 420. Processor 412 computes an output, based on the instructions of instructions 420 (and the input data), and then based on the output computed sends signals to controllers 408a and 408b to change the position in memory being read and/or sends signals to head 402 to read and write data from/to data memory 404. In an embodiment, instructions 420 include a table in which processor looks up a row and column determined by the current state and the symbol at the current memory position, and in response writes data to data memory 404 and changes the current memory position (e.g., by moving the head right or left on the tape).

In general, throughout this specification, it should be understood that since the behavior of any register machine computer can be duplicated with a Turing machine, the same remarks made about Turing machines, the Turing machine table, the state of the machine, the tape, and the head apply equally to a register machine computer with a program, no matter the programming language, no matter the means for tracking the appropriate behavior for a given set of input, no matter the type of data memory (matrix addressed memory, flash memory, Random Access Memory, harddrives, etc.), no matter the type of mechanism for reading and writing to the data memory, respectively.

More formally, a Turing machine may be represented as a triple (Q, A, η) where
There is a unique state h, called the halt state.
Q is a finite set of states that does not contain the halt state h. The states are represented as Q={q₁, q₂, . . . q_{K}} or as the natural numbers Q={2, . . . , K} and the halt state as 1. Before machine execution begins, there is a starting state s, and s is an element of Q.
L and R are special symbols that instruct the machine to advance to the left square or to the right square on the tape T.
A is a finite set of alphabet symbols that are read from and written to the tape. The alphabet symbols are denoted as A={a₁, a₂, . . . , a_{J}} or as the natural numbers A={1, 2, . . . , J}. A does not contain the symbols L, R.
η is a function where η: Q×A→(Q∪{h})×A×{L,R}.

In a classical Turing machine, the function η is the Turing machine's lookup table. The η function acts as the program for the Turing machine in the following manner. For each q in Q and α in A, the expression η (q, α)=(r, β, x) describes how machine (Q, A, η) executes one computational step. When in state q and scanning alphabet symbol α on the tape:
1.) Machine (Q, A, η) changes to state r.
2.) Machine (Q, A, η) rewrites alphabet symbol α as symbol β on the tape.
C. If x=L, then machine (Q, A, η) moves its tape head one square to the left on the tape and is subsequently scanning the symbol in this square—the square in which the head just arrived.
D. If x=R, then machine (Q, A, η) moves its tape head one square to the right on the tape and is subsequently scanning the symbol in this square.
E. If r=h, machine (Q, A, η) enters the halting state h, and the machine stops (halts).

Turing Machine Tape

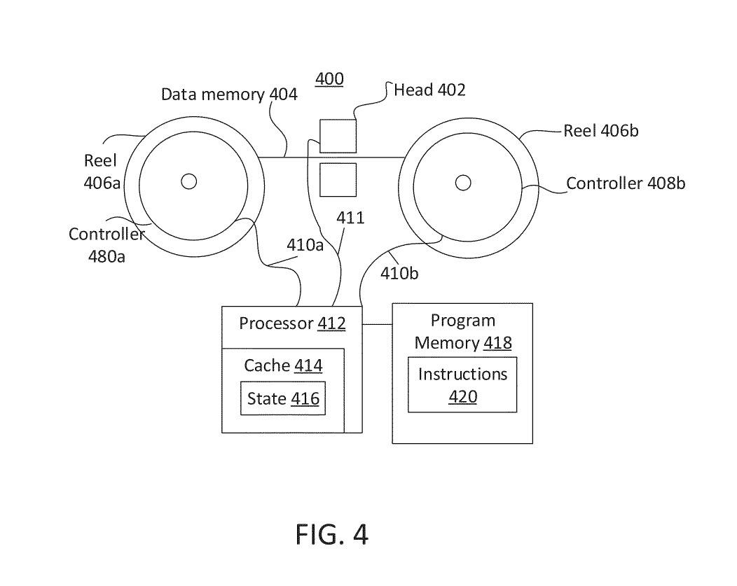

FIG. 5 shows an example of a classical Turning machine tape 500. Tape 500 Includes tape positions 502a and 502b. In other embodiments, non-prior art variations of Turing machine tape 500 may include additional components and/or may not include all of the components listed above.

In an embodiment of Turing machine 400 that uses a tape, tape 500 is an example of the tape. Tape 500 includes tape positions 502a and 502b, which are illustrated as squares. There are several other tape positions represented on the tape, (which are not labeled with numerical labels). Each square contains a symbol. The symbol in tape position 502a is represented by a1 and the symbol in tape position 502b is represented by a2. Other symbols are also shown in other tape positions. After reading a tape symbol, the Truing machine writes a new symbol (which may be the same as the current symbol) and then moves right or left with respect to the tape to process the next tape position.

More formally, the Turing machine tape T is represented as a function T: Z→A where Z denotes the integers. The tape T is M-bounded if there exists a bound M>0 such that for T(k)=#, where a₁=#, whenever |k|>M. The symbol on the kth square of the tape is denoted as Tₖ. The symbol # may be associated with a blank space on the tape. The integers Z of the tape numerically label positions on the tape. The tape is bounded if at a certain point on the tape, there are no symbols, and there are only blanks (or some other character that may be used to represent no data).

In an embodiment, the blank is a symbol that is different than the halt symbol, and the Turing machine table includes square defining how to respond to reading a blank for different states of the machine. In another embodiment, the same symbol that is used to represent no data (e.g., a blank or a #) may also be used to represent a halt, because when the machine reads the no data symbol, the program terminates.

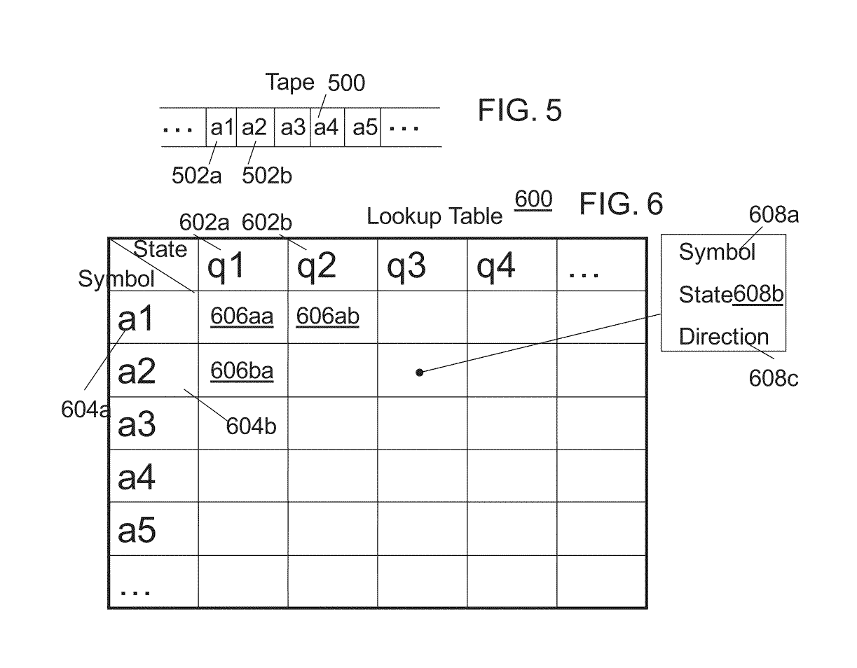

FIG. 6 is an example of Turing machine table 600. Turing machine table 600 includes columns 602a, 602b, . . . , rows 604a, 604b, . . . , squares 606aa, 606ab, . . . , 606ba, . . . , symbol 608a, state, 608b, and direction 608c. In other embodiments, non-prior art variations of Turing machine table 600 may include additional components and/or may not include all of the components listed above.

Turing machine table 600 is the program of the Turing machine. Columns 602a, 602b, . . . , are labeled according to the input states, which is the current state of the machine prior to processing the symbol on the tape. Rows 604a, 604b, . . . , are labeled according to the input symbols, which are read from the tape. Squares 606aa, 606ab, . . . , 606ba, . . . , contain the output of the Turing machine program. When a particular symbol is read and the current state of the machine is input, the state and the symbol act as coordinates to identify one of squares 606aa, 606ab, . . . , 606ba, . . . . For example, square 608aa is retrieved in response to receiving the input symbol a1 and input state q1.

As an example of the information in each square, symbol 608a is the output symbol of a particular square, which is written to the tape. State 608b is the new state of the machine after processing the input symbol that was read on the tape. Direction 608c is the direction to move the head, which in the case of a tape would be right to left (but more generally may be an Indication of a new location to read the next symbol).

Putting together the above description of a Turing machine, the classical Turing machine mechanically operates on a tape. On the tape are symbols, which the machine can read and write, one at a time, using a tape head. An operation is fully determined by a finite set of elementary instructions. In other words, the tape is divided into cells, one next to the other. Each cell contains a symbol from a finite alphabet. The alphabet contains a special blank symbol (which may be written as a ‘0’) and one or more other symbols.

The tape is assumed to be so long that the tape is essentially arbitrarily extendable to the left and to the right. In other words, the tape is so long that, the Turing machine essentially always has as much tape as the machine needs for the computations of the program being executed. Cells that have not been written before are assumed to be filled with the blank symbol. In a physical Turing machine, the user may run the program and if the machine runs out of tape stop the machine replace the tape with a larger tape and rerun the program from the start with the larger tape.

The head can read and write symbols on the tape and move the tape left and right one (and only one) cell at a time. In some models the head moves and the tape is stationary. A state register that stores the state of the Turing machine. The state of the machine is one of finitely many states, which may be represented by symbols. The Turing Machine is provided with a finite table^{[4]} of instructions. The table may be arranged in rows and columns. There may be one row for each possible symbol on the tape and one column for each state of the tape.

Alternatively there may be one row for each possible state and one column for each possible symbol. Each combination of one of the possible symbols and one of the possible states of the machine determines which square in the table is selected. Each square includes (1) a symbol to write to the tape, (2) an indication of a direction in which to move the head (one step to the left or one step to the right), and (3) the state to which the state of the machine should be updated.

Given the state(qᵢ) the machine is currently in and the symbol(aⱼ) the machine is reading on the tape (symbol currently under the head), the table indicates to the machine to do the following in set of steps (1) write a new symbol to the tape (based on the table entry for the particular combination of the current state the symbol on the table that was read), thereby replacing the symbol just read, (2) move the head one step to the left or one step to the right (based on the table entry for the particular combination of the state at the time of just reading the tape and the symbol on tape that was just read), and (3) Update the state of the machine (based on the table entry for the particular combination of the state at the time of just reading the tape and the symbol on tape that was just read). However, if the halting state is encountered, the Turing machine stops, and the Turing machine has finished executing the combination of the symbols on the tape and the table.

The Turing machine may include a register for storing the state of the machine and a servo drive for moving the head or the tape and may include a processor for that decodes the signals from the head when reading the tape, reads the state of the machine form the register, performs the look up on the table based on the symbol read and the state of the machine, sends signals to the head to write the new symbol of the tape (based on the table), send a signal to the register to change the state, and send signals to the servo drive to advance the tape or head.

For example, referring to the table FIG. 6, the classical Turing machine reads one symbol (a₂) from the tape, and finds the current state of the machine (q3), and then inspects the lookup table to find the intersection of a row and column determined by the current state and the symbol read. The resulting intersection includes information determining what symbol to write to the tape, what the new state of the machine should be changed to, and a direction to move the head (either left or right).

### Extensions of the Turing Machine

It should be understood, that although the following extensions may be referred to as “Turing machines” in this specification, the following extension are not a classical Turing machine. In an embodiment, the Turing machine may be simulated on a modern computer, which would have one region of the memory that represents the tape, one region of memory that stores the state of the system, one region in memory that stores the table.

In an embodiment, rather than the table just including an indication of whether to move right or left, the table may include an indication of the next memory cell to move to, and the tape may be replaced with a matrix of memory cells. The indication of where to move to may be provide as an address of the new memory cell to move to or as a direction (e.g., right, left, up, down) to move and the distance of the number of memory cells to move.

In an embodiment, as will be discussed below in further detail, the table is replaced with a collection of execution node pairs. Each execution node pair includes one input node and one output node, which are associated with one another as input and output. Optionally a point may connect the input and output nodes of the input-output pair. As another alternative the input node may include a memory address and/or another indicator as to where to find the output node. The machine may include a memory having one section that represents the tape, one section that represents the state of the machine, and another section in which the collection of execution node pairs are stored. Optionally, the input node and output node may be physically or logically juxtaposed with the memory of the machine. The machine reads symbols on the tape or other memory, and then finds the input node that contains the combination of symbols read and the current state of the machine.

Based on (e.g., as directed by) the input node, the machine next reads output node that corresponds to the input node. The output node includes a series of symbols of one or more symbols to write to the tape, a new state of the machine to which the current state is updated, and then a new location to move to on the tape or to move to within the memory storing the symbols. In an embodiment, there is a one to relationship between Input execution nodes and output execution nodes—each input execution node is associated with one and only one output execution node, and each output execution node is associated with one and only one input execution node. In an alternative embodiment, there may be some input execution nodes that share a common output execution node, and the common output node may be one memory location.

In an embodiment, the Turing machine is implemented on an active element machine, which is discussed below. In an embodiment, the Turing machine is simulated by a dynamic register machine, such as that of FIG. 1.

### Affine Maps, Horizontal & Vertical Coverings

An affine transformation is combination of rotation, while optionally scaling the coordinates, plus a translation. An affine transformation between one pair of coordinates and another pair of coordinates can be represented as a multiplications by a square matrix plus the addition of a column matrix (or row matrix, depending on the type of matrices involved). The matrix multiplication accomplishes the rotation and the scaling of the coordinates and the addition can be viewed as a translation of the coordinates.

Any transformation from one pair of coordinates to another pair of coordinates can be replaced by an affine transformation. As will be discussed, the significance of an affine transformation is that any square in the lookup table of a classical Turing machine can be replaced by a transformation from a first pair of coordinates (the current symbols on the tape and the current state of the machine) to a new pair of coordinates (the new symbol being written to the tape and the new state to which the state of the machine is updated). Additionally, although a single affine transformation, cannot necessarily replace all of the table entries of a table with more than six entries, a single transformation can in principle represent an infinite number of table entries of a classical Turing machine.

Each affine transformation may be represented as one or more execution node pairs, where the input nodes are the input to the affine transformation and each of the output nodes is the output of the transformation that corresponds to the input node having the input coordinates that result in the output coordinates of the transformation. Additionally, affine operations are a bit more flexible than the lookup table of a classical Turing table, because from a practical stand point, the collection of possible symbols and states cannot have a continuum of values, but affine transformations can accomplish the same thing as if there were a lookup table having a continuum of acceptable values for the symbols and/or the states of the machine, which in some situations, such as for the manipulation of a continuum of real numbers, may make the use of affine transformations more convenient than a classical Turing machine lookup table. An extensive discussion of Affine maps appears in parent application, U.S. application Ser. No. 12/499,749 (Docket # BP-2), entitled “Executing Machine Instructions Comprising Input/Output Pairs of Execution Node,” filed Sep. 14, 2009, by Michael Stephen Fiske, which is incorporated herein by reference.

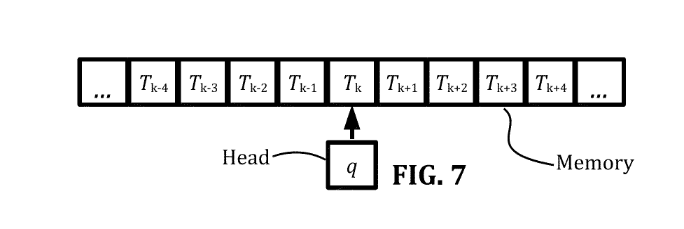

FIG. 7 shows the tape, tape head location, and the configuration (q, k, T).

### An EXAMPLE of a Turing Machine Configuration

Consider configuration (p, 2, . . . ##αβ## . . . ). The first coordinate indicates that the Turing machine is in state p. The second coordinate indicates that its tape head is currently scanning tape square 2, denoted as T₂ or T(2). The third coordinate indicates that tape square 1 contains symbol α, tape square 2 contains symbol β, and all other tape squares contain the # symbol.

An example of a Turing Machine Halt Configuration being represented as natural numbers, a second example of a configuration is (1, 6, . . . 1111233111 . . . ). This configuration is a halted configuration. The first coordinate indicates that the machine is in halt state 1. The second coordinate indicates that the tape head is scanning tape square 6. The underlined 2 in the third coordinate indicates that the tape head is currently scanning a 2. In other words, T(6)=2, T(7)=3, T(8)=3, and T(k)=1 when k<6 OR k>8.

### Turing Machine Execution Step

Given Turing machine (Q, A, η) with configuration (q, k, T) such that T(k)=α. After the execution of one computational step, the new configuration is one of the three cases such that for all three cases T_{new}(k)=β and T_{new}(j)=T(j) whenever j≠k:
I. (r, k−1, new) if η(q, α)=(r, β, L).
II. (r, k+1, T_{new}) if η(q, α)=(r, β, R).
III. (h, k±1, T_{new}). In this case, the machine execution stops (halts).

In other words, after executing the operations dictated by the table as a result of reading the symbol at position k, after replacing the symbol read with the symbol indicated by the table, since the tape positions are labeled consecutively, the head is in the position one space to the left of k, which may be labeled k−1, which in the case of moving the head left is T_{new}, one space to the right of k which may be labeled k+1, which in the case of moving the head left is T_{new}, or still at space k, in the halt state (alternatively the labeling the tape positions could be in the other direction and the left position could be k+1 and right position could be k−1).

If Turing machine (Q, A, η) with initial configuration (s, k, T) reaches the halt state h after a finite number of execution steps, then the machine execution halts. Otherwise, it is said that the machine execution is immortal on initial configuration (s, k, T), meaning that it will never stop running unless the Turing machine is shut off (e.g., the Turing machine is in an infinite loop).

### Turing Program Length

The program length is the number of elements in the domain of η The program length is denoted as |η|. Observe that |η|=|Q×A|=|Q∥A|. In [TURING] and [DAVIS], omit quintuples (q, a, r, b, x) are omitted when r is the halting state. In the representation shown here, η(q, a)=(1, b, x) or n(q, a)=(h, b, x).

If alphabet A={a}, then the halting behavior of the Turing machine is completely determined in |Q|+1 or less execution steps. In other words, if the behavior of the machine is completely determined after executing a number of steps that is equal to or less than the number of states plus 1. That is, within |Q|+1 steps of the program, the program will either terminate on a halt, or return to an earlier configuration and start repeating the same set of steps over again (because the machine is in an infinite loop).

For example, suppose the Turing machine has states Q={q₁, q₂, q_{κ}} and only the symbol a. Observe that the program length is |η|=|Q|. Also, after an execution step every tape symbol on the tape must be a. Consider the possible execution steps: η(q_{S(1)}, a)→η(q_{S(2)}, a)→η(q_{S(3)}, a) . . . →η(q_{S(K+1)}, a), where qₛ₍ₖ₎, is the state prior to performing step k. The state, qₛ₍ₖ₎ and the symbol a (the only possible symbol other than a blank tape) or the inputs to the table. Since there are only |Q| different states and one symbol, the program can only exhibit |Q| different types of behaviors or take |Q| distinctly different actions.

If the program execution does not halt in these |Q|+1 steps (that is after taking all |Q| distinctly different actions) and does not run out of tape having symbols, then S(i)=S(j) for some i≠j; and the tape contents are still all a's, and the Turing machine started repeating the same sequence of steps over again. Thus, the program will exhibit periodic behavior whereby the program will execute η(q_{S(i)}, a)→ . . . η(q_{S(j)}, a) indefinitely. If the program does not halt in |Q|+1 execution steps, then the program will never halt.

Since a Turing machine with only one symbol has the simple property of either halting within in |Q|+1 execution steps or never halts, then the program will never halt, from now on, it is assumed that the number of symbols is |A|≧2. Further, since at least one state is needed, then from here on, it is assumed that the base B≧3.

### Translation Equivalent Configurations

With respect to Turing machine (Q, A, η), the two configurations (q, k, T) and (q, j, V) are translation equivalent if T(m)=V(m+j−k) for every integer m (the translational equivalence may also be used for the trivial case in which j=k and j−k=0). Thus, if a composition of a sequence of functions has a fixed point, or after series of instructions, one arrives at the same state and tape pattern is the same as it was previously when in that state except that the tape pattern has been translated to a different position on the tape, the point arrived at is an immortal point.

Different notations are introduced that represent a point corresponding to a Turing machine configuration. The coordinates of the point are not dependent on the integer value of the tape head with respect to the tape. For this reason, in these different notations, the position of the tape head is located without indicating the integer value of the tape head.

The expression p=[3, w [symbol] 1 [symbol] 2v] represents point p where the current state of the machine is 3; the tape head points to a tape square containing a 1; the tape square adjacent to the right of the tape head contains a 2; the remainder of the tape squares to the right of this 2 are represented by a variable v which may represent an arbitrary sequence of alphabet symbols on the right side of the tape; and the remainder of the tape squares to the left of the tape head are represented by a variable w which may represent an arbitrary sequence of alphabet symbols on the left side of the tape.

To express the configuration at a computational step, 3 1111222 represents that the machine is in state 3, the tape head is located at the underlined 1 and there are 2's to the right of the tape head and 1's to the left of the tape head. If a sequence of symbols is overlined then that means the remainder of the tape squares contain that periodic pattern. For example, p=[3, 1̅2̅ [symbol] 1 [symbol] 2̅1̅2̅] means the machine is in state 3; that the tape to the right of the tape head contains the periodic pattern 212 212 212 . . . ; and the tape to the left of the tape head contains the periodic pattern . . . 12 12 12 12 12.

The following examples demonstrate simple immortal periodic points.

### Example 3.3

Q = {2, 3}. Halting state = 1 A = {1, 2}.
Program 1034

| Q | Tₖ | η(q, Tₖ) |
|---|---|---|
| 2 | 1 | (1, 1, R) |
| 2 | 2 | (3, 2, L) |
| 3 | 1 | (2, 2, R) |
| 3 | 2 | (2, 1, R) |

| | |
|---|---|
| 3 | w22v |
| 2 | w12v |
| 3 | w12v |
| 2 | w22v |
| 3 | w22v |

The immortal point is non-hyperbolic. Specifically, if the machine starts its execution at point p, then the minimal number of computational steps, denoted C(p), for the machine to return to point p is called the computational period of p. One can define the hyperbolic degree of an immortal point as m(p)=|R|−|L| and the periodic degree of the immortal point as C(p)=|R|+|L|, where if p is an immortal periodic point with computational period C(p), then C(p)=|R|+|L| where |R| denotes the number of right tape head moves during these C(p) computational steps and |L| denotes the number of left tape head moves during these C(p) computational steps (a more formal statement of the terms computational period and hyperbolic degree appear below after the introduction of some new notation and the discussion of some examples).

The tape head moves for this non-hyperbolic immortal periodic point are {RLRL}ⁿ. All points p=[3, w [symbol] 2 [symbol] 2v] are non-hyperbolic immortal periodic points with period C=4. Program 1034 does not have any hyperbolic immortal periodic points.

### Example

Q = {2, 3}. Halting state = 1. A = {1, 2}.
Program 481

| Q | Tₖ | η(q, Tₖ) |
|---|---|---|
| 2 | 1 | (3, 1, L) |
| 2 | 2 | (1, 2, R) |
| 3 | 1 | (3, 1, R) |
| 3 | 2 | (2, 1, L) |

| | |
|---|---|
| 3 | 1111222 |
| 3 | 1111222 |
| 2 | 1111122 |
| 3 | 1111122 |
| 3 | 1111122 |
| 3 | 1111122 |

The tape head moves for this immortal periodic point are {RLLRR}ⁿ where n is a positive integer. Point p=[3, 1̅1 [symbol] 1 [symbol] 2 2̅] is an immortal periodic point with period 5 and hyperbolic degree 1. There is an immortal periodic point q=[3, 1̅ [symbol] 1 [symbol] 1̅] with period 1 and hyperbolic degree 1. There is also has an immortal periodic point w=[2, 1̅2̅ [symbol] 1 [symbol] 1̅] with period 2 and hyperbolic degree −2.

### Example

Q = {2, 3, 4, 5, 6}. Halting state = 1. A = {1, 2}.
Left pattern = 2 Middle Pattern = 1121. Right pattern = 1

| Q | Tₖ | η(q, Tₖ) |
|---|---|---|
| 2 | 1 | (3, 2, R) |
| 2 | 2 | (1, 2, R) |
| 3 | 1 | (4, 1, R) |
| 3 | 2 | (1, 2, R) |
| 4 | 1 | (1, 1, R) |
| 4 | 2 | (5, 1, R) |
| 5 | 1 | (6, 2, L) |
| 5 | 2 | (1, 2, R) |
| 6 | 1 | (2, 1, L) |
| 6 | 2 | (1, 2, R) |

| | | |
|---|---|---|
| 2 | y1121 | 1 |
| 3 | y2121 | 1 |
| 4 | y2121 | 1 |
| 5 | y2111 | 1 |
| 6 | y2112 | 1 |
| 2 | y2112 | 1 |
| 3 | y2212 | 1 |
| 4 | y2212 | 1 |
| 5 | y2211 | 1 |
| 6 | y2211 | 2 |

The point p=[2, 2̅ [symbol] 1 [symbol] 121 1̅] is the only immortal periodic point derived from state 2. The immortal point p has period C=5. The minimum left pattern “2” has length 1. The middle pattern “1121” has length 4; and the right pattern “1” has length 1.

EXAMPLE a machine having Q={q, r, s, t, u, v, w, x} and symbols A={1, 2} and halting state=h. left pattern=12, spanning middle pattern=121 2212, right pattern=212, and table

| Q | Tₖ | η(q, Tₖ) |
|---|---|---|
| Q | 1 | (r, 1, R) |
| Q | 2 | (h, 2, R) |
| R | 1 | (h, 1, R) |
| R | 2 | (s, 2, R) |
| S | 1 | (t, 1, R) |
| S | 2 | (h, 2, R) |
| T | 1 | (h, 1, R) |
| T | 2 | (u, 2, R) |
| U | 1 | (h, 1, R) |
| U | 2 | (v, 1, R) |
| V | 1 | (h, 1, R) |
| V | 2 | (w, 2, R) |
| W | 1 | (h, 1, R) |
| W | 2 | (x, 1, L) |
| X | 1 | (h, 1, R) |
| X | 2 | (q, 2, R) |

Below are the machine execution steps with tape head initially at tape square 1. Tape head location is indicated by underline.

| | | | | | | | | | | | | | | | | | | | |
|---|---|---|---|---|---|---|---|---|---|---|---|---|---|---|---|---|---|---|---|
| Q | . . . | 1 | 2 | 1 | 2 | 1 | 2 | 1 | 2 | 2 | 1 | 2 | 2 | 1 | 2 | 2 | 1 | 2 | . . . |
| R | . . . | 1 | 2 | 1 | 2 | 1 | 2 | 1 | 2 | 2 | 1 | 2 | 2 | 1 | 2 | 2 | 1 | 2 | . . . |
| S | . . . | 1 | 2 | 1 | 2 | 1 | 2 | 1 | 2 | 2 | 1 | 2 | 2 | 1 | 2 | 2 | 1 | 2 | . . . |
| T | . . . | 1 | 2 | 1 | 2 | 1 | 2 | 1 | 2 | 2 | 1 | 2 | 2 | 1 | 2 | 2 | 1 | 2 | . . . |
| U | . . . | 1 | 2 | 1 | 2 | 1 | 2 | 1 | 2 | 2 | 1 | 2 | 2 | 1 | 2 | 2 | 1 | 2 | . . . |
| V | . . . | 1 | 2 | 1 | 2 | 1 | 2 | 1 | 2 | 1 | 2 | 2 | 2 | 1 | 2 | 2 | 1 | 2 | . . . |
| w | . . . | 1 | 2 | 1 | 2 | 1 | 2 | 1 | 2 | 1 | 2 | 2 | 2 | 1 | 2 | 2 | 1 | 2 | . . . |
| x | . . . | 1 | 2 | 1 | 2 | 1 | 2 | 1 | 2 | 1 | 2 | 1 | 2 | 1 | 2 | 2 | 1 | 2 | . . . |
| q | . . . | 1 | 2 | 1 | 2 | 1 | 2 | 1 | 2 | 1 | 2 | 1 | 2 | 1 | 2 | 2 | 1 | 2 | . . . |

The tape head moves are {R⁶ LR}ⁿ. The point p=[q, 1̅2̅ [symbol] 1 [symbol] 2̅1̅2̅] is an immortal periodic point with period 8 and hyperbolic degree 6.
Computational Period Suppose the Turing machine (Q, A, η) has an immortal periodic point p. If the machine starts its execution at point p, then the minimal number of computational steps, denoted C(p), for the machine to return to point p is called the computational period of p. Observe that the computational period C(p) is the same number as the period of p with respect to the corresponding affine maps ƒₖ: Wₖ→P where 1≦k≦I and Wₖ is an element on the tape.

### Alphabet Sequences

Suppose alphabet A={a₁, a₂, a₃ . . . , aₙ}. A k-sequence is a sequence of k symbols denoted as s₁ s₂ s₃ . . . sₖ where each sⱼ lies in A.

### Identical Tape Sequences

The two tape sequences TⱼTⱼ₊₁ . . . Tₘ and TₖTₖ₊₁ . . . Tₙ are identical if they are the same length (i.e. n−k=m−j) and Tₖ₊₁=Tⱼ₊₁ for each i satisfying 1≦i≦n−k, because although k is not equal to j, there must exist some number l, such that Tₖ₊₁=Tⱼ, for all j and k of the two tape sequences, and l would be the number of tape positions between the Tₖ=Tⱼ.

### Example of Non-Overlapping 3-Sequences

Consider the set of symbols A={0, 1} and the sequence of symbols on the tape of 000 001 010 011 100 101 110 111 a₁a₂a₃, where a₁a₂a₃ are the next three symbols on the tape after the symbols 111. Since the first eight strings of three symbols lists all of the possible combinations of 0's and 1's that can appear in a string of three symbols, a₁a₂a₃ must repeat one of the previous 3-sequences. In a sequence of length equal to |A|³+3 at least one 3-sequence is repeated.

### Example of Distinct Overlapping 2-Sequences

In any sequence of length |A|²+2, two distinct overlapping 2-sequences are repeated. Consider the set of symbols A={0, 1}, |A|²+2=2²+2=6, and consequently in any sequence two overlapping sequence will appear by the sixth element of the sequence or earlier, as in the sequences below.
0000
0001
00101
00100
001101
01000
01001
0101
011000
011001
0111
. . .
   Duality of 0 and 1 for the remaining eight have corresponding repeats as the first eight.

Distinct overlapping n-sequences that are subsequences of any sequence of length L=|A|ⁿ+n implies that at least two subsequences are identical.

Any Turing tape sequence of length L=|Q∥A|ⁿ+n has at least one n-sequence that occurs |Q|+1 times. In other words, the tape sequence has |Q|+1 distinct, non-overlapping subsequences. If machine (Q, A, η) has an immortal configuration, then it has an immortal periodic point

### Other Uses of Matrices to Represent Turing Tables

Additionally, one can construct matrices that match an initial state, initial head position, and the symbols located on a portion of the current track (each symbol being in a different tape square) as an input with a final set of symbols on an output tape (each symbol being in a different tape square), head position, and direction to move the head (e.g., in an n×m matrix, where n is the number of track positions of the input plus the state and the head position, and m is the number of track positions in the output plus the state, head positions, and optionally plus the direction of movement of the head).

### Other Uses of Matrices to Represent Turing Tables and Other Machine Instructions

Additionally, one can construct matrices that match an initial state, initial head position, and the symbols located on a portion of the current track (each symbol being in a different tape square) as an input with a final set of symbols on an output tape (each symbol being in a different tape square), head position, and direction to move the head (e.g., in an n×m matrix, where n is the number of track positions of the input plus the state and the head position, and m is the number of track positions in the output plus the state, head positions, and optionally plus the direction of movement of the head).

### Patterns and Repeating State Cycles

### Overlap Matching & Intersection Patterns

The notion of an overlap match expresses how a part or all of one pattern may match part or all of another pattern. Let V and W be patterns. (V, s) overlap matches (W, t) if and only if V(s+c)=W(t+c) for each integer c satisfying λ≦c≦μ such that λ=min{s, t} and μ=min{|V|−1−s, |W|−1−t} where 0≦s<|V| and 0≦t<|W|. The index s is called the head of pattern V and t is called the head of pattern W. If V is also a subpattern, then (V, s) submatches (W, t).

If (V, s) overlap matches (W, t), then define the intersection pattern I with head u=λ as (I, u)=(V, s)∩(W, t), where I(c)=V(c+s−λ) for every integer c satisfying 0≦c≦(μ+λ) where λ=min{s, t} and μ=min{|V|−−1−s, |W|−1−t}.

### Edge Pattern Substitution Operator

Consider pattern V=v₀ v₁ . . . vₙ, pattern W=w₀ w₁ . . . wₙ with heads s, t satisfying 0≦s, t≦n and pattern P=p₀ p₁ . . . pₘ with head u satisfying 0≦u≦m. Suppose (P, u) overlap matches (V, s). Then define the edge pattern substitution operator ⊕ as E=(P, u)⊕[(V, s) [symbol] (W, t)] according to the four different cases A., B., C. and D.

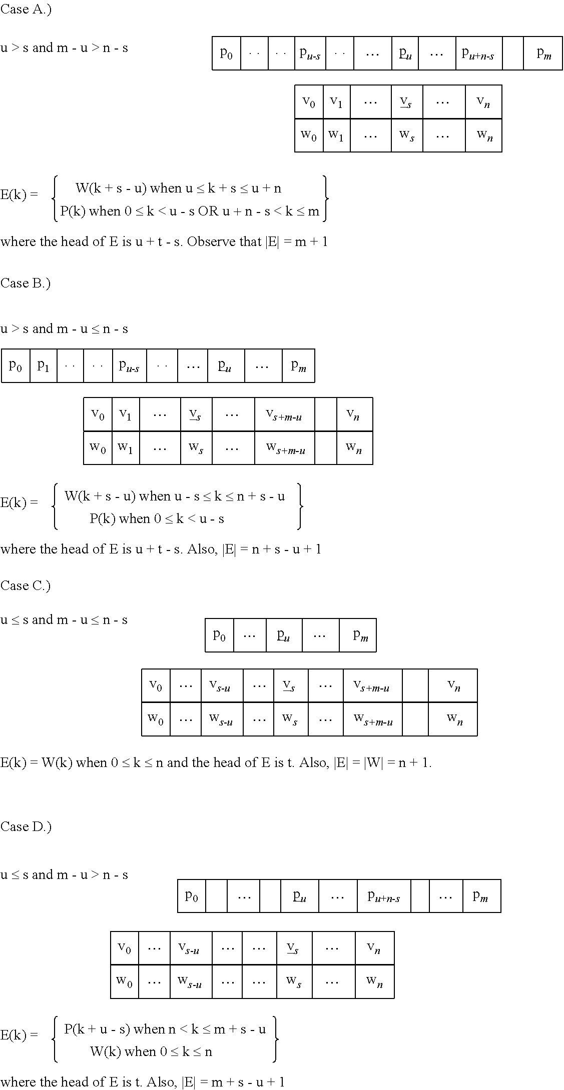

### Overlap and Intersection Matching and Edge Pattern Substitution are Useful in Sections 7, 8 and 10.

### Overlap Matching and Edge Substitution

Set pattern P=0101 110. Set pattern V=11 0101. Set pattern W=01 0010. Then (P, 0) overlap matches (V, 2). The index 0 of (P,0) and the index 2 of (V,2) indicate the position of the reader prior to performing any operations. In other words if one aligns the element of P having the index 0 with the element of V having the index 2, one can perform an overlap match of P and V. Edge pattern substitution is well-defined (from above), so that E=(P, 0)⊕[(V, 2) [symbol] (W, 4)]=01 0010 110.

In other words, let P represent the tape, for example, and let V represent the input of a function, and W represent the output of the function, for example. First construct the combined string of P (from the tape) and V, by aligning the part of the two strings that are common to both strings, as 11 0101 110, where the first two symbols 11 come from V, the next four symbols are common to both, and the last 3 symbols are from P. Then substituted the W for V (forming the combination of P and V is an optional step.

One could just directly from the combination of P and W, but in some ways adding the extra step simplifies the explanation of the process, because it makes it easier to see where to place the string W in relation to P). If the tape had two symbols prior to the first two symbols in P, they will be over written by the first two symbols of W. The head or index of pattern E=4. In other words, the number of symbols that overlapped is 4. In terms of the notation above, this example fits case D.

So, s-u=2, because the 3^{rd} element of P is the first that matches an element in V and W, and since the first element of P is labeled 0, the third element of P is labeled 2. Since there are 7 elements in P and the first is labeled 0, m=6. Since there are 6 elements in each of V and W and the first element is labeled 0, n=5. Since s−u=2 and n=5, u−s=−2 and therefore n+u−s=5−2=3, indicating that the last element in P that matches an element in V and W is the fourth element, and since the third element is labeled 0, the fourth element is labeled 3.

$$Accordingly , E ( k ) = \{ \begin{matrix}P ( k + u - s ) & when n < k \leq m + s - u \\ W ( k ) & when 0 \leq k \leq n\end{matrix} \}$$

$$becomes E ( k ) = \{ \begin{matrix}P ( k - 2 ) & when 5 < k \leq 6 + 2 = 8 \\ W ( k ) & when 0 \leq k \leq 5\end{matrix} \}$$

In other words, in this example of case D, the values of the output string are the string W for first 6 symbols, when k has the values 0 to 5, and the last two symbols are taken from last two symbols of P, when the index values in P are 5 and 6, while the corresponding index values in the resulting output/combined string are 7 and 8.

Also, (P, 4) overlap matches (V, 0), thereby aligning the element of P having index 4 with the element of V having the index 0. F=(P, 4)⊕[(V, 0) [symbol] (W, 4)]=0101 010010. In this case, the first 3 symbols of V (and therefore of W) are aligned with the last 3 symbols of P, resulting in the last 3 symbols P being replaced with the first three symbols of W (skipping the unnecessary intermediary step for first forming the combined string of P and V), and the entire combine string of symbols that results has the first four symbols of the pattern P, and the remainder are of the symbols are the symbols of output pattern W. This second example is an example of case B, above. In this example, u−s=4, because the the fifth element of P, which has the index 4 is the first element of P to align with an element of V and W. Accordingly the combined pattern is given by

$$E ( k ) = \{ \begin{matrix}W ( k + s - u ) & when u - s \leq k \leq n + s - u \\ P ( k ) & when 0 \leq k < u - s\end{matrix} \} , \\ which in this example is$$

$$E ( k ) = \{ \begin{matrix}W ( k - 4 ) & when 4 \leq k \leq 5 + 4 = 9 \\ P ( k ) & when 0 \leq k < 4\end{matrix} \}$$

The index of pattern F=u+t−s=4+4−0=8.

### State Cycle

Consider N execution steps of Turing Machine (Q, A, η) After each execution step, the machine is in some state qₖ and the tape head is pointing to some alphabet symbol aₖ. Relabeling the indices of the states and the alphabet symbols if necessary and assuming the machine has not halted after N execution steps in terms of the input commands is denoted as: (q₀, a₀) [symbol] (q₁, a₁) [symbol] . . . [symbol] (q_{N-1}, a_{N-1}) [symbol] (q_{N}, a_{N}). In this notation, the first ordered pair represents the initial input, which includes a state of the machine and the symbol at the initial head position. The [symbol] represents an operation that is dictated by the Turing table (or equivalent function).

In particular, (q₀, a₀) [symbol] (q₁, a₁) indicates the output of [symbol] as a result of operating on the previous input (which was (q₀, a₀)) is (q₁, a₁). A state cycle is a valid execution sequence of input commands such that the first and last input command in the sequence have the same state i.e. (qₖ, aₖ) [symbol] (qₖ₊₁, aₖ₊₁) [symbol] . . . [symbol] (q_{N-1}, a_{N-1}) [symbol] (qₖ, aₖ). The length of this state cycle equals the number of input commands minus one. A state cycle is called a prime state cycle if it contains no proper state subcycles (as a reminder a covering path [S(1), S(2), S(3), . . . , S(m)] is a covering cycle of length m if φ(S(m))∩W_{S(1)}≠ø; if S(j)=S(k) and k≦m and 1<k−j<m then [S(j), S(j+1), . . . , S(k−1)] is a proper subcycle of [S(1), S(2), S(3), . . . , S(m)]). For a prime state cycle, the length of the cycle equals the number of distinct states in the sequence. For example, (2, 0) [symbol] (3, 1) [symbol] (4, 0) [symbol] (2, 1) is called a prime 3-state cycle because it has length 3 and also 3 distinct states {2, 3, 4}.

### Any Prime State Cycle has Length≦|Q|

This follows from the Dirichlet principle and the definition of a prime state cycle.

### Maximum Number of Distinct Prime State Cycles

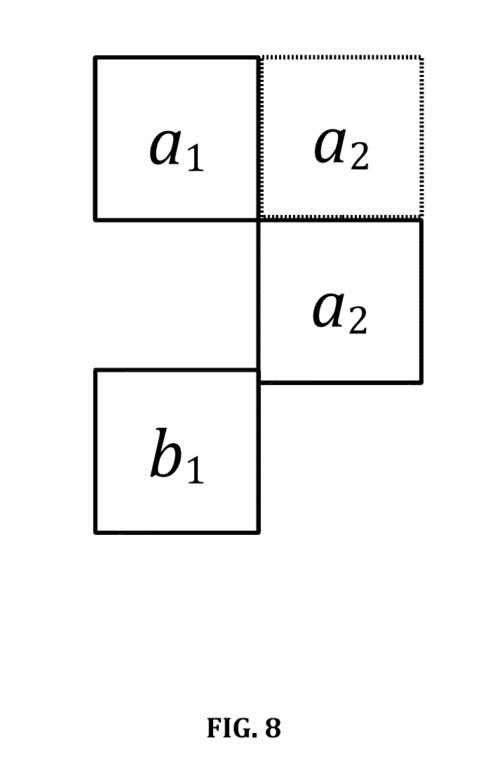

Given an alphabet A and states Q, consider an arbitrary prime state cycle with length 1, (q, a) [symbol] (q, b). There are |Q∥A| choices for the first input command and |A| choices for the second input command since the states must match. Thus, there are |Q∥A|² distinct prime state cycles with length 1. Similarly, consider a prime state cycle with window of execution whose length is 2, this can be represented as (q₁, a₁) [symbol] (q₂, a₂) [symbol] (q₁, b₁). For the tape head move sequence RL, the tape square diagram looks like FIG. 8.

In FIG. 8, each row is another configuration of the tape. The first row shows the head position and symbol initially located in that tape location. The tape position outlined with dotted lines indicates that the initial operation will cause the tape head to move to that position. Although the second row only shows the symbol at the current position of the tape, and does not show what symbol was written to the original tape position, as a result of the second operation, the head is brought back to the starting position, where there is now a new symbol. One can infer that the new symbol in the original position was written as a result of the first operation, but the symbol written as a result of the second operation is not shown in FIG. 8.

Then there are |Q∥A| choices for (q₁, a₁) and once (q₁, a₁) is chosen there is only one choice for q₂ because it is completely determined by η(q₁, a₁)=(q₂, b₁) where η is the program in (Q, A, η). Similarly, there is only one choice for b₁. There are |A| choices for a₂. Thus, there are |Q∥A|² distinct choices. For an arbitrary prime state cycle (q₁, a₁) [symbol] (q₂, a₂) [symbol] . . . [symbol] (qₙ, aₙ) [symbol] (q₁, aₙ₊₁) with window of execution of length k then there are |Q∥A| choices for (q₁, a₁) and |A| choices for a₂ since the current window of execution length after the first step increases by 1. There is only one choice for q₂ because it is determined by η(q₁, a₁). Similarly, for the jth computational step, if the current window of execution length increases by 1, then there are |A| choices for (qⱼ₊₁, aⱼ₊₁). Similarly, for the jth computational step, if the current window of execution stays unchanged, then there is only one choice for aⱼ₊₁ that was determined by one of the previous j computational steps.

Thus, there are at most |Q∥A|^{k} distinct prime state cycles whose window of execution length equals k. Since (1) the window of execution denoted as [λ,μ] is the sequence of integers representing the tape squares that the tape head visited during N computational steps; the length of the window of execution is μ−λ+1—where μ and λ are the first and last indices of the sequence, respectively—which is also the number of distinct tape squares visited by the tape head during these N steps) and (2) if j≦k, then [λ(j), μ(j)]⊂[λ(k), μ(k)], therefore a prime k-state cycle has a window of execution length less than or equal to k. Thus, from the previous and since any prime state cycle has length ≦|Q|, therefore there are at most

$$\vert Q \vert {\sum }_{k = 1}^{\vert Q \vert} {\vert A \vert}^{k}$$

distinct prime state cycles in (Q, A, η), even if the window of execution is longer than |Q| (note that the summation stops at |Q| regardless of how long the window of execution is).

### Any State Cycle Contains a Prime State Cycle,

The reason any state cycle contains a prime state cycle is as follows. Relabeling if necessary let S(q₁, q₁)=(q₁, a₁) [symbol] . . . [symbol] (qₙ, aₙ) [symbol] (q₁, aₙ₊₁) be a state cycle. If q₁ is the only state visited twice, then the proof is completed. Otherwise, define μ=min{|S(qₖ, qₖ)|: S(qₖ, qₖ) is a subcycle of S(q₁, q₁)}. Then μ exists because S(qₖ, qₖ) is a subcycle of S(q₁, q₁). Claim: Any state cycle S(qⱼ, qⱼ) with |S(qⱼ, qⱼ)|=μ must be a prime state cycle. Suppose not. Then there is a state r≠qⱼ that is visited twice in the state cycle S(qⱼ, qⱼ). But then S(qᵣ, qᵣ) is a cycle with length less than μ which contradicts μ's definition.

In other words, since (1) a prime state cycle is the smallest cycle without any subcycles and since (2) the state cycle is itself a cycle, therefore if the state cycle does not have any subcycles within the state cycle (other than the state cycle itself), then there are also no prime cycle with the state cycle, and the state cycle itself would be a prime cycle. If the state cycle has at least one state subcycle within, then the same argument applies to each subcycle.

Applying the same argument to each subcycle and to each subcycle of each subcycle for as many nestings of subcycles within subcycles as possible, for each subcycle, one either arrives at one or more subcycles of a length greater than one operation, that have no subcycles within and are therefore prime state cycles or else one arrives at one or more subcycles that are only of a length of one operation (involving an input symbol-state pair and output symbol-state pair), which for practical reasons cannot have any subcycles, because one cannot have a state cycle of length of less than 1 operation (while if sequence of states is not a prime state cycle and has no prime state cycles within, the sequences of states is cannot be state cycle).

### Consecutive Repeating State Cycle for (Q, a, η)

If machine (Q, A, η) starts execution and repeats a state cycle two consecutive times i.e. (q₁, b₁) [symbol] . . . [symbol] (qₙ, bₙ) [symbol] (q₁, b₁) [symbol] . . . [symbol] (qₙ, bₙ) [symbol] (q₁, b₁), then (Q, A, η) has a consecutive repeating state cycle.

### Execution Node for (Q, a, η)

An execution node (or node) is a triplet Π=[q, w₀ w₁ . . . wₙ, t] for some state q in Q where w₀ w₁ . . . wₙ is a pattern of n+1 alphabet symbols each in A such that t is a non-negative integer satisfying 0≦t≦n. Intuitively, w₀ w₁ . . . wₙ is the pattern of alphabet symbols on n+1 consecutive tape squares on the tape and t represents the location of the tape head.

### Every Immortal Periodic Point Induces a Consecutive Repeating State Cycle.

Suppose p is an immortal periodic point with period n. Then by the Turing-Affine correspondence theorem the kth iterate of p is ƒ_{S(k)} ƒ_{S(k-1)} . . . ƒ_{S(1)}(p) and the application of affine function ƒ_{S(k)} corresponds to the execution of input command

(qₖ, bₖ). Thus, let the input command sequence (q₁, b₁) [symbol] . . . [symbol] (qₙ, bₙ) [symbol] (qₙ₊₁, bₙ₊₁) denote the first n input commands that are executed. Since p has period n, ƒ_{S(n)} . . . ƒ_{S(k)} . . . ƒ_{S(1)}(p)=p. Thus, (q₁, b₁)=(qₙ₊₁, bₙ₊₁). Thus, the first n steps are a state cycle (q₁, b₁) [symbol] . . . [symbol] (qₙ, bₙ) [symbol] (q₁, b₁).
Since the n+1 computational step corresponds to applying ƒ_{S(1)} to p which corresponds to input command (q₁, b₁). By induction, the n+k computational step corresponds to applying function ƒ_{S(k)} to the point ƒ_{S(k-1)} . . . ƒ_{S(1)}(p) which by the previous paragraph corresponds to the execution of the input command (qₖ, bₖ). Thus, the sequence of input commands is (q₁, b₁) [symbol] . . . [symbol] (qₙ, bₙ) [symbol] (q₁, b₁) [symbol] . . . [symbol] (qₙ, bₙ) [symbol] (q₁, b₁).

Another way to view repeating immortal points, if for a given classical Turing machine program a periodic immortal point of a given period n is encountered, by the definition of an immortal periodic point, the Turning machine will proceed through a sequence of n operations (which are uniquely determined by the tape and that Turing machine table) until the Turning machine outputs the same periodic immortal point having the same period. Since the output of the one cycle is the input of the next operation, which is an immortal periodic point of having a period n, by the definition of the immortal periodic point, the Turing machine starts the cycle again and completes the same cycle again outputting the same immortal periodic point, which again is the input of the next operation, so that the same cycle repeats every n operations.

### Every Consecutive Repeating State Cycle Induces an Immortal Periodic Orbit

Suppose Turing machine (Q, A, η) begins or resumes execution at some tape square and repeats a state cycle two consecutive times, and the rest of the pattern of the tape is the same at the beginning of each stated cycle (other than possibly being translated). Then (Q, A, η) has an immortal periodic point and this state cycle induces the immortal periodic point.

The reason that every consecutive repeating state cycle induces an immortal periodic orbit is as follows. Let the state cycle that is repeated two consecutive times be denoted as (q₁, b₁) [symbol] . . . [symbol] (qₙ, bₙ) [symbol] (q₁, b₁) [symbol] . . . [symbol] (qₙ, bₙ) [symbol] (q₁, b₁). Let sₖ denote the tape square right before input command (qₖ, bₖ) is executed the first time where 1≦k≦n. Let tₖ denote the tape square right before input command (qₖ, bₖ) is executed the second time where 1≦k≦n.

Thus, the window of execution for the first repetition of the state cycle, right before input command (qᵢ, bη) is executed a second time, denoted Iₙ={s₁, s₂, . . . , sₖ, Sₖ₊₁ . . . Sₙ, Sₙ₊₁} where Sₙ₊₁=t₁. The window of execution for the second repetition of the state cycle is Jₙ={t₁, t₂, . . . , tₙ, tₙ₊₁} where tₙ₊₁=tₙ+t₁−sₙ.

Furthermore, observe that the window of execution for the computational steps 1 thru k is Iₖ={s₁, s₂, . . . , sₖ, sₖ₊₁} where the tape square sₖ₊₁ is indicated after input command (qₖ, bₖ) is executed the first time. Also, observe that the window of execution for the computational steps n+1 thru n+k is Jₖ={t₁, t₂, . . . , tₖ, tₖ₊₁} where the tape square tₖ₊₁ is indicated after the input command (qₖ, bₖ) is executed the second time (in the second repeating cycle).

Next a useful notation represents the tape patterns for each computational step. Then the proof is completed using induction. Let V₁ denote the tape pattern—which is the sequence of alphabet symbols in the tape squares over the window of execution Iₙ—right before input command (q₁, b₁) is executed the first time. Thus, V₁(s₁)=b₁. Let Vₖ denote the tape pattern—which is the sequence of alphabet symbols in the tape squares over the window of execution Iₙ—right before input command (qₖ, bₖ) is executed the first time. Thus, Vₖ(sₖ)=bₖ.

Let W₁ denote the tape pattern—which is the sequence of alphabet symbols in the tape squares over the window of execution Jₙ—right before input command (q₁, b₁) is executed the second time. Thus, W₁(t₁)=b₁. Let Wₖ denote the tape pattern—which is the sequence of alphabet symbols in the tape squares over the window of execution Jₙ—right before input command (qₖ, bₖ) is executed the second time. Thus, Wₖ(tₖ)=bₖ. Using induction, it is shown that V₁ on window of execution Iₙ equals W₁ on window of execution Jₙ. This completes the proof Since (q₁, b₁) is the input command before computational step 1 and (q₁, b₁) is the input command before computational step n+1, then V₁(s₁)=b₁=W₁(t₁). Thus, V₁ restricted to window of execution I₁ equals W₁ restricted to window of execution J₁.

From the definition, η(q₁, b₁)=(q₂, a₁, x) for some a₁ in A and where x equals L or R. Note that L represents a left tape head move and R a right tape head move.

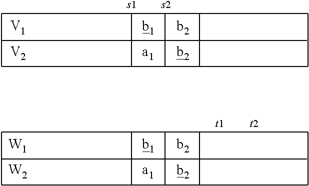

Then s₂=s₁+1, t₂=t₁+1 and V₁₍ₛ₂₎=b₂=W₁(t₂). It has already been observed that V₁(s₁)=b₁=W₁(t₁). Thus, V₁ restricted to the window of execution I₂ equals W₁ restricted on the window of execution J₂. Furthermore, the tape head is at s₁ right before computational step 1 and input command (q₁, b₁) is executed; the tape head is at t₁ right before computational step n+1 and input command (q₁, b₁) is executed.

Also, V₂(s₁)=a₁=W₂(t₁) and V₂(s₂)=b₂=W₂(t₂). Thus, V₂ restricted to the window of execution I₂ equals W₂ restricted to the window of execution J₂. Furthermore, the tape head is at s₂ right before computational step 2 with input command (q₂, b₂) is executed; the tape head is at t₂ right before computational step n+2 with input command (q₂, b₂) is executed.

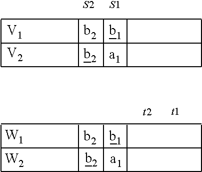

Then s₂=s₁−1, t₂=t₁−1 and V₁(s₂)=b₂=W₁(t₂). And V₁(s₁)=b₁=W₁(t₁). Thus, V₁ restricted to the window of execution I₂ equals W₁ restricted on the window of execution J₂. Furthermore, the tape head is at s₁ right before computational step 1 and input command (q₁, b₁) is executed; the tape head is at t₁ right before computational step n+1 and input command (q₁, b₁) is executed.

Also, V₂(s₁)=a₁=W₂(t₁) and V₂(s₂)=b₂=W₂(t₂). Thus, V₂ restricted to the window of execution I₂ equals W₂ restricted to the window of execution J₂. Furthermore, the tape head is at s₂ right before computational step 2 and input command (q₂, b₂) is executed; the tape head is at t₂ right before computational step n+2 and input command (q₂, b₂) is executed. This completes the base case of induction.

Induction Hypothesis.

Suppose that for the 1, 2, . . . , k−1 computational steps and the corresponding n+1, n+2, . . . , n+k−1 steps that for every i with 1≦i≦k
V₁ is restricted to the window of execution Iᵢ equals W₁ restricted on the window of execution Jᵢ; V₂ restricted to the window of execution L equals W₂ restricted on the window of execution Jᵢ; and . . . Vᵢ restricted to the window of execution L equals Wᵢ restricted on the window of execution Jᵢ.
Furthermore, the tape head is at s₁ right before computational step i and input command η(qᵢ, bᵢ) is executed; the tape head is at tᵢ right before computational step n+i and input command η(qᵢ, bᵢ) is executed.

Induction Step.

Since η(qₖ, bₖ) is the input command before computational step k and before computational step n+k, then Vₖ(sₖ)=bₖ=Wₖ(tₖ). From the definition, η(qₖ, bₖ)=(qₖ₊₁, aₖ, x) for some aₖ in A and x equals L or R. Note that L represents a left tape head move and R a right tape head move.

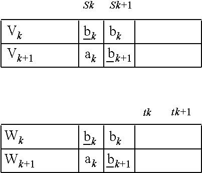

By the inductive hypothesis Vₖ restricted to window of execution Iₖ equals Wₖ restricted to window of execution Jₖ and the only change to the tape and tape head after executing η(qₖ, bₖ)=(qₖ₊₁, aₖ, R) for the steps k and n+k is that Vₖ₊₁(sₖ)=aₖ=Wₖ₊₁(tₖ) and Vₖ₊₁(sₖ₊₁)=bₖ₊₁=Wₖ₊₁(tₖ₊₁) and that the tape heads move right to Sₖ₊₁ and tₖ₊₁ respectively.

Thus, Vₖ₊₁ restricted to the window of execution Iₖ₊₁ equals Wₖ₊₁ restricted on the window of execution Jₖ₊₁. And for each j satisfying 1≦j≦k, then Vⱼ restricted to the window of execution Iₖ₊₁ equals Wⱼ restricted on the window of execution Jₖ₊₁.

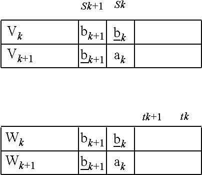

By the inductive hypothesis Vₖ is restricted to window of execution Iₖ equals Wₖ restricted to window of execution Jₖ and the only change to the tape and tape head after executing η(qₖ, bₖ)=(qₖ₊₁, aₖ, L) for the steps k and n+k is that Vₖ₊₁(sₖ)=aₖ=Wₖ₊₁(tₖ) and Vₖ₊₁(sₖ₊₁)=bₖ₊₁=Wₖ₊₁(tₖ₊₁) and that the tape heads move left to Sₖ₊₁ and tₖ₊₁ respectively.

Thus, Vₖ₊₁ restricted to the window of execution Iₖ₊₁ equals Wₖ₊₁ restricted on the window of execution Jₖ₊₁. And for each j satisfying 1≦j≦k, then Vⱼ restricted to the window of execution Iₖ₊₁ equals Wⱼ restricted on the window of execution Jₖ₊₁.

### Execution Node Pair Machine

Before proceeding further, in the process of discussing finding infinite loops in programs, the specification has also described a new type of computer, which is different than the dynamic register machine computer, which is described below.

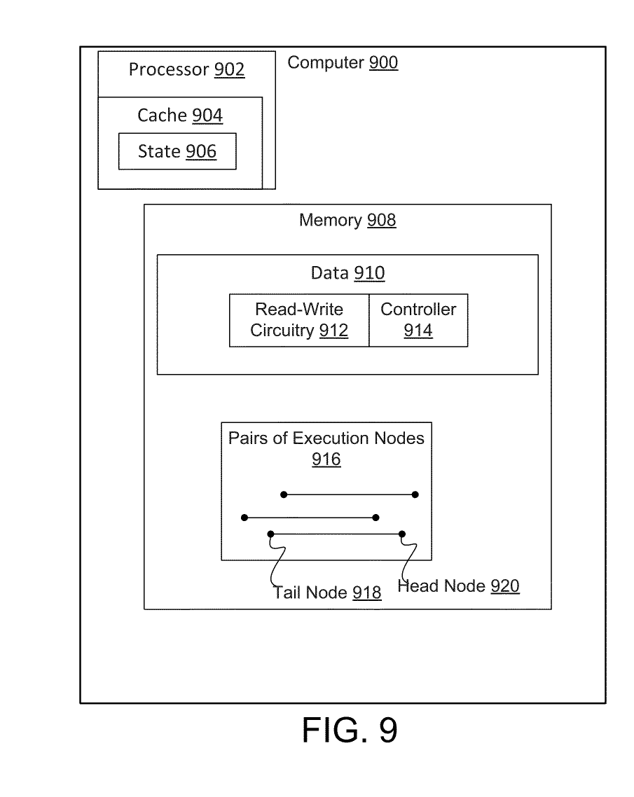

FIG. 9 shows a block diagram of a computer 900 having a collection of execution nodes. Computer 900 may include processor 902, having cache 904, storing state 906. Computer 900 may also include data 908, read-write mechanism 910, controller 912, pairs of execution nodes 914, head node 916, and tail node 918. In other embodiments, computer 900 may include additional components and/or may not include all of the components listed above.

Computer 900 is a new type of computer that runs programs written as pairs of execution nodes. Processor 902 is circuitry that performs computations of based on the execution node pairs. In an embodiment processor 902 is a conventional processor. In another embodiment, processor 902 is hardwired for processing execution node paris. In another embodiment processor 902 is a portion of a network of active machine elements that share the tasks of performing computations and storing information, which optionally may have been trained to process execution node pairs.

Cache 904 is onboard memory of processor 902. State 906 is a variable representing the state the machine, which when changed changes the response that the machine has to the same input data. Although in FIG. 9, state 906 is stored in cache 904, in other embodiments state 906 may be stored elsewhere. Data 908 is a portion of memory where the data that is being processed by computer 900, which could be any sort of data, such as text files, an electronic spreadsheet, values for inputting to a spread sheet, etc.

Read-write mechanism 910 is a mechanism for reading and writing to data 908. Read-write circuitry 910 may be x-y electrodes for addressing memory cells, the read-write head of a hard drive, etc. Controller 912 controls the read-write mechanism 2210. In matrix addressed memory cells, controller 912 may include the circuitry that the addresses the x-y electrodes.

Regarding a harddrive, the controller may include the servo mechanism for positioning the head over the correct track and causing the head to read the track when over the correct position of the track.

Pairs of execution nodes 914 is a region of memory in which pairs of execution nodes are stored. In an embodiment pairs of execution nodes 914 and data 908 are physically separate regions of memory optionally different devices. In another embodiment, execution nodes 914 and data 908 are stored in the same memory dispersed with one another, but which computer 908 has grouped together as different logical regions of memory. Although only 3 execution node pairs are illustrated, there may be any number of execution node pairs in any given program.

In an embodiment, the execution node pairs are prime directed edges. The advantage of using execution node pairs is the many execution steps that are expected to be performed together are collapsed into one step. The advantage of using prime directed edges is that by breaking down a program in terms of state cycles of the program, which is likely to characterize the manner in which operations in the program are commonly grouped.

In this specification head node is used interchangeably is input node and tail node used interchangeably with output node either term may be substituted for the other, respectively to obtain different embodiments.

In another embodiment, other execution node pairs are included, in addition to or instead of prime directed edges. For example, the user may have certain operations that are performed frequently together, and it may be convenient to have one or more pre-computed execution node pairs that handle those groups of operations, so that the computations are performed faster.

As another example of a manner of using execution node pairs that are not prime directed edges, there may be a hierarchy of execution node pairs stored according to length, and for each length all of the possible execution node pairs are present. The machine first searches for the execution node heads having the largest combination of possible steps. The combinations of steps that do not lead to a halt before the last step are considered the possible combinations of steps. If none match then the next longest length set of execution node heads are searched. Once an execution nodes head is search the output node is implemented.

Head node 916 is an example of a head node of an execution node pair, which indicates the input that needs to be received to execute the execution node pair. In an embodiment, each execution each node head, such as head node 916, includes a series of symbols representing a series of tape positions each having a symbol in an equivalent Turing machine, a state of the machine, and the position of the equivalent Turing machine head. In other embodiments, tail node 916 may include other information instead, such as the data read from a two dimension pattern of data in a two dimensional array of memory locations (e.g., registers) an address the last piece of data that was read, and a current state of the machine.

Tail node 918 carries the output of executing the execution node head. In an embodiment, each node tail, such as tail node 918, includes a series of symbols representing a series of tape positions each having a symbol in an equivalent Turing machine, a state of the machine, the position of the equivalent Turing machine head, and direction to which to move the equivalent Turing head. In other embodiments, tail node 918 may include other information instead, such as the data to write to a two dimension pattern of data in a two dimensional array of memory locations (e.g., registers) an address of which data to read next, and a new state of the machine for updating the state of the machine.

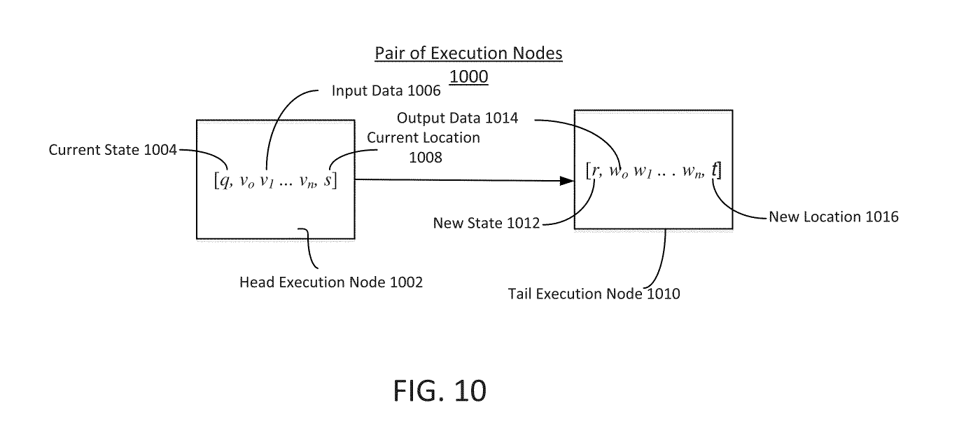

FIG. 10 shows an example of an execution node pair 1000 that may be used in the execution node pair machine of FIG. 9. Execution node pair 1000 may include head node 1002, current state 1004, input symbols 1006, current location 1008, tail node 1010, new state 1004, output symbols 1006, and new location 1008. In other embodiments, execution node pair 1000 may include additional components and/or may not include all of the components listed above.

Execution node pair 1000 may be any pair of execution nodes having an input node and an output node that are associated with one another, such that when the input to the program matches the input node, the output is the data in the output node. Optionally, there may be a pointer pointing from the input node to the output node. Head node 1002 is the input node. When at least a portion of the input matches the input that is in the head node (e.g., in an edge substitution process), the execution node pair is used to determine the output, based on the output node.

Current state 1004 is an indication of the current state of the machine. In a Turing machine, the state is just a symbol or value. In other embodiments, the state may be an indication or flag that tracks whether the machine is currently executing a do-loop or other programming loop and/or an indication of whether or not a logical variable is true or false, such as a logical variable for determining whether to execute an if statement or determining which prong of a select statement to execute, for example. More generally, the state of the system is information that determines which of multiple possible behaviors and/or operations to perform for the same input. In other words, when the machine is in a different state the operation performed for a given input is different than when the machine is in a different state, despite receiving the same input.

The input data 1006 is the data read from memory that is the current input of the program. In Turing machine input data 1006 would be a sequence of symbols found at multiple adjacent tape positions. In other embodiments, input data 1006 may be number for a mathematical computation, text for manipulation for composing machine generated articles, keyboard strokes for entering information into a word processor, spreadsheet, search engine, or other type program, and/or any other type of input. Current location 1008 is the current memory cell being read.

Current location 1008 may be a pointer value pointing to a particular location in memory. In a Turing machine, the current location 1008 is the position of read-write head on the tape where the head is located.

Tail node 1010 is the output node. Tail node 1010 is associated with head node 1002 as the output for the input associated with head node 1002. If the input information matches at least part of the input node, the machine goes to tail node to retrieve output information that, in an embodiment, at least partially replaces the input information.

New state 1012 is the new state to which the state of the machine is changed. In the context of a Turing machine, the new state may just be a new value stored in memory. However, the new state could be an indication of being in a different loop, no longer being in any loop, being in a different option of a selected statement or if else statement for example. In general, the new state 1012, when different form the old state, changes the manner in which the machine responds to the same input.

Output data 1014 is the data that is retrieved and stored in the data storage area of the machine. The output data may be changes in the formatting of a document, results of a mathematical computation, or any other results of performing tasks of a program. In the context of a Turing machine, the output data would be a sequence of symbols to be written to a series of adjacent tape positions.

New location 1016 is the new location in memory that is read next. New location 2316 may be pointer value pointing to a particular register in the machine. In an embodiment the new location 2316 is a location where that was written as part of writing output data 2316. In the context of the Turing machine, new location 1016 may be a new location with the data just written to the tape, where the head is moved to.

Current location 1008 and new location 1016 are optional. In an embodiment, current location 1008 and new location 1016 may be replaced with a current location and a new location in a sequence of steps in a program or left out completely. For example, after executing an execution node pair, the machine may automatically read the next chunk of information in the sequence of input information and use that information to find the next head node of the next execution node pair.

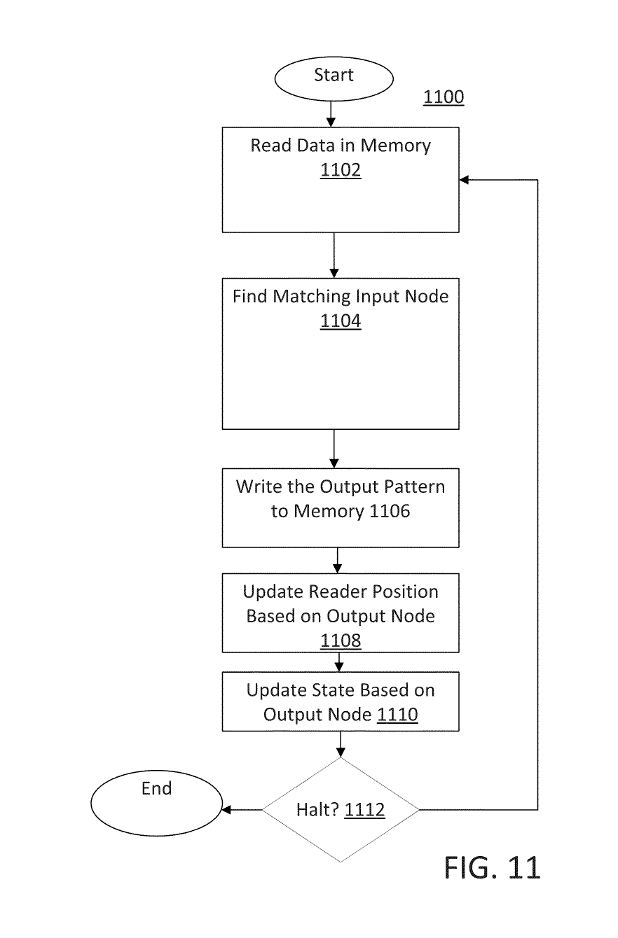

FIG. 11 is a method of running an execution node pair machine of FIG. 10. In step 1102 data in memory is read by the execution node pair machine. For example, symbols in a sequence of memory positions are read based on the position of the reader (which reads the memory). As another example a group of register are read, based on a register that a pointer points to.

In step 1104, a search is performed for a matching head node of an execution node pair. In an embodiment, the matching head node only needs to having a portion of data that matches a portion of information in the head node. In an embodiment, the matching portion include a memory location where the reader is currently located or where a pointer is pointing indicating the last location read, which is matched with the indication of the position of the reader or the location that pointer points.

In step 1106, data is written to memory based on the content of the tail node, the read position, and the manner in which the data read matches the data in the head node. In step 1108, the state of the machine is updated according to the state indicated by the tail node. Step 1108 may be performed before, after, at the same time as step 1106. In step 1110, a determination is made whether the tail node indicates to halt the program. If the tail node indicated to halt the program the program terminates. Otherwise, the program returns to step 1102, where a new set of data is read from memory based on the new position of the reader or the pointer.

Optionally, in step 1110, the processor may not need to expressly compute a decision. The tail node may send the reader to a position having no data and/or may change the state of the system to the halt state, and as a result of having no data, the program may end.

In an embodiment, each of the steps of method 1100 is a distinct step. In another embodiment, although depicted as distinct steps in FIG. 11, step 1102-1110 may not be distinct steps. In other embodiments, method 1100 may not have all of the above steps and/or may have other steps in addition to or instead of those listed above. The steps of method 1100 may be performed in another order. Subsets of the steps listed above as part of method 1100 may be used to form their own method.

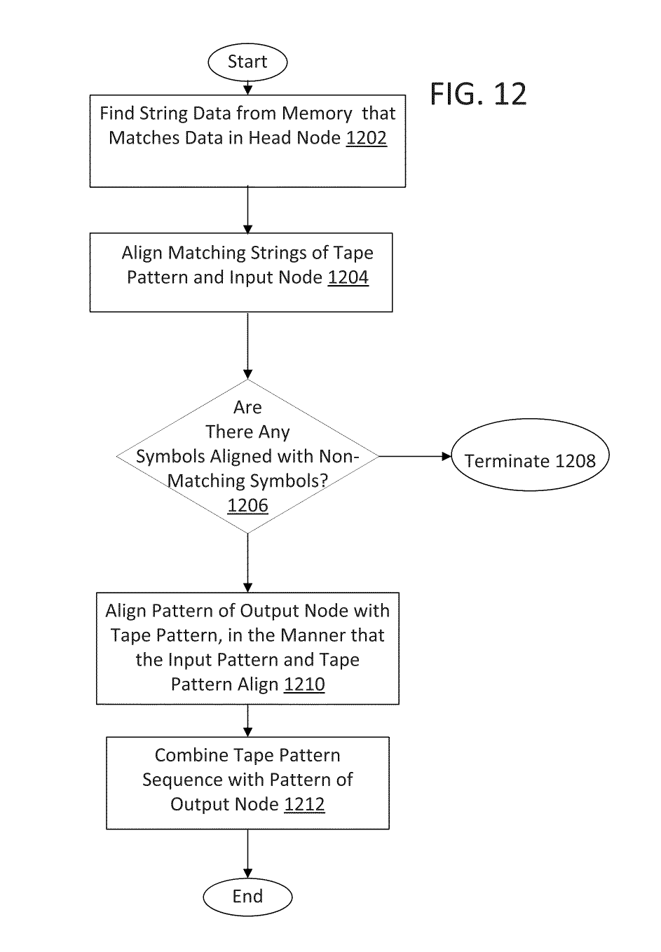

FIG. 12 shows a flowchart of an embodiment of a method 1200 of performing overlap matching and edge substitution. In an embodiment, the execution node machine performs computations by performing an overlap match followed by an edge substitution.

In step 1202, a search is performed for a head node having data that at least partially matches the data in the head node. In an embodiment, the portion that matches is a set of data that are adjacent to one another. In the case of a tape, or a string of symbols, the portion that is matched is a string of contiguous symbols, which appear in the same order in both the head node and the tape. In the case of registers, the portion that matches may be a two dimensional pattern or a series of symbols that are treated as if the symbols are arranged in a string. In an embodiment, the read locations of the head node and the data read are also matched. In step 1204, the matching portions of the head node and the data read are aligned, so that the read locations are also aligned.

In step 1206, a determination is made whether there are any symbols in locations in the data read that align with different symbols in the head node. For example, on a tape, after aligning the read head and the symbols that are common to both the data read and the head node, a determination is made whether there are any symbols in the head node that align with non-matching symbols in the data read. If there is an alignment of non-matching data, there is no match between the data read and the head node, and consequently the method proceeds to step 2508, where the method terminates. After the method terminates, the machine searches for another head node with matching data.

Returning to step 1206, if there is no non-matching data aligned with one another, then in step 1210, the data in the tail node is aligned with the data read in the manner in which the data in the head node aligned. For example if the first three memory positions of the head node aligned with the last three positions of the data read, then the data in the tail node is aligned with the data read such that the first there memory positions of the tail node align with the last three memory positions in the data read.

In step 1212, the data of the tail node is written to memory in alignment with the manner in which the head node aligned with the data read. Continuing the example of 1210, the data in the last three positions of the data read is written over by data in the first three memory positions of the tail node. The read location is changed to the read location indicted by the tail node.

In an embodiment, each of the steps of method 1200 is a distinct step. In another embodiment, although depicted as distinct steps in FIG. 12, steps 1202-1212 may not be distinct steps. In other embodiments, method 1200 may not have all of the above steps and/or may have other steps in addition to or instead of those listed above. The steps of method 1200 may be performed in another order. Subsets of the steps listed above as part of method 1200 may be used to form their own method.

Prime Directed Edge from Head and Tail Execution Nodes

A prime head execution node Δ=[q, v₀ v₁ . . . vₙ, s] and prime tail execution node Γ=[r, w₀ W₁ . . . wₙ, t] are called a prime directed edge iff all of the following hold:
When Turing machine (Q, A, η) starts execution, it is in state q; the tape head is located at tape square s. For each j satisfying 0≦j≦n tape square j contains symbol vⱼ. In other words, the initial tape pattern is v₀ v₁ . . . vₛ . . . vₙ.
During the next N computational steps, state r is visited twice and all other states in Q are visited at most once. In other words, the corresponding sequence of input commands during the N computational steps executed contains only one prime state cycle.
After N computational steps, where 1≦N≦|Q|, the machine is in state r. The tape head is located at tape square t. For each j satisfying 0≦j≦n tape square j contains symbol wⱼ. The tape pattern after the N computational steps is w₀ w₁ wₜ w₁ . . . Wₙ.
The window of execution for these N computational steps is [0, n].

A prime directed edge is denoted as Δ [symbol] Γ or [q, v₀ v₁ . . . vₙ, s] [symbol] [r, w₀ w₁ . . . wₙ, t]. The number of computational steps N is denoted as |Δ [symbol] Γ|. In an embodiment, each head execution node is an input node that has a one-to-one correspondence with a tail node, and the tail nodes in an output node.

### Prime Input Command Sequence

Above, input commands were introduced. (Specifically, it was stated that a state cycle is a valid execution sequence of input commands such that the first and last input command in the sequence have the same state, and the length of this state cycle equals the number of input commands minus one). If (q₁, a₁) [symbol] . . . [symbol] (qₙ, aₙ) is an execution sequence of input commands for (Q, A, η), then (q₁, a₁) [symbol] . . . [symbol] (qₙ, aₙ) is a prime input command sequence if qₙ is visited twice and all other states in the sequence are visited once. In other words, a prime input command sequence contains exactly one prime state cycle.

### Prime Input Command Sequence Notation

Using the same notation as used earlier, let V₁ denote the initial tape pattern—which is the sequence of alphabet symbols in the tape squares over the window of execution of the prime input command sequence—right before the first input command (q₁, a₁) in the sequence is executed. And let s₁ denote the location of the tape head, i.e., V₁(s₁)=a₁. Let Vₖ denote the tape pattern right before the kth input command (qₖ, aₖ) in the sequence is executed and let sₖ denote the location of the tape head, i.e., in this notation Vₖ(sₖ)=aₖ.

### Definition 8.4 Composition of Prime Input Command Sequences

Let (q₁, a₁) [symbol] . . . [symbol] (qₙ, aₙ) and (r₁, b₁) [symbol] . . . [symbol] (rₘ, bₘ) be prime input command sequences where Vₖ denotes the tape pattern right before the kth input command (qₖ, aₖ) with tape head at sₖ with respect to Vₖ and Wₖ denotes the tape pattern right before the kth input command (rₖ, bₖ) with tape head at tₖ with respect to Wₖ.

Suppose (Vₙ, Sₙ) overlap matches with (W₁, t₁) and qₙ=r₁. Then (qₙ, aₙ)=(r₁, b₁). And the composition of these two prime input command sequences is defined as (q₁, a₁) [symbol] . . . [symbol] (qₙ, aₙ) [symbol] (r₂, b₂) [symbol] . . . [symbol] (rₘ, bₘ). The composition is undefined if (Vₙ, sₙ) and (W₁, t₁) do not overlap match or qₙ≠r₁. If (q₁, a₁) [symbol] . . . [symbol] (qₙ, aₙ) [symbol] (q₁, b₁) is a prime state cycle, then it is also prime input command sequence. For simplicity in an upcoming, later part of this specification, a prime input command sequence is called a composition of one prime input command sequence.

The purpose of the next group of definitions is to show that any consecutive repeating state cycle is contained inside a composition of prime input command sequences. Since (1) every immortal periodic point induces a consecutive repeating state cycle) and (2) every consecutive repeating state cycle induces an immortal periodic orbit, therefore there is a one to one correspondence between a consecutive repeating state cycle and an immortal periodic point.

If this consecutive repeating state cycle is rotated (in other words, if the last k states are moved from the end of the sequence to the beginning of the sequence, but otherwise all of the states in the sequence are kept in the same order with respect to one another), then the resulting new sequence of states is still part of the same periodic orbit of the original periodic point. Next it is shown that there is a one to one correspondence between prime input command sequences and prime directed edges. Subsequently, it is explained how to link match prime directed edges. Then it is demonstrated how to find all prime directed edges for a particular Turing machine. If a particular Turing machine has any immortal periodic points, then that Turing machine will have corresponding consecutive repeating state cycles, which will be contained in an edge sequence of prime directed edges that are link matched.

### Directed Partition Method

Start with the finite state sequence (0, 4, 2, 3, 4, 1, 3, 0, 1, 2, 0, 4, 2, 3, 4, 1, 3, 0, 1, 2).

Partition Steps

(0 4 2 3 4 1 3 0 1 2 0 4 2 3 4 1 3 0 1 2)

((0 4 2 3) 4 1 3 0 1 2 0 4 2 3 4 1 3 0 1 2) 4 lies in (0 4 2 3) and is the next state after 3, so the each sequence ends just before the recurrence of a state in that sequence, which in the case of the first sequence, the recurrent state is state 4. Consequently, 0423 is the first sequence and the 4 is theist element found.

((0 4 2 3) (4 1 3 0) 1 2 0 4 2 3 4 1 3 0 1 2) 1 lies in (4 1 3 0) and is the first state after the 0 is 4130. Consequently, 4130 is the second sequence and 1 is the 2nd element found.

((0 4 2 3) (4 1 3 0) (1 2 0 4) 2 3 4 1 3 0 1 2) 2 lies in (1 2 0 4) and recurs just after 4, and consequently 1204 the third sequence and 2 is the 3rd element found.

((0 4 2 3) (4 1 3 0) (1 2 0 4) (2 3 4 1) 3 0 1 2) 3 lies in (2 3 4 1). 4th element found.

((0 4 2 3) (4 1 3 0) (1 2 0 4) (2 3 4 1) (3 0 1 2)) 0 lies in (0 4 2 3). 5th element found.

### Tuples

A tuple is a finite sequence of objects denoted as (σ₁, σ₂, . . . , σₘ). The length of the tuple is the number of objects in the sequence denoted as |(σ₁, σ₂, . . . , σₘ)|=m. For our purposes, the objects of the tuple may be states, input commands or natural numbers. For example, (3) is a tuple of length one, and (1, 4, 5, 6) is a tuple of length four. Sometimes the commas will be omitted as in the previous example. For example, (4 6 0 1 2 3) is a tuple of length six (despite the lack of commas). The term object is often used in connection with tuples to describe the elements of a tuple. For example, the 4 is called the first object in tuple (4 6 0 1 2 3). Similarly, the objects of a tuple are also referred to as members of a tuple. For example, 1 is called a member of tuple (4 6 0 1 2 3).

### Tuple of Tuples

A tuple of tuples is of the form (w₁, w₂, . . . , wₙ) where each Wₖ may have a different length. An example of a tuple of tuples is ((3), (1, 4, 5, 6), (4, 5, 6)). Sometimes the commas are omitted: ((0 8 2 3) (1 7 5 7) (5 5 6)).

### Directed Partition of a Sequence

A directed partition is a tuple of tuples (w₁, w₂, . . . , wₙ) that satisfies Rules A and B.

Rule A. No object σ occurs in any element tuple Wₖ more than once.
Rule B. If wₖ and wₖ₊₁ are consecutive tuples, then the first object in tuple wₖ₊₁ is a member of tuple Wₖ.

### Example 8.9

### Directed Partition Examples

((0 8 2 3) (8 7 5 4) (5 0 6)) is an example of a directed partition.

((0 8 2 3) (8 7 5 4) (5 0 6)) is sometimes called a partition tuple.

(0 8 2 3) is the first element tuple. And the first object in this element tuple is 0. Specifically, in the example of ((0 8 2 3) (8 7 5 4) (5 0 6)), each of the element tuples (0 8 2 3), (8 7 5 4), and (5 0 6) have sequence of numbers in which each number in the sequence only occurs once in that sequence in accordance with rule A. Also, in the example of ((0 8 2 3) (8 7 5 4) (5 0 6)), in accordance with rule B, the first object is 8, which is a member of the prior element tuple 0823, and the first object of the last element tuple, 506, is a 5, which is the third element of the prior element tuple, 8754.

Element tuple (8 0 5 7 0 3) violates Rule A because object 0 occurs twice. ((0 8 2 3) (1 7 5 4) (5 0 6)) violates Rule B since 1 is not a member of element tuple (0 8 2 3).

### Consecutive Repeating Sequence and Extensions

A consecutive repeating sequence is a sequence (x₁, x₂, . . . , xₙ, . . . , x₂ₙ) of length 2n for some positive integer n such that xₖ=xₙ₊ₖ for each k satisfying 1≦k≦n. An extension sequence is the same consecutive repeating sequence for the first 2n elements (x₁ . . . xₙ . . . X₂ₙ . . . x₂ₙ₊ₘ) such that xₖ=x₂ₙ₊ₖ for each k satisfying 1≦k≦m.

A minimal extension sequence is an extension sequence (x₁, . . . , x₂ₙ₊ₘ) where m is the minimum positive number such that there is at least one element in x₂ₙ, x₂ₙ₊₁ . . . , x₂ₙ₊ₘ that occurs more than once. Thus, x₂ₙ₊ₖ=x₂ₙ₊ₘ for some k satisfying 0≦k<m.

For example, the sequence S=(4 2 3 4 1 3 0 1 2 0 4 2 3 4 1 3 0 1 2 0) is a consecutive repeating sequence and S̅=(4 2 3 4 1 3 0 1 2 0 4 2 3 4 1 3 0 1 2 0 4 2 3 4 1) is an extension sequence. S̅ contains consecutive repeating sequence S, followed by the sequence, 42341, in which only 4 is repeated.

Directed Partition Extension with Last Tuple Satisfying Rule B

Suppose (x₁ . . . xₙ . . . x₂ₙ, x₂ₙ₊₁, . . . x₂ₙ₊ₘ) is an extension of consecutive repeating sequence (x₁ . . . , xₙ . . . x₂ₙ). Then (w₁, w₂, . . . , wᵣ) is a directed partition extension if it is a directed partition of the extension: The last tuple wᵣ satisfies Rule B (which states, that if wₖ and wₖ₊₁ are consecutive tuples, then the first object in tuple wₖ₊₁ is a member of tuple wₖ) if x₂ₙ₊ₘ is the last object in tuple wᵣ and xₘ₊₁ lies in tuple wᵣ.

For example, the extension S̅=(4 2 3 4 1 3 0 1 2 0 4 2 3 4 1 3 0 1 2 0 4 2 3) has directed partition extension ((4 2 3) (4 1 3 0) (1 2 0 4) (2 3 4 1) (3 0 1 2) (0 4 2 3)) and the last tuple satisfies Rule B since 4 lies in (0 4 2 3).

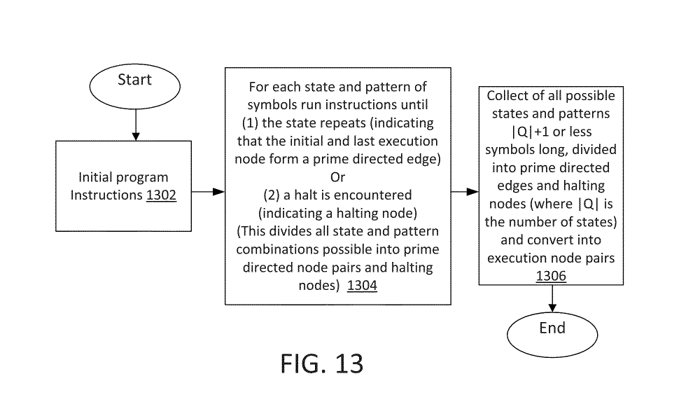

FIG. 13 shows a flowchart of an example of a method 1300 of finding prime directed edges. In step 1302, determine the initial program instructions. For example, in the case of a Turing machine determine the table for the Turing machine.

In step 1304, for each state and possible pattern of symbols that is length |Q|+1 or less, run the program instructions (e.g., following the Turing table until (1) one of the states repeats or until (2) a halt is encountered. Optionally, one may categorize the strings of operations into prime directed edges and halting edges (edges, which when implemented that halt execution of the program). In step 1304, there is no need to fully construct each possible pattern of symbols all the way to the last |Q|+1 symbol, because many of the patterns will arrive at a halt before the end of the pattern. Rather one can instead first figure out for which possible initial symbol has no pattern of symbols been constructed.

That symbol is the first symbol in the initial symbol pattern. Then one can determine which states have not been tested yet for that initial symbol. The state found is the initial state of the head node and also the first state is the state pattern. Then one can determine the result of reading that symbol, when the machine is in that state. If that symbol and state result in a halt or if the resulting state is the same as a previous state in the state sequence, then that is the end of the edge, the resulting final state, the resulting final pattern of symbols, and the direction to move the head next are stored.

If that symbol and state do not result in a halt to determine what are the next possible symbol in the location where the head is about to move that have not been tested. After finding a halt or a repeated state, then return to the latest point in the sequence where another symbols could have been inserted next, that results in a pattern of symbols and states that has not been computed, yet and determine the results and again proceed as before until running into either a halt or a repeated state.

In step 1306, the prime directed edges and the halting edges are each converted into execution node pairs. The initial state, the initial set of symbol patterns prior to running the operations in the Turing table, the initial state of the machine and the initial head position is placed into the head node. The final set of symbols resulting from running the set of operations prescribed by the Turing table (until arriving at a halt or a repeated state), the final state, and (at least for non-halting edges) the final position of the head, the direction to move the head next after performing the last Turing table operation on the sequence of symbols, are stored in the tail node.

In an embodiment, each of the steps of method 1300 is a distinct step. In another embodiment, although depicted as distinct steps in FIG. 13, steps 1302-1306 may not be distinct steps. In other embodiments, method 1300 may not have all of the above steps and/or may have other steps in addition to or instead of those listed above. The steps of method 1300 may be performed in another order. Subsets of the steps listed above as part of method 1300 may be used to form their own method.

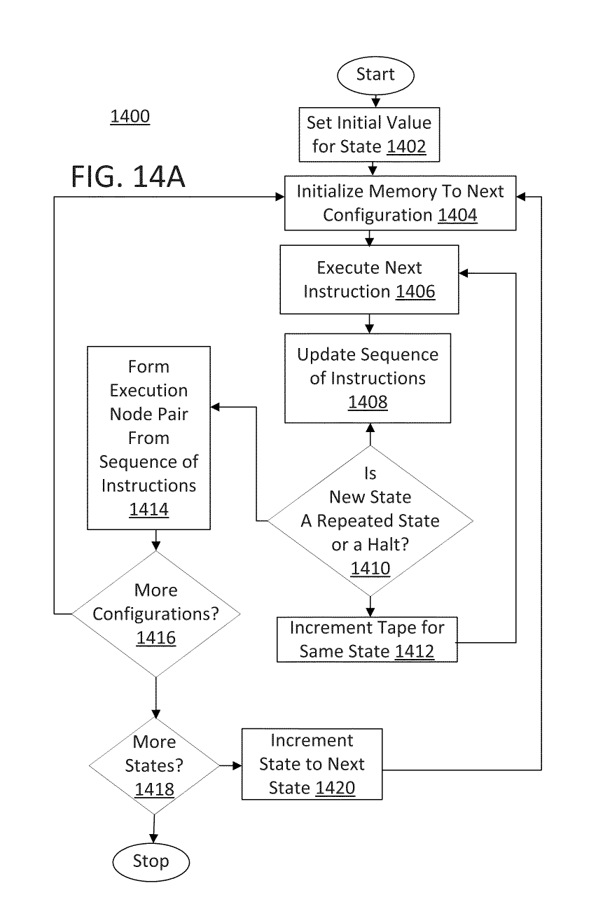

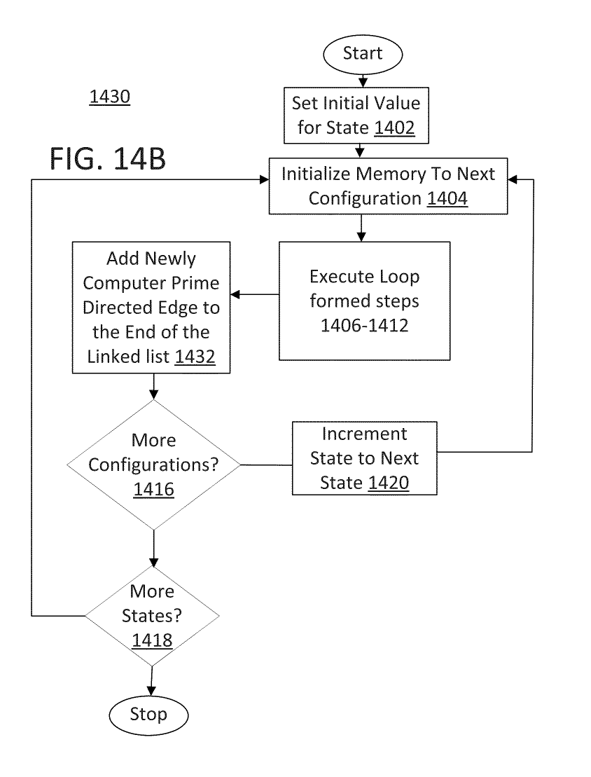

FIG. 14 shows a more detailed example of a method 1400 of finding prime directed edges. In step 1402, an initial state is chosen. In step 1404, a configuration of the memory is chosen, which may be a sequence of symbols of only one memory position or may be a sequence of symbols of up to |Q| memory positions, where |Q| is the number of states. In a Turing machine each memory position is a different tape square. In other forms or layouts of data, an initial pattern of data is chosen which may be data for a single register or for as many as |Q| registers in any particular pattern that is convenient for arranging data.

In step 1406, the next instruction (which could be the first instruction is executed). In step 1408, the sequence of instructions executed during the current loop is updated and stored (which during the first time through the loop for any given pattern of data and state may include creating this new sequence of instructions and storing the new sequence of instructions).

In step 1410, a determination is made whether the execution of the last instruction would result in a halt or in a repetition of the prior state. If the execution of the prior instruction would not result in a halt or a repeated state, the method proceeds to step 1412. In step 1412, the current memory pattern is updated to include results of the most recent execution step. In the case of a Turing tape, the sequence of symbols of the current tape is updated. In other sorts of the machines other patterns in other forms of memory are updates.

Also, in step 1412, optionally, is the rest of the memory pattern was not already chosen, the data in the next memory location to be read is determined, so that the resulting initial memory pattern is unique and not an initial memory pattern that was already computed. After step 1412, the method 1400 returns to step 1406 to repeat the loop for the next memory location.

Returning to step 1410, if a halt or repeated state is encountered, this cycle through the loop (of steps 1406 to 1412) is terminated, and the method proceeds to step 1414. In step 1414, the current data pattern and state are stored as the output data pattern, output state, and the next read location of the tail node, and the initial data pattern, initial state, and initial read location are stored as the input data pattern, input state, and input location of the head node. The head node and tail node are associated with one another as an input-output pair, as a head node-tail node execution node pair.

In step 1416, a determination is made whether there are any more data patterns that have not been tested yet for the current state. If there are more data configurations, to test, method 1400 proceeds to step 1404 to choose a new data configuration that has not yet been computed, and restart the inner loop (of steps 1406 to 1412). As method 1400 is being performed, to improve efficiency, partial results that are expected to be reusable may be stored. For example is a Turing machine having 3 states (1, 2, and 3) and two symbols a and b (the halt state may be represented as 0), after method 1400 computes the result of the sequence of symbols aa for state 1, during the first time through the inner loop, the results may be saved.

Then (if a halt or a repeat o states is not encountered, method 1400 may compute the results of the sequence of symbols aaa for the initial state 1. Since there are only three states, the next computation must result in a halt or a repetition of states. Next, using the stored result of the computation of the sequence aa for the initial state 1 (which is in this example is not a prime directed edge and is not halt state, and therefore just a partial result), method 1400 may next compute the results of the sequence aab for the initial state 1 (and then may proceed to compute the results of ab for the initial state of 1, for example, and if a halt or repeated state is not encountered store the results as a partial result for use in computing another prime directed edge or halting edge).

Returning to the step 1416, if there are not more data configurations for the current state, the method proceeds to step 1418, In step 1418, a determination is made whether there are any more initial state for which the prime directed edges and halting edges have not been computed. If there are none, the method terminates. If there are more initial states, then the method 1400 proceeds step 1420, where the initial state is incremented to the next initial state for which the prime directed edges and halting edges have not yet been computed. Then, the method returns to step 1404, where the data pattern is initialized to the first data pattern, and the inner loop (steps 1404-1412) is started again.

In an embodiment, each of the steps of method 1400 is a distinct step. In another embodiment, although depicted as distinct steps in FIG. 14, steps 1402-1416 may not be distinct steps. In other embodiments, method 1400 may not have all of the above steps and/or may have other steps in addition to or instead of those listed above. The steps of method 1400 may be performed in another order. Subsets of the steps listed above as part of method 1400 may be used to form their own method.

FIG. 14B is a flowchart of an example of a method 1420 for creating a linked list of prime directed edges. Steps 1402-1412 of method 27B are essentially the same as described above in FIG. 14A. However, 1420, after creating a new prime directed edge, instead or in addition to creating an execution node pair (as in step 1414), the newly created prime directed edges is attached to the end of the prime directed edge linked list, and optionally, a variable representing the number of prime directed edges found is incremented.

Steps 1416, 1418, and 1420, are implemented as in method 1400 of FIG. 14A. In other words, the difference between method 1400 (FIG. 14A) and method 1430 (14B) is in FIG. 14A execution node pairs are created for later use by the execution node pair machine, which occurs at step 1414, whereas in FIG. 14B, at the same point in the flow as step 1414, step 1432 is executed in addition to or instead of step 1414 to create a linked list of prime directed edges.

Although in the examples of FIGS. 14A and 14B for each state, after finding an execution pair node or prime directed edge, the track pattern is updated and another execution node pair and/or another prime directed edges is searched for, which has the same initial state (thereby incrementing the track pattern before incrementing the state, in a different embodiment), the state could be implemented before incrementing the track pattern. In other words for each initial memory pattern, the resulting sequence of states and the resulting final memory pattern is computed, before incrementing the initial memory pattern, and the initial memory pattern is not incremented until the results for each initial state in combination with the current initial memory pattern is computed.

In an embodiment, each of the steps of method 1420 is a distinct step. In another embodiment, although depicted as distinct steps in FIG. 14B, step 1402-1432 may not be distinct steps. In other embodiments, method 1420 may not have all of the above steps and/or may have other steps in addition to or instead of those listed above. The steps of method 1420 may be performed in another order. Subsets of the steps listed above as part of method 1420 may be used to form their own method.

### Directed Partition Method

Given a finite sequence (x₁ . . . xₙ) of objects.

Initialize element tuple w₁ to the empty tuple, ( )
Initialize partition tuple P to the empty tuple, ( )
For each element xₖ in sequence (x₁ . . . xₙ)

{

if xₖ is a member of the current element tuple wᵣ
{

Append element tuple wᵣ to the end of partition tuple so that P =
(w₁ . . . wᵣ)
Initialize current element tuple wᵣ₊₁ = (xₖ)

```
  }
  else update wᵣ by appending xₖ to end of element tuple wᵣ
```

}

The final result is the current partition tuple P after element xₙ is examined in the loop. Observe that the tail of elements from (x₁ . . . xₙ) with no repeated elements will not lie in the last element tuple of the final result P.
Directed Partition Method Implemented in newLISP, www.newlisp.org.

(define (add_object element_tuple object)

(if (member object element_tuple) nil

(append element_tuple (list object)) ))

(define (find_partition seq)

(let

| | |
|---|---|
| ( (partition_tuple | ′( ) ) |

| | |
|---|---|
| (element_tuple | ′( ) ) |

| | |
|---|---|
| (test_add | nil) |

```
  )
  (dolist (object seq)
```

```
  (set ′test_add (add_object element_tuple object) )
  (if test_add
```

(set ′element_tuple test_add)
(begin

(set ′partition_tuple (append partition_tuple
(list element_tuple) ) )
(set ′element_tuple (list object) )

) ) )

partition_tuple

))
(set ′seq ′(4 2 3 4 1 3 0 1 2 0 4 2 3 4 1 3 0 1 2 0 4 2 3 4 ) )
> (find_partition seq)
( (4 2 3) (4 1 3 0) (1 2 0 4) (2 3 4 1) (3 0 1 2) (0 4 2 3) )
4 lies in the last tuple (0 4 2 3)

Every Consecutive Repeating Sequence has an Extension Sequence with a Directed Partition Such that the Last Tuple Satisfies the Rule B Property.

Above consecutive repeating sequence was defined (above it was stated that a consecutive repeating sequence is a sequence (x₁, x₂, . . . , xₙ, . . . , x₂ₙ) of length 2n for some positive integer n such that xₖ=xₙ₊ₖ for each k satisfying 1≦k≦n, and an extension sequence is the same consecutive repeating sequence for the first 2n elements (x₁ . . . xₙ . . . x₂ₙ . . . x₂ₙ₊ₘ) such that xₖ=x₂ₙ₊ₖ for each k satisfying 1≦k≦m). The consecutive repeating sequence (x₁, x₂ . . . x₂ₙ) can be extended to the extension sequence (x₁, x₂ . . . x₂ₙ, x₂ₙ₊₁ . . . x₂ₙ₊ₘ), such that m is the minimum positive number such that there is one element in x₂ₙ, x₂ₙ₊₁ . . . x₂ₙ₊ₘ that occurs more than once. Thus, x₂n+k=x₂ₙ₊ₘ for some k satisfying 0≦k<m.

Apply the method for finding directed partitions to S̅=(x₁, x₂ . . . x₂ₙ, x₂ₙ₊₁ . . . x₂ₙ₋ₘ). Then the resulting partition tuple P extends at least until element x₂n and the last tuple in P satisfies rule B. If the partition tuple P is mapped back to the underlying sequence of elements, then it is an extension sequence since it reaches element x₂n.

Any consecutive repeating state cycle is contained in a composition of one or more prime input command sequences. The reason that any consecutive repeating state cycle is contained in a composition of one or more prime input command sequences is as follows. Let σ=[(q₁, a₁) [symbol] . . . (qₙ, aₙ) [symbol] (q₁, a₁) [symbol] . . . [symbol] (qₙ, aₙ)] be a consecutive repeating cycle. Since for fining directed partitions since every consecutive repeating sequence has an extension sequence with a directed partition such that the last tuple satisfies the Rule B property, therefore the sequence of consecutive repeating input commands a may be extended to a minimal extension sequence: [(q₁, a₁) [symbol] . . . [symbol] (qₙ, aₙ) [symbol] (q₁, a₁) [symbol] . . . [symbol] (qₙ, aₙ) [symbol] (q₁, a₁) [symbol] . . . [symbol] (qₘ, aₘ)]

For simplicity, let vₖ denote input command (qₖ, aₖ). Apply the method for finding directed partitions, from above, to (v₁, . . . vₙ v₁ . . . Vₙ V₁ . . . Vₘ), so that the result is the partition tuple P=(w₁, . . . wᵣ). Then the sequence of element tuples in P represent a composition of one or more prime input command sequences. Rules A and B imply that for consecutive tuples wₖ=(vₖ₍₁ vₖ₍₂₎ . . . vₖ₍ₘ₎) and Wₖ₊₁=(v₍ₖ₊₁₎₍₁₎ v₍ₖ₊₁₎₍₂₎ . . . v₍ₖ₊₁₎₍ₘ₎), each of vₖ₍₁₎ vₖ₍₂₎ . . . vₖ₍ₘ₎ are different from one another and each of v₍ₖ₊₁₎₍₁₎ v₍ₖ₊₁₎₍₂₎ . . . v₍ₖ₊₁₎₍ₘ₎w are different form one antoer (rule A) and where one of {vₖ₍₁₎ vₖ₍₂₎ . . . vₖ₍ₘ₎}=v₍ₖ₊₁₎₍₁₎ (according to rule B), then if one forms the a sequence form the first sequence plus only the first element of the second sequence, the new sequence has one and only one repeated element, which is v₍ₖ₊₁₎₍₁₎ and correspondingly, (qₖ₍₁₎, aₖ₍₁₎) [symbol] (qₖ₍₂₎, aₖ₍₂₎) [symbol] . . . [symbol] (qₖ₍ₙ₎, aₖ₍ₘ₎) [symbol] (q₍ₖ₊₁₎₍₁₎, a₍ₖ₊₁₎₍₁₎) is a prime input command sequence, which is contained in the composition of the last two tuples. Also, the fact that every consecutive repeating sequence has an extension sequence with a directed partition such that the last tuple satisfies the Rule B property, implies that the last tuple wᵣ corresponds to a prime input command sequence and that the consecutive repeating state cycle is contained in the partition P mapped back to the sequence of input commands.

### Finite Sequence Rotation

Let (x₀ x₁ . . . xₙ) be a finite sequence. A k-rotation is the resulting sequence (xₖ xₖ₊₁ . . . xₙ x₀ x₁ . . . xₖ₋₁). The 3-rotation of (8 7 3 4 5) is (3 4 5 8 7). When it does matter how many elements it has been rotated, it is called a sequence rotation.

### Rotating a State-Symbol Cycle

Let (q₁, a₁) [symbol] . . . [symbol] (qₙ, aₙ) [symbol] (q₁, b₁) be a state cycle. This state cycle is called a state-symbol cycle if a₁=b₁. A rotation of this state-symbol cycle is the state cycle (qₖ, aₖ) [symbol] . . . [symbol] (qₙ, aₙ) [symbol] (q₁, a₁) [symbol] . . . [symbol] (qₖ, aₖ) for some k satisfying 0≦k≦n. In this case, the state-symbol cycle has been rotated by k−1 steps.

Any consecutive repeating rotated state cycle generated from a consecutive repeating state cycle induces the same immortal periodic orbit. The reason that any consecutive repeating rotated state cycle generated from a consecutive repeating state cycle induces the same immortal periodic orbit is as follows. Let p be the immortal periodic point induced by this consecutive repeating state cycle. Rotating this state cycle by k steps corresponds to iterating p by the next k corresponding affine functions. Since the first symbol-state pair uniquely determine the entire sequence, and since the sequence repeats itself with a fixed period, if one starts anywhere in the cycle, the rest of the cycle will still repeat itself with the same period (as long as the symbols on the tape are shifted to match the states).

### Prime Directed Edges Prime Input Command Sequences

Prime directed edges and prime input command sequences have a 1 to 1 correspondence. The reason prime directed edges and prime input command sequences have a 1 to 1 correspondence is as follows. ( [symbol] ) Let Δ [symbol] σ be a prime directed edge where Δ=[q, v₀ v₁ . . . vₙ, s] and Γ=[r, w₀ w₁ . . . wₙ, t]. From the definition of a prime directed edge, over the next N computational steps some state r is visited twice, all other states in Q are visited at most once and there is a sequence of input commands (q, vₛ) [symbol] (q₁, a₁) [symbol] . . . (r, aₖ) . . . [symbol] (r, wt) corresponding to these N steps.

This is a prime input command sequence.

( [symbol] ) Let (q₁, a₁) [symbol] . . . [symbol] (qₙ, aₙ) be a prime input command sequence with N computational steps. Then qₙ is visited twice and all other states in the sequence are visited only once. Let v₀ v₁ . . . vₙ be the initial tape pattern over the window of execution during the N computational steps. Now a₁=vₛ for some s. Let w₀ w₁ . . . wₙ be the final tape pattern over the window of execution as a result of these N steps. Then aₙ=vₜ for some t. Thus, [q, v₀ v₁ . . . vₙ, s] [symbol] [r, w₀ w₁ . . . wₙ, t] is a prime directed edge.

As an aside, regarding the above discussion of affine transformations, each execution node pair may be represented by a matrix transformation between the elements of the input node and the elements of the output node.

### Upper Bound for the Number of Prime Directed Edges

Each prime head node determines a unique prime directed edge so an upper bound for head nodes provides an upper bound for the number of distinct prime directed edges. Consider prime head node [q, V, s]. There are |Q| choices for the state q. Any pattern that represents the window of execution has length ≦|Q|+1. Furthermore, by the previous remark any pattern P such that (V, s) submatches (P, t) for some t, then the resultant pattern is the same since V spans the window of execution. Thus, |A|^{|Q|+1} is an upper bound for the number of different patterns V.

Lastly, there are two choices for s in a |Q|+1 length pattern because the maximum number of execution steps is |Q| i.e. the tape head move sequence is L^{|Q|} or R^{|Q|}. Thus, |Q| is an upper bound for the number of choices for s unless |Q|=1. The following bound works in the trivial case that |Q|=1. Thus, there are at most |Q|²|A|^{|Q+1} prime directed edges.

EXAMPLE of a 3-state machine prime directed edges and prime input command sequences Consider Turing Machine (Q, A, η). Q={2, 3, 4} and 1 is the halting state. A={0, 1} and η is specified in the following table.

| q | Tₖ | η(q, Tₖ) |
|---|---|---|
| 2 | 0 | (3, 1, L) |
| 2 | 1 | (4, 0, L) |
| 3 | 0 | (4, 1, R) |
| 3 | 1 | (4, 0, R) |
| 4 | 0 | (1, 0, R) |
| 4 | 1 | (2, 0, R) |

| Prime Directed Edges | Prime Input Command Sequences |
|---|---|
| [2, 000, 1] [symbol] [2, 100, 2] | (2, 0) [symbol] (3, 0) [symbol] (4, 1) [symbol] (2, 0) |
| [2, 100, 1] [symbol] [2, 000, 2] | (2, 0) [symbol] (3, 1) [symbol] (4, 1) [symbol] (2, 0) |
| [2, 11, 1] [symbol] [2, 00, 1] | (2, 1) [symbol] (4, 1) [symbol] (2, 0) |
| [2, 001, 1] [symbol] [2, 101, 2] | (2, 0) [symbol] (3, 0) [symbol] (4, 1) [symbol] (2, 1) |
| [2, 101, 1] [symbol] [2, 001, 2] | (2, 0) [symbol] (3, 1) [symbol] (4, 1) [symbol] (2, 1) |
| [3, 010, 0] [symbol] [3, 101, 1] | (3, 0) [symbol] (4, 1) [symbol] (2, 0) [symbol] (3, 0) |
| [3, 110, 0] [symbol] [3, 001, 1] | (3, 1) [symbol] (4, 1) [symbol] (2, 0) [symbol] (3, 0) |
| [4, 10, 0] [symbol] [4, 11, 1] | (4, 1) [symbol] (2, 0) [symbol] (3, 0) [symbol] (4, 1) |
| [4, 11, 0] [symbol] [4, 00, 1] | (4, 1) [symbol] (2, 1) [symbol] (4, 0) |

There are 9 distinct prime state cycles. Observe that |Q|²|A|^{|Q|+1}=3²(4²)=144. Observe that |Q| (|A|+|A|²)=2(2+4)=12. The upper bound for the length of the program appears to not be sharp. Although sharp upper bounds for the number of prime directed edges are important, these types of results are not addressed here.

In what follows prime directed edges are link matched so that for a given Turing Machine a method for finding consecutive repeating state cycles is demonstrated. It is proved that this method will find immortal periodic points if they exist. The expression demonstrate a method for finding is used instead of describe an algorithm in order to not create confusion with the current notion of a Turing algorithm computed by a fixed Turing machine. Below, a dynamic register machine is described that can implement this new method of computing.

### Halting Execution Node

Suppose [q, v₀ v₁ . . . vₙ, s] is an execution node and over the next |Q| computational steps a prime state cycle is not found. In other words, a prime directed edge is not generated. Then the Turing machine execution halted in |Q| or less steps. Let W be a pattern such that (W, t) submatches (V, s) and W spans the window of execution until execution halts. Define the halting node as H=[q, W, t]. As a motivation for this definition, one can think of originally starting with a tape pattern (V,s). However, the execution of the machine halts after just processing a subsequence (W,t) of the original tape pattern.

### Set of all Prime Directed Edges

Remark 8.20 provides an upper bound on the number of prime directed edges. Let P={Δ₁ [symbol] Γ₁, . . . , Δₖ [symbol] Γₖ, . . . , Δ_{N} [symbol] Γ_{N}} denote the finite set of prime directed edges for machine (Q, A, η).

### Overlap Matching of a Node to a Prime Head Node

Execution node Π overlap matches prime head node Δ iff the following hold:
Π=[r, w₀ w₁ . . . wₙ, t] is an execution node satisfying 0≦t≦n
Δ=[q, v₀ v₁ . . . vₙ, s] is a prime head node satisfying 0≦s≦m
State q=State r.
W denotes pattern w₀ w₁ . . . wₙ and V denotes pattern v₀ v₁ . . . vₘ
Pattern (W, t) overlap matches (V, s) as defined in definition of Overlap Matching and Intersection Patterns.

### Overlap Matching Prime Head Nodes are Equal

If Δⱼ=[q, P, u] and Δₖ=[q, V, s] are prime head nodes and they overlap match, then they are equal. (Distinct edges have prime head nodes that do not overlap match.) The reason that overlap matching prime head nodes are equal is as follows.

| | |
|---|---|
| Δₖ | s |
| Δⱼ | u |
| Ω | m |

0≦u≦|Δⱼ| and 0≦s≦|Δₖ|.
Let (I, m)=(P, u)∩(V, s) where m=min{s, u}
Suppose the same machine begins execution on tape I with tape head at m in state q. If s=u and |Δⱼ|=|Δₖ|, then the proof is complete.

Otherwise, s≠u or |Δⱼ|≠*|Δₖ| or both. has a window of execution [0, |Δⱼ|−1] and Δₖ has window of execution [0, |Δₖ|−1]. Let the ith step be the first time that the tape head exits finite tape I. This means the machine would execute the same machine instructions with respect to Δⱼ and Δₖ up to the ith step, so on the ith step, Δⱼ and Δₖ must execute the same instruction. Since it exits tape I at the ith step, this would imply that either pattern P or V are exited at the ith step. This contradicts either that [0,|Δⱼ|−1] is the window of execution for 0ᵢ or [0, |Δₖ|−1] is the window of execution for Δₖ.

### Edge Node Substitution Operator Π⊕(ΔΓ)

Let Δ [symbol] Γ be a prime directed edge with prime head node Δ=[q, v₀ v₁ . . . vₙ, s] and tail node Γ=[r, w₀ w₁ . . . wₙ, t]. If execution node Π=[q, p₀ p₁ . . . pₘ, u] overlap matches Δ, then the edge pattern substitution operator from 7.2 induces a new execution node Π⊕(Δ [symbol] Γ)=[r, (P, u)⊕[(V, s) [symbol] (W, t)], k] with head k=u+t−s if u>s and head k=t if u≦s such that 0≦s, t≦n and 0≦u≦m and patterns V=v₀ v₁ . . . vₙ and W=w₀ w₁ . . . wₙ and P=p₀ p₁ . . . pₘ.

### Prime Directed Edge Sequence and Link Matching

A prime directed edge sequence is defined inductively. Each element is a coordinate pair with the first element being a prime directed edge and the second element is an execution node. Each element is abstractly expressed as (Δₖ [symbol] Γₖ, Πₖ).

The first element of a prime directed edge sequence is (Δ₁ [symbol] Γ₁, Π₁) where Π₁=Γ₁, and Δ₁ [symbol] Γ₁ is some prime directed edge in P. For simplicity in this definition, the indices in P are relabeled if necessary so the first element has indices equal to 1. If Π₁ overlap matches some non-halting prime head node Δ₂, the second element of the prime directed edge sequence is (Δ₂ [symbol] Γ₂, Π₂) where Π₂=⊕(Δ₂ [symbol] Γ₂). This is called a link match step.

Otherwise, Π₁ overlap matches a halting node, then the prime directed edge sequence terminates. This is expressed as [(Δ₁ [symbol] Γ₁, Γ₁), HALT]. In this case it is called a halting match step.

If the first k−1 steps are link match steps, then the prime directed edge sequence is denoted as [(Δ₁ [symbol] Γ₁, Π₁), (Δ₂ [symbol] Γ₂, Π₂) , . . . , (Δₖ [symbol] Γₖ, Πₖ)] where Πⱼ overlap matches prime head node Δⱼ₊₁ and Πⱼ₊₁=Πⱼ⊕(Δⱼ₊₁ [symbol] Γⱼ₊₁) for each j satisfying 0≦j<k.

Implementing C Code with Execution Node Pairs

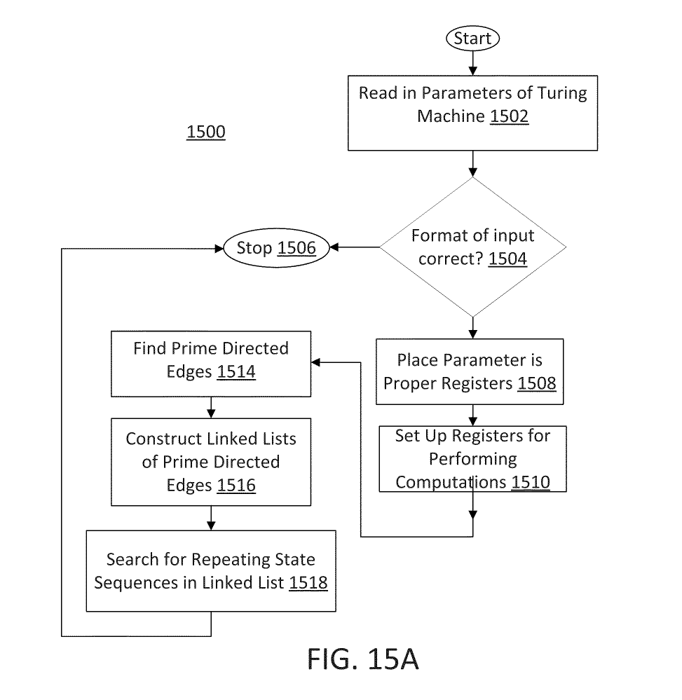

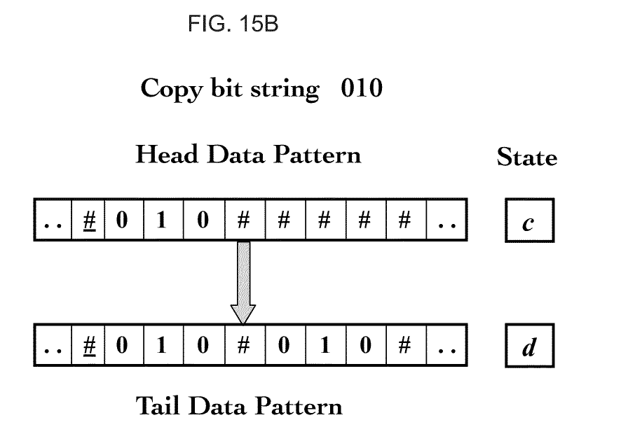

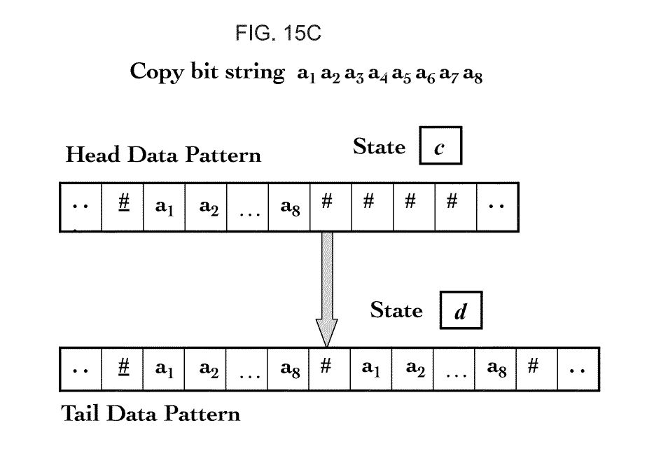

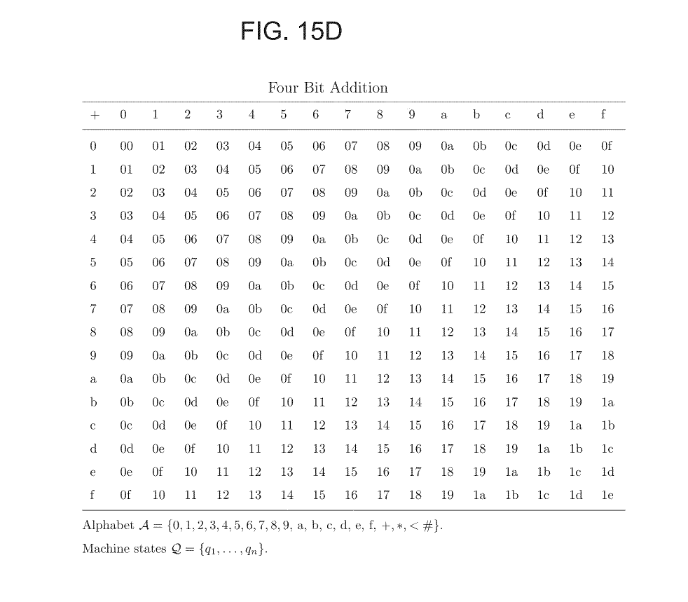

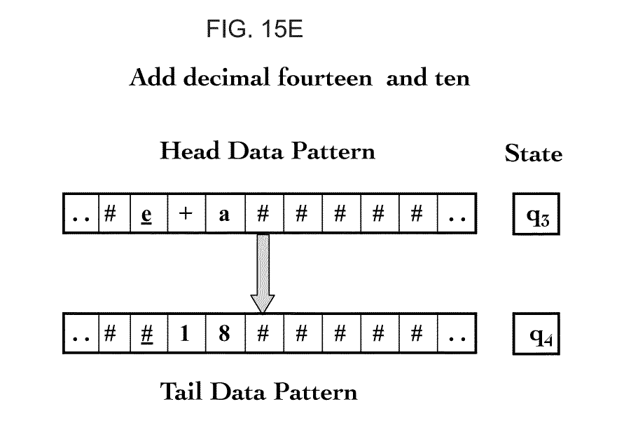

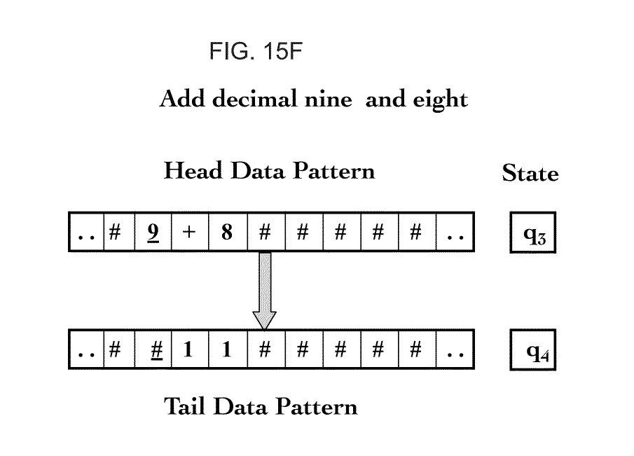

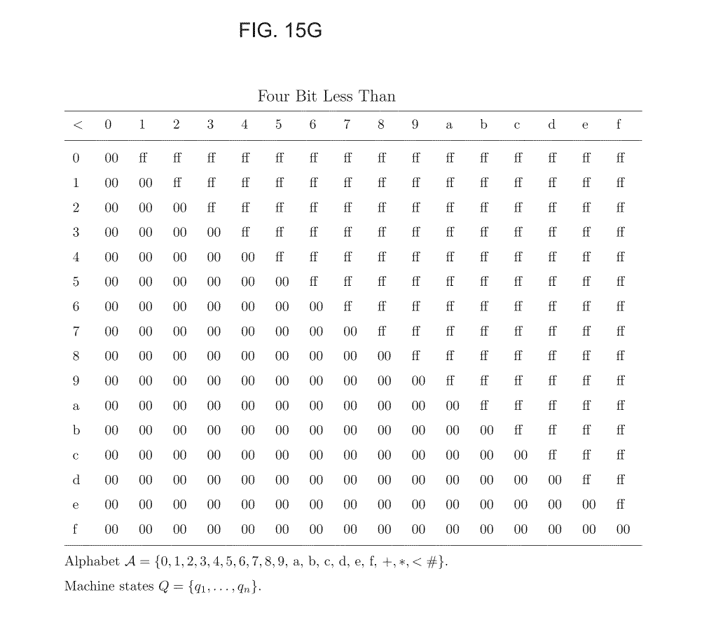

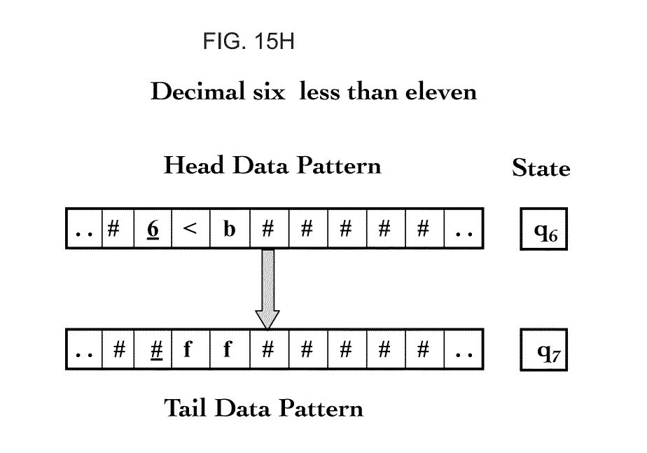

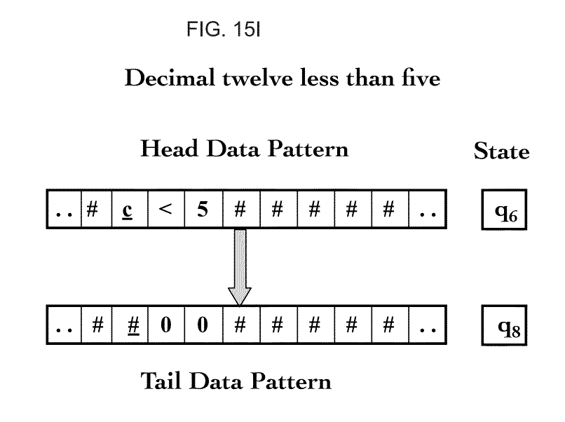

Consider FIG. 15B. In FIG. 15B, the head node is [c,#010####, 0] and the tail node is [d, #010#010, 0]. The execution of the node pair of FIG. 15B copies the bit string 010 from one memory location associated with the variable a, and stores the bit stream 0101 to another memory location associated with the variable x. When the machine matches a portion of the memory (e.g., the tape) to the sequence of symbols in the head node of FIG. 15B, the sequence of symbols of the tail node of FIG. 15B replaces the corresponding sequence of symbols in memory. Pairs of execution nodes, such as those illustrated in FIG. 15B, compute the assignments in the C programming language or another programming language such as JAVA, Ruby, BASIC, or Haskell.

Similarly, in C, the assignment statement

unsigned char x=a;

can be computed using the pair of execution nodes in FIG. 15C. In FIG. 15C, the head execution node is [c,# a₁ a₂ a₃ a₄ as a₆ a₇ a₈ # # # # # # # # #, 0], and the tail execution node is [d,# a₁ a₂ a₃ a₄ as a₆ a₇ as # a₁ a₂ a₃ a₄ as a₆ a₇ as, 0]. When the machine matches a portion of memory (associated with the symbol a) to the sequence of symbols in the head node of FIG. 15C, the sequence of symbols of the tail node of FIG. 15C replaces the corresponding sequence of symbols in memory, which writes the sequence of symbols in a to a second memory location, which is associated with x. The interpretation of the replacement is that the variable x stores the second copy of a₁ a₂ a₃ a₄ as a₆ a₇ as in memory.

FIG. 15D shows a table that contains the information for pairs of execution nodes that perform four bit addition. For all of the head and tail nodes described below, pertaining to FIGS. 15E and 15F, the alphabet is A={0, 1, 2, 3, 4, 5, 6, 7, 8, 9, a, b, c, d, e, f, +, *, <, #} and the machine states are Q={q₁, . . . , qₙ}. FIG. 15E shows an instantiation of one member of the table in FIG. 15D. FIG. 15E shows a head node [q₃, e+a, 0] and tail node [q₄, #18, 0], and performs addition of decimal numbers fourteen and ten as follows.

Consider the following two lines of C code:

unsigned char x=14, y=10, z;

z=x+y;

If z points to #18, then the pair of execution nodes in FIG. 15E, computes z=x+y. The numbers in FIG. 15E are represented in base 16 (hexadecimal), as are all numbers in the table in FIG. 15D: ‘a’ corresponds to ten, ‘b’ corresponds to eleven, ‘c’ corresponds to twelve, ‘d’ corresponds to thirteen, ‘e’ corresponds to fourteen, and ‘f’ corresponds to fifteen.

FIG. 15F shows head node [q3, 9+8, 0] and tail node [q4, #11, 0], which adds decimal numbers nine and eight. The result is 11, which is the hexadecimal (or base 16) representation of the base 10 number 17.

FIG. 15G shows a table which contains the information for pairs of execution nodes that perform four bit less than operation.

FIGS. 15G, 15H and 15I illustrate how pairs of execution nodes can perform a control statement such as if (x<y) then { }. FIG. 15H shows a pair of execution nodes [q6, c<6, 0] (the head node) and [q7,#ff, 0] (the tail node) derived from the table in FIG. 15G. As a reminder the ‘c’ in the expression c<6 in the head node is the hexadecimal digit c. The pair of execution nodes of FIG. 15G compares decimal numbers six and eleven (as part of performing the less than operation), and #ff indicates that this comparison is true. FIG. 15I shows a pair of execution nodes [q6, c<5, 0] (the head node) and [q8, #00, 0] (the tail node) that compares (less than) decimal numbers twelve (which in hexadecimal is c) and five, and the string #00 in the tail node indicates that the comparison is false. The machine state q₇ in the tail node of the pair of execution nodes shown in FIG. 15H is different from machine state q₈ in the tail node of the pair of execution nodes shown in FIG. 15I: having a difference in state enables machine states q₇ and q₈ to act as two different paths of control, needed in an if (x<y) then { }; else { } statement.

Similarly, a for {statement1; . . . statementN;} loop in C can be constructed by making the state of the tail node perform the last statement (statement N) equal to one state upon entering the for loop. The exit condition of the for loop is similar to that shown in FIGS. 15H and 15I, where once the machine is ready to exit the loop, the state of the machine is changed to a new machine state (analogous to state q₈ in FIG. 15I), based on the machine state that is in the tail node corresponding to the head node that determines that the exit condition of the for loop is true. Although the examples of FIGS. 15B-15I show how to perform an assignment, addition, a comparison, an if statement, and loop, using execution node pairs as computer instructions, other instructions can be performed in similar fashions and/or can be built from assignment, addition, comparisons, if statements, and loops.

The same operations as described above in conjunction with FIGS. 15B-15I could also be performed with prime directed edges, using overlap matching to determine which prime directed edge to apply.

Edge Sequence Notation E([p₁, p₂, . . . , pₖ], k)

To avoid subscripts of a subscript, pₖ and the subscript p₍ⱼ₎ represent the same number. As defined in the prime directed edge sequence and link matching method, P={Δ₁ [symbol] Γ₁, . . . , Δₖ [symbol] Γₖ, . . . , Δ_{N} [symbol] Γ_{N}} denotes the set of all prime directed edges. E([p₁], 1) denotes the edge sequence [(A_{P(1)} [symbol] Γₚ₍₁₎, Πₚ₍₁₎)] of length 1 where Πₚ₍₁₎=Γₚ₍₁₎ and 1≦p₁≦|P|. Next E([p₁, p₂], 2) denotes the edge sequence [(Δₚ₍₁₎ [symbol] Γₚ₍₁₎, Πₚ₍₁₎), (Δₚ₍₂₎ [symbol] Γₚ₍₂₎, Πₚ₍₂₎)] of length 2 where Πₚ₍₂₎=Πₚ₍₁₎⊕(Δₚ₍₂₎ [symbol] Γₚ₍₂₎) and 1≦p₁, p₂≦|P|.

In general, E([p₁, p₂, . . . , pₖ], k) denotes the edge sequence of length k which is explicitly [(Δₚ₍₁₎ [symbol] Γₚ₍₁₎, Πₚ₍₁₎), (Δₚ₍₂₎ [symbol] Γₚ₍₂₎, Πₚ₍₂₎), . . . , (Δₚ₍ₖ₎ [symbol] Γₚ₍ₖ₎, Πₚ₍ₖ₎)] where Πₚ₍ⱼ₊₁₎=Πₚ₍ⱼ₎⊕(Δₚ₍ⱼ₊₁₎ [symbol] Γₚ₍ⱼ₊₁₎) for each j satisfying 1≦j<k−1 and 1≦p(j)≦|P|.

### Edge Sequence Contains a Consecutive Repeating State Cycle

The fact that prime directed edges and prime input command sequences have a 1 to 1 correspondence implies that an edge sequence corresponds to a composition of prime input commands. The expression an edge sequence contains a consecutive repeating state cycle is used if the corresponding sequence of prime input commands contains a consecutive repeating state cycle.

Any consecutive repeating state cycle of (Q, A, η) is contained in an edge sequence of (Q, A, IA The reason that any consecutive repeating state cycle of (Q, A, η) is contained in an edge sequence of (Q, A, η) follows immediately from the fact that (1) edge sequence contains a consecutive repeating state cycle is used to describe an edge sequence of prime directed commands containing an a consecutive repeating state cycle and (2) any consecutive repeating state cycle is contained in a composition of one or more prime input command sequences and (3) prime directed edges and prime input command sequences have a 1 to 1 correspondence.

### Period of an Immortal Periodic Point Contained in Edge Sequence

If E([p₁, p₂, . . . , pᵣ], r) contains a consecutive repeating state cycle, then the corresponding immortal periodic point has period

$$\leq \frac{1}{2} {\sum }_{k = 1}^{r} \vert {Δ}_{p ( k )} ⇒ {Γ}_{p ( k )} \vert .$$

The reason that the corresponding immortal periodic point has period is

$$\leq \frac{1}{2} {\sum }_{k = 1}^{r} \vert {Δ}_{p ( k )} ⇒ {Γ}_{p ( k )} \vert$$

because a consecutive repeating state cycle induces an immortal periodic point. The length of the state cycle equals the period of the periodic point. Further, the number of input commands corresponding to the number of computational steps equals |Δₚ₍ₖ₎ [symbol] Γₚ₍ₖ₎| in directed edge Δₚ₍ₖ₎ [symbol] Γₚ₍ₖ₎.

### Finding a Consecutive Repeating State Cycle in an Edge Sequence

Given an edge sequence whose corresponding prime input command sequence (q₀, a₀) [symbol] (q₁, a₁) [symbol] . . . [symbol] (q_{N}, a_{N}) has length N.

```
  Set n = N / 2 if N is even; otherwise, set n = (N +1) / 2 if N is
  odd
```

for each k in {1, 2, . . ., n }
{

for each j in {0, 1, . . ., N − 2k − 1}
{

if sequence (qⱼ, aⱼ) [symbol] (qⱼ₊₁, aⱼ₊₁) [symbol] . . . [symbol] (qⱼ₊ₖ, aⱼ₊ₖ) equals

sequence (qⱼ₊ₖ₊₁, aⱼ₊ₖ₊₁) [symbol] (qⱼ₊ₖ₊₂, aⱼ₊ₖ₊₂) [symbol] . . . [symbol] (qⱼ₊₂ₖ₊₁,
aⱼ₊₂ₖ₊₁)

then
{

return consecutive repeating state cycle

(qⱼ, aⱼ) [symbol] (qⱼ₊₁, aⱼ₊₁) [symbol] . . . [symbol] (qⱼ₊ₖ, aⱼ₊ₖ) [symbol] . . . [symbol] (qⱼ₊₂ₖ₊₁,
aⱼ₊₂ₖ₊₁)

}

}

}

If exited outer for loop without finding a consecutive repeating state cycle, return NO consecutive repeating state cycles were found.

EXAMPLE of A newLISP function that finds a consecutive repeating sequence

(define (find_pattern_repeats p_length seq)

(let

(

(k 0) !! this line initializes an index k, at k=0
(max_k (− (length seq) (+ p_length p_length)) ) !!

this line sets the maximum for the the index k.

(pattern nil) !! this initializes the variable pattern as
having a null value.
(repeat_pair nil) !! this initializes the variable repeat
pattern as having a null value.
(no_repeats true) !! this initializes the logical variable

no repeats has having the value true.

```
  )
  (while (and (<= k max_k) no_repeats)
```

```
  (set ′pattern (slice seq k p_length))
  (if (= pattern (slice seq (+ k p_length) p_length))
```

(begin

(set ′repeat_pair (list pattern k))
(set ′no_repeats false) !! this sets no_repeats
to false

)

```
  )
  (set ′k (+ k 1)) !! this increments k by 1.
```

```
  )
  repeat_pair
```

))
(define (find_repeats seq)

(let

(

```
  (p_length 1)
  (max_p_length (/ (length seq) 2) )
  (repeat_pair nil)
```

)
(while (and (<= p_length max_p_length) (not repeat_pair) )!! If

p_length <= max_length and repeat_pair is false repeat the following

steps (set ′repeat_pair (find_pattern_repeats p_length seq))

!! finds a repeat of the pattern for patterns of length p_length, and sets

repeat pair to false if a pair of repeated sequences is found
(set ′p_length (+ p_length 1)) !! increment p_length by 1.

)
repeat_pair

))
(set ′s1 ′(3 5 7 2 3 5 7 11 5 7) )
;; s1 does not have a consecutive repeating sequence.
(set ′s2 ′(3 5 7 2 3 5 7 11 5 7 11 2 4 6 8 ) )
;; 5 7 11 5 7 11 is a consecutive repeating sequence starting at element in
list s2
(set ′s3 ′(1 2 0 2 1 0 2 0 1 2 0 2 1 0 1 2 1 0 2 1 2 0 2 1 0 1 2 0 2 1 2 0 1 2
1 0 1 2 0 1 0 1))
;; 0 1 0 1 is a consecutive repeating sequence starting at element 38 in list
s3
> (find_repeats s1)
nil
> (find_repeats s2)
( (5 7 11) 5)
> (find_repeats s3)
( (0 1) 38)

### Prime Directed Edge Search Method

Given Turing Machine (Q, A, η) as input, the search method works as follows.

Set P=Ø. For each non-halting state q in Q
For each pattern a_{-|Q|} . . . a₋₂ a₋₁ a₀ a₁ a₂ . . . a_{|Q|} selected from A^{2|Q|+1}

{

| | | | | | | | | | |
|---|---|---|---|---|---|---|---|---|---|
| Tape Square | −\|Q\| | | −2 | −1 | 0 | 1 | 2 | | \|Q\| |
| Tape Contents | a_{-\|Q\|} | . . . | a₋₂ | a₋₁ | a₀ | a₁ | a₂ | . . . | a_{\|Q\|} |
| Start State | Q | | | | | | | | |

With tape head located at a₀, start executing machine (Q, A, η) until one
state has been visited twice or (Q, A, η) reaches a halting state. The
Dirichlet principle implies this will take at most |Q| computational steps.
If it does not halt, let r be the state that is first visited twice. As defined
in the prime directed edge from head and tail execution nodes above,
over this window of execution, a prime directed edge Δ [symbol] Γ is
constructed where Δ = [q, v₀ v₁ . . . vₙ, s], Γ = [r, w₀ w₁ . . . wₙ, t] and
0 ≦ s, t ≦ n ≦ |Q|.
Set P = P ∪ {Δ [symbol] Γ} (in other words, in this last step, add the prime
directed edge that was found to the collection of prime directed edges).

}

### Prime Directed Edge Search Method Finds all Prime Directed Edges

The prime directed edge search finds all prime directed edges of (Q, A, η) and all halting nodes.

PROOF. Let Δ [symbol] Γ be a prime directed edge of (Q, A, η). Then Δ [symbol] Γ has a head node

Δ=[r, v₀ v₁ . . . vₙ, s], for some state r in Q, for some tape pattern v₀ v₁ . . . vₙ that lies in Aⁿ⁺¹, such that n≦|Q| and 0≦s≦n. In the outer loop of the prime directed edge from head and tail execution nodes, when r is selected from Q and in the inner loop when the tape pattern a_{-|Q|} . . . a₋₂ a₋₁ a₀ a₁ a₂ . . . a_{|Q|} is selected from A^{2|Q|1} such that

a₀=vₛ a₁=vₛ₊₁ . . . aₖ=vₛ₊ₖ . . . aₙ₋ₛ=vₙ

a₋₁=a₋₂=vₛ₋₂ . . . a₋ₖ=vₛ₋ₖ . . . a₋ₛ=v_{O}

then the machine execution in the prime directed edge from head and tail execution nodes will construct prime directed edge Δ [symbol] Γ.

When the head node is a halting node, the machine execution must halt in at most |Q| steps. Otherwise, it would visit a non-halting state twice and thus, be a non-halting head node. The rest of the argument for this halting node is the same as for the non-halting head node.

FIG. 15A, which will be discussed below, shows a method finding immortal periodic points (infinite loops with a periodic behavior).

### Immortal Periodic Point Search Method

Given a valid periodic Turing Machine (Q, A, η) as input, the method works as follows.

Use the prime directed edge search method, above, of FIG. 27B to find all prime directed edges, P_{new}

set k = 1.
set Φ(1) = { E([1], 1), E([2], 1), . . . , E([ |P| ], 1) } !! each E([i],j)
represents an edge node
sequence
while ( Φ(k) ≠ Ø )
{

```
  set Φ(k+1) = Ø.
  for each E([p₁, p₂, . . ., pₖ], k) in Φ(k)
{
```

for each prime directed edge Δⱼ [symbol] Γⱼ in P
{

```
  if Δⱼ [symbol]   Γⱼ link matches with Πₚ₍ₖ₎ then
  {
```

set pₖ₊₁ = j
set Φ(k+1) = Φ(k+1) ∪ E([p₁, p₂, . . ., pₖ, pₖ₊₁], k+1)
if E([p₁, p₂, . . ., pₖ, pₖ₊₁], k+1) contains a consecutive
repeating state cycle
then return the consecutive repeating state cycle

}

}

```
  }
  k is incremented.
```

}
if (while loop exited because Φ(m) = Ø for some m) then return Ø.

Note that |Φ(k)| is finite and |Φ(k)|≦|P|^{k}

The reason that |Φ(k)| is finite and |Φ(k)|/≦|P|^{k} is as follows. |Φ(1)|=|P|. Analyzing the nested loops, in the immortal periodic point search method

for each E([p₁, p₂, . . . , pₖ], k) in Φ(k)

for each Δⱼ [symbol] Γⱼ in P { . . . }

For each edge sequence E([p₁, p₂, . . . , pₖ], k) chosen from Φ(k), at most |P| new edge sequences are put in Φ(k+1). Thus |Φ(k+1)|≦|P∥Φ(k)|, so |Φ(k)≦|P|^{k}.

When (Q, A, η) is a periodic machine, method the immortal periodic point search method terminates in a finite number of steps with either a consecutive repeating state cycle or for some positive integer J, then Φ(J)=Ø. The reason that the immortal periodic point search method terminates in a finite number of steps with either a consecutive repeating state cycle or for some positive integer J, then Φ(J)=Ø is as follows. If (Q, A, η) has at least one configuration (q, k, T) that is an immortal point, then by definition a Turing machine that has at least one periodic configuration, whenever it has an immortal configuration is said to be a periodic Turing machine, which implies the existence of a periodic point p with some finite period N.

Thus, since every immortal periodic point induces a consecutive repeating state cycle, there is a consecutive repeating state cycle that corresponds to the immortal periodic orbit of p. Since the immortal periodic point search method searches through all possible prime edge sequences of length k, a consecutive repeating state cycle will be found that is contained in a prime directed edge sequence with length at most 2N. Thus, this immortal periodic point of period N will be reached before or while computing Φ(2N). Otherwise, (Q, A, η) does not have any configurations with an immortal orbit. In other words, for every configuration, (Q, A, η) halts in a finite number of steps.

Claim: There is a positive integer J such that every edge sequence terminates while executing the immortal periodic point search method. By reductio absurdum, suppose not. Then there is at least one infinite prime directed edge sequence that exists: this corresponds to an immortal orbit, which contradicts that (Q, A, η) does not have any configuration with an immortal orbit.

Immortal and Mortal Configuration

If a configuration (which may also be referred to as an Instantaneous Description (ID)) upon execution of Turing Machine (Q, A, η) halts after a finite number of computational steps, then it is called a mortal configuration (which may be referred to as a mortal ID). Otherwise a configuration (ID) is called immortal.

### Halting Machine

Turing Machine (Q, A, η) is called a halting machine if it contains only mortal (halting) configurations.

### Periodic Turing Machine

A Turing machine (Q, A, η) that has at least one periodic configuration, whenever it has an immortal configuration is said to be a periodic Turing machine.

|Φ(k)| is finite and |Φ(k)|≦P|^{k} determines whether (Q, A, η) is a halting machine when (Q, A, η) is a periodic machine. This follows immediately that since when (Q, A, η) is a periodic machine, method immortal periodic point search method terminates in a finite number of steps with either a consecutive repeating state cycle or for some positive integer J, then Φ(J)=Ø) and the immortal periodic point search method.

Turing Immortality Problem and Halting Problem

The classic result of Turing machine theory is the undecidability of the problem of determining for a given configuration of a Turing machine (Q, A, η) is whether this configuration is immortal or mortal. This is called the halting problem.

The immortality problem is the problem of deciding for a given Turing machine (Q, A, η) whether it is a halting machine; in other words, determining whether an immortal configuration exists for the machine (Q, A, η).

Immortal Dynamic Register Machine

In the next section, a complete description of a dynamic register machine program, called an IDRM, is presented. This embodiment of a computing system implements the prime directed edge search method and the immortal periodic point search method, which includes the method of finding a consecutive repeating state cycle in an edge sequence. In this section, the design of this machine is explained from a human-friendly perspective. This section describes how the Turing machine (Q, A, η) is represented and where it is located in the registers of the IDRM. This section also describes how the prime directed edge search method and the immortal periodic point search method are implemented and executed by the IDRM program.

Below, the complete program of 1590 instructions composed from the Constant (C m n), Successor (S m), Transfer (T m n), Address (A m n), Jump (J m n q), Delete (D m n), and Update (U m n q) Instructions. With a valid periodic Turing Machine as input in its registers, this IDRM solves the Turing Immortality problem for periodic Turing Machines after a finite number of execution steps.

### Turing Machine State, Alphabet and Command

The states Q of machine (Q, A, η) are represented with the natural numbers {1, 2, . . . , |Q|}. The alphabet symbols are represented with natural numbers {1, 2, . . . |A|}. The function η determines all the Turing machine commands. A Turing machine command is of the form (q a r b m) where 2≦q≦|Q|, where 1≦r≦|Q|, where 1≦a, b≦|A| where 1≦m≦2. The variable m=1 represents a left tape move and m=2 represents a right tape head move. As described in definition of a Turing machine, the design of the IDRM assumes that 1 with respect to Q is the halting state. This is why q≧2.

### Representation of Turing Machine Program as Input in the IDRM Registers

Registers 0 to 155 are reserved for computation, program flow and important constants. The design of the IDRM assumes that registers 156 through 160 contain the first Turing machine command, which is of the form (2 1 r b m). Further, it is assumed that the instructions for the Turing machine are dictionary ordered over the first two coordinates. In other words, each Turing machine command of the form (q a r b m) is stored as follows:

A.) q is stored in register number 5(q−1)a+151

B.) a is stored in register number 5(q−1)a+152

C.) r is stored in register number 5(q−1)a+153

D.) b is stored in register number 5(q−1)a+154

E.) m is stored in register number 5(q−1)a+155

F.)

The initial register contents starting at register 156 are shown in the table:

| | | | | | | | | | | | | | | | | | |
|---|---|---|---|---|---|---|---|---|---|---|---|---|---|---|---|---|---|
| 2 | 1 | r₂₁ | b₂₁ | m₂₁ | 2 | 2 | r₂₂ | b₂₂ | m₂₂ | • | • | • | 2 | \|A\| | r_{2\|A\|} | b_{2\|A\|} | m_{2\|A\|} |
| 3 | 1 | r₃₁ | b₃₁ | m₃₁ | 3 | 2 | r₃₂ | b₃₂ | m₃₂ | • | • | • | 3 | \|A\| | r_{3\|A\|} | b_{3\|A\|} | m_{3\|A\|} |
| 4 | 1 | r₄₁ | b₄₁ | m₄₁ | 4 | 2 | r₄₂ | b₄₂ | m₄₂ | • | • | • | 4 | \|A\| | r_{4\|A\|} | b_{4\|A\|} | m_{4\|A\|} |
| • | • | • | • | • | • | • | • | • | • | • | • | • | • | • | • | • | • |
| \|Q\| | 1 | r_{\|Q\|1} | b_{\|Q\|1} | m_{\|Q\|1} | \|Q\| | 2 | • | • | • | • | • | • | \|Q\| | \|A\| | r_{\|Q\|\|A\|} | b_{\|Q\|\|A\|} | m_{\|Q\|\|A\|} |
| 0 | | | | | | | | | | | | | | | | | |

This means register 157 contains a 1; register 158 contains r₂i; register 159 contains b₂₁ register 160 contains m₂₁; register (160+5|A|) contains m₃₁ and so on.

The 0 in register number 5(|Q|−1)|A|+156 indicates the end of the Turing machine program. At the beginning of program execution, the design of the IDRM assumes that register 0 contains the address 5(|Q|−1)|A|+156. In other words, (R 0)=5(|Q|−1)|A|+156. This assumption is made so that the IDRM can determine if the Turing machine program is presented in a valid format in registers 156 through register 5(|Q|−1)|A|+155. This is analogous to the notion of a well-formed formula in mathematical logic. See [ENDERTON].

In other embodiments, the registers could be virtual registers, the registers could be numbered differently, and/or the contents of the memory could be stored in another manner. FIG. 28 shows a flowchart for a method of finding infinite loops. FIG. 28 is discussed in conjunction with a description of the computer program, below, as an example.

### Description of IDRM Program Summary

As an overview of the computer program below, in the program below, overall, the purpose of instructions 0 to 296 in the IDRM program is to check that the Turing machine (Q, A, η) is stored in a valid format starting at register 156 and to set up registers for specific purposes based on ‥Q| and |A| in machine.

Overall, the purpose of instructions 297 to 857 in the IDRM is to construct a linked list of all, if any exist, the prime directed edges of the given Turing Machine (Q, A, η) whose command set starts at register 156. These 858 instructions execute the prime directed edge search method. After the prime directed edge search method described in the the prime directed edge search method is completed, instructions 858 to 1589 of the IDRM program execute the immortal periodic point search method. Next, further details of the IDRM program are discussed.

### Description of IDRM Program Instructions 0 to 296

In step 1502, parameters of the program being checked are read into the system. In step 1504, a determination is made whether the input has the correct format. As an example, in the embodiment of the program below, instructions 0 through 126 in the IDRM determine whether the Turing machine represented in registers 156 through register (5(|Q|−1)|A|+155) is in a valid format.

If in step 1504, a determination is made that the instructions are not in the correct format, the method proceeds to step 1506, and in step 1506 the method terminates. Optionally, an error message may be returned. For example, in the program below, if not the format is not correct, then execution of the IDRM jumps to instruction 1570 and writes “ERROR TURING PROGRAM” in registers 0 through 19 using the ASCII code representation. In other words, 65 corresponds to “A”; 69 corresponds to “E”; 82 corresponds to “R” and so on. Checking the validity of the format helps assure that the execution of the IDRM always terminates regardless of the initial contents of the registers in the IDRM.

Returning to step 1504, if the format is correct, the method proceeds to step 1508. In step 1508, the parameters are placed in their proper registers. In step 1510, the registers are set up for performing computations. Observe that in the example below rather than omitting a Turing machine command, in contrast to the convention in [TURING] and [DAVIS], if η(q, a) halts, the IDRM uses the convention (q a 1 b m) to represent this halting instruction as specified in section 2. Regarding the representation of the instruction (q a 1 b m) in the example below, the natural number q is stored in register 5(q−1)a+151; the number a is stored in register 5(q−1)a+152; 1 is stored in register 5(q−1)a+153; b is stored in register 5(q−1)a+154; and m is stored in register 5(q−1)a+155.

Regarding the setting up of the registers, in the example, below, after the 0 in register (5(|Q|−1)|a|+156) there are four unused registers, followed by the A offsets: A₂, A₃, . . . A_{|Q|}. The A offsets are used to help the IDRM more effectively lookup the next Turing command based on the prior state and tape symbol. The A offsets are determined and stored by instructions 127 through 153 of the IDRM.

After the A offsets, some registers are used to store information necessary to do the prime edge computations for each tape pattern element. The location of these registers are based on the values of |A| and |Q|. In more detail, instructions 154 through 296 set up a scratch pad of registers needed to execute the prime directed edge search method i.e. the finding and storing of all prime directed edges of (Q, A, η)—if any exist. In particular, instructions 154 through 167 set up registers to record the current prime input command sequence. Instructions 168 to 190 set up registers to record the current prospective head node. Instructions 191 to 212 set up registers to record the current prospective tail node.

Instructions 213 to 233 set up registers to record the execution tape during the computation of a prospective prime directed edge. Instructions 234 to 254 set up registers to store an iteration tape, which is used to iterate through every tape pattern in A^{2|Q|+1}. Instructions 255 to 265 set up registers to record the tape head moves during the computation of the prospective prime edge. Instructions 266 to 292 set up registers to compute the window of execution. Instructions 293 to 296 set up memory pointers to record the number of prime edges found so far and store a linked list of prime edges. In instruction 296, a free heap pointer is stored in register 155. In step 1514, method 1500 searches for (e.g., by computing) the prime directed edges.

Description of the IDRM Program Implements Method 1400 (FIG. 14A) and/or the Prime Directed Edge Search Method

For example, for each non-halting state q in Q and for each tape pattern in A^{2|Q|+1} the IDRM program executes machine (Q, A, η) for at most n≦|Q| computational steps of the Turing machine. As a result, this particular tape pattern and starting state q form a prime directed edge or they do not. If they do, the prime directed edge is stored in a prime edge linked list.

Each element (node) in the prime edge linked list is stored contiguously in registers as follows: next_node, pe_number, h_node, t_node, s_node, n, q, s, s_p, v₀, v₁ . . . vₙ, r, t, t_p, w₀, w₁ . . . wₙ, 2N, (q, vₛ), (q₁, a₁) . . . (q_{N}, a_{N}). In other words, if next_node is stored in register 7000, then pe_number is stored in register 7001. h_node (the head node) is stored in register 7002. t_node (the tail node) is stored in register 7003. s_node is stored in register 7004. n is stored in register 7005. q (the state) is stored in register 7006. s is stored in register 7007. s_p is stored in register 7008, and so on.
The contents of register next_node stores the register number of the next_node.
The register contents pe_number stores the name (a number) of this prime edge.
Register h_node contains the address of the register state q in the head node.
Register t_node contains the address of the register state r in the tail node.
Register s_node contains the address of the number 2N in the prime input command sequence.
The window of execution size is stored in the register n
q is the state of the head node.
s is the index of the head node.
s_p points to the location of tape symbol vₛ (i.e. index pointer of the head node)
r is the state of the tail node.
t is the index of the tail node.
t_p points to the location of tape symbol vₛ (i.e. index pointer of the head node)
N is the number of computational steps for this prime directed edge.
N+1 is the number of prime input commands in the prime input command sequence.
Tape symbol a₀=Tape symbol vₛ
State r=State q_{N}
Register 81 stores the number of prime directed edges.
The node numbers count sequentially up to the number of prime directed edges.
v₀, v₁ . . . vₙ is the initial tape pattern of the head node.
w₀, w₁ . . . wₙ is the final tape pattern of the tail node.
(q, vₛ), (q₁, a₁), . . . , (q_{N}, a_{N}) is the prime input command sequence corresponding to this prime directed edge.

Now that the data structure for representing and storing prime directed edges in the registers has been described, more detail is provided on the instructions 297 to 857 that execute the prime directed edge search method.

In particular, instructions 297 to 313 initialize the tape pattern in A^{2|Q|+1} to all 1's. Instruction 314 begins the outer loop that iterates from state 2 up to state |Q|. This is the outer for loop in method the prime directed edge search, expressed as: For each non-halting state q in Q.

Instructions 331 to 349 copy the iterated tape pattern, starting at the register pointed to by register 68. Instruction 334 stores the value of 2|Q|+1 in register 2. Instructions 350 to 367 initialize the prospective head node state and the tape symbols. Instructions 371 to 395 initialize register 33 to the correct command (q a r b m) in the Turing command table. The current state q of the Turing machine is stored in register 65. The current tape symbol a is stored in register 66.

Instructions 396 to 408 store (qₖ aₖ) in the register that is pointed to by the contents of register 51. Instructions 409 to 483 execute one computational step of the Turing machine whose command table starts at register 156. Instruction 484 increments register 48 which stores the number of computational steps for this prospective prime directed edge.

Instructions 485 to 496 check to see if state qₖ₊₁ has already been visited. If so, the program execution jumps to instruction 497. Instructions 497 to 509 store (q_{N} a_{N}) starting at the register pointed to by the contents of register 51. Instructions 510 to 550 compute the window of execution. Instructions 551 to 578 increment the tape pattern which is an element of A^{2|Q|+1}. Incrementing the tape pattern enables the program to search every element in A^{2|Q|+1} as a prospective head node.

Instructions 579 to 778 copy this new prime directed edge found to the end of the prime directed edge linked list, whose data structure format has already been described. Instructions 779 and 780 update the prime directed edge linked list pointers. Instructions 781 to 839 check if the new head node just found is the same as the head node at the end of the prime directed edge linked list. If yes, then the new prime directed edge is the same as the last one found and it is ignored.

Otherwise, the prime directed edge just found is new and so it is added to the end of the prime directed edge linked list. This is performed in instructions 840 to 854. The number of prime directed edges found so far is incremented in instruction 855.

Instructions 856 and 857 cause program execution to jump back to instruction 314, where the next tape pattern is examined to decide if the current state and the new tape pattern determine a new prime directed edge. When the tape pattern reaches all 1's again, instructions 328, 329 and 330 increment the state q and the next prime directed edge is searched for. Once all states have been exhausted up to the last state value |Q|, then the program jumps to instruction 858 where the immortal periodic search method starts.

Next in step 1516, the directed edges grouped into linked lists. In step 1516, a search is performed for prime directed edges having tail nodes that overlap match head nodes of other prime directed edges. For each match found, the edge substitution is performed to find the results. Each pair of overlap matching prime directed nodes may be stored as a sequence of overlap matching prime directed edges. Each sequence is compared to the prime directed edges to determine if any of the sequences overlap matches any of the prime directed edges. Optionally, instead of performing steps 1514 and 15I6 as separate consecutive steps, as each prime directed edge is added to the sequence, a check may be performed for consecutive repeated sequence of states.

### IDRM Program Implementing Immortal Periodic Search Method

After the prime directed edge search method is completed, instructions 858 to 1589 of the IDRM program execute the immortal periodic point search method. Following the notation of the immortal periodic point search method, Φ(k) is the set of all edge sequences of length k. The IDRM program, represents Φ(1), the set of prime directed edges as a linked list where each node is in square brackets:

$$[ {ptr}_{1} , 2 {N}_{1} , {r}_{1} , {idx}_{1} , {ub}_{1} , {lb\_ptr}_{1} , {idx\_ptr}_{1} , {ub\_ptr}_{1} , 1 , {w}_{0 , 1} , … {w}_{idx , 1} … {w}_{ub , 1} , ( {q}_{0 , 1} , {a}_{0 , 1} ) , ( {q}_{1 , 1} , {a}_{1 , 1} ) , … , ( {q}_{N 1 , 1} {a}_{N 1 , 1} ) ] \\ [ {ptr}_{2} , 2 {N}_{2} , {r}_{2} , {idx}_{2} , {ub}_{2} , {lb\_ptr}_{2} , {idx\_ptr}_{2} , {ub\_ptr}_{2} , 2 , {w}_{0 , 2} , … {w}_{idx , 2} … {w}_{ub , 2} , ( {q}_{0 , 2} , {a}_{0 , 2} ) , ( {q}_{1 , 2} , {a}_{1 , 2} ) , … , ( {q}_{N 2 , 2} {a}_{N 2 , 2} ) ]$$

$$… \\ [ {ptr}_{m} , 2 {N}_{m} , {r}_{m} , {idx}_{m} , {ub}_{m} , {lb\_ptr}_{m} , {idx\_ptr}_{m} , {ub\_ptr}_{m} , m , {w}_{0 , m} , … {w}_{idx , m} … {w}_{ub , m} , ( {q}_{0 , m} , {a}_{0 , m} ) , ( {q}_{1 , m} , {a}_{1 , m} ) , … , ( {q}_{N m , m} {a}_{N m , m} ) ]$$

The contents of register ptrⱼ points to register ptrⱼ₊₁
m is the number of prime directed edges.
(q_{0,j}, a_{0,j}), (q_{1,j}, a_{1,j}), . . . , (q_{Nj,j}, a_{Nj,j}) is the sequence of input commands corresponding to the prime directed edges that have been linked matched for this jth edge sequence. For E(1), this is just the prime input command sequence corresponding to the jth prime edge.
2Nⱼ is stored in the register following ptrⱼ where Nⱼ+1 is the number input command pairs.
rⱼ is the state of tail node Γ for the jth prime edge which corresponds to state r in definition of the prime directed edge from head and tail execution nodes.
w_{0,j} . . . w_{idx,j} . . . w_{ub,j} represents the tape of the tail node and the tape head points to alphabet symbol w_{idx,j}
idxⱼ contains the tape head index which corresponds to the index t in the tail node Γ of definition of the prime directed edge from head and tail execution nodes.
ubⱼ contains the upper bound, where the window of execution is [0, ubⱼ]
The contents of register lb_ptrⱼ points to the register containing tape symbol w_{0,j}
The contents of register idx_ptrⱼ points to the register containing tape symbol w_{idx,j}
The contents of register ub_ptrⱼ points to the register containing tape symbol w_{ub,j}
j indicates the jth prime edge.

The above representation of Φ(1) is constructed by the execution of instructions 858 to 1016 of the IDRM program. In other words, in the immortal periodic point search method, the expression
Set Φ(1)={E([1], 1), E([2], 1), . . . , E([|P|], 1)} is executed by instructions 858 to 1016.

In more detail, instructions 858 to 875 set up an array of m prime edge pointers. Instructions 876 and 877 test if register 0 contains m, the number of prime directed edges. Instructions 878 to 885 initialize registers so that register 33 points to the next prime directed edge pointer, register 155 points to the free heap, and register 99 points to the head node of the edge sequence linked list. Also, register 97 is initialized to 1 which stores the number of distinct prime edges composed together in every element of Φ(1) i.e. the 1 in Φ(1). Register 96 is initialized to 1 which stores at that time during program execution the number of edge sequences in Φ(k). Instructions 886 and 887 test if the program is finished with constructing Φ(1).

Instructions 888 to 903 set up the h_node, t_node, and s_node pointers. Instructions 904 to 910 store state rⱼ. Instructions 911 to 918 store idxⱼ. Instructions 919 to 926 store ubⱼ. Instructions 927 to 938 store lb_ptrⱼ. Instructions 939 to 945 compute idx_ptrⱼ. Instructions 946 to 951 store idx_ptrⱼ. Instructions 952 to 957 compute ub_ptrⱼ. Instructions 958 to 963 store ub_ptrⱼ. Instructions 964 to 969 store p_{1,j} which equals j. Instructions 970 to 987 store w_{0,j}, . . . w_{idx,j} . . . w_{ub,j}. Instructions 988 to 1004 store (q_{0,j}, a_{0,j}), (q_{1,j}, a_{1,j}), . . . , (q_{Nj,j}, a_{Nj,j}). Instructions 1005 to 1016 update pointers and registers to jump back to instruction 886 and repeat this loop for the j+1^{st} prime edge that is stored in E(1).

After Φ(1) is constructed, instruction 1018 is the start of the loop where Φ(k+1) is constructed from Φ(k). Instruction 1018 corresponds to the beginning of the while loop while (Φ(k)≠Ø) in the immortal periodic point search method. In particular, if Φ(k)=Ø is executed by instructions 1021 and 1022. If Φ(k)=Ø, then the IDRM program jumps to instruction 1551. After this the program writes “HALT” in registers 0 through 4 using the ASCII code representation. Then the IDRM program jumps to instruction 1590 which does not exist and this terminates the execution.

Instruction 1028 corresponds to the beginning of the for loop

for each E([p₁, p₂, . . . , pₖ], k) in Φ(k) in the immortal periodic point search method. Instruction 1032 corresponds to the beginning of the for loop: for each prime directed edge Δⱼ [symbol] Γⱼ in P in method the immortal periodic point search method. Next in method 2800, in step 2818, a search is performed for consecutive repeated state cycles (as in method 8.32).

In regard to if Δⱼ [symbol] Γⱼ link matches with Πₚ₍ₖ₎ in the immortal periodic point search method, instructions 1070 to 1461 test for an overlap match between the current prime edge found and the execution node Πₚ₍ₖ₎ in the loop starting at instruction 1032 if E([p₁, p₂, . . . , pₖ, pₖ₊₁], k+1) contains a consecutive repeating state cycle in method 8.36 is executed in instructions 1475 to 1537 of the IDRM program. Instructions 1475 to 1537 look for a consecutive repeating state cycle in (q_{0,j}, a_{0,j}) (q_{1,j}, a_{1,j}), . . . , (q_{Nj,j}, a_{Nj,j}).

If a consecutive repeating state cycle is found, the program jumps to instruction 1557. Then it writes “IMMORTAL” in registers 0 through 7 using the ASCII code representation. After the program writes the length of one repeat of the consecutive repeating state cycle in register 8. After the program writes the starting register of the first repeat of the state cycle in register 9 and writes the starting register of the second repeat of the state cycle in register 10. Then the IDRM program jumps to instruction 1590 which does not exist and this terminates the execution.

Next the representation of Φ(k) in the registers of the IDRM program is discussed. Similar to Φ(1) the jth element in Φ(k) is of the form:

[ptrⱼ, 2Nⱼ, rⱼ, idxⱼ, ubⱼ, lb_ptrⱼ, idx_ptrⱼ, ub_ptrⱼ, p₁, p₂, . . . , pₖ

w_{0,j}, w_{idx,j} . . . w_{ub,j}, (q_{0,j}, a_{0,j}) (q_{1,j}, a_{1,j}), . . . , (q_{Nj,j}, a_{Nj,j})]
k is the number prime directed edges composed together.
2Nⱼ is stored in the register following ptrⱼ where Nⱼ+1 is the number input command pairs corresponding to the edge sequence if E([p₁, p₂, . . . , pₖ], k) in the edge sequence notation E([p₁, p₂, . . . , pₖ], k).
rⱼ is the state of the execution node Πₚ(k) as defined in 8.26, 8.27, and edge sequence notation E([p₁, p₂, . . . , pₖ], k).
idxᵢ contains the tape head index of the execution node Πₚ(k)
ubᵢ contains the upper bound of the tape of the execution node Πₚ(k)
The contents of register lb_ptrⱼ points to the register containing tape symbol w_{0,j}
The contents of register idx_ptrⱼ points to the register containing tape symbol w_{idx,j}
The contents of register ub_ptrⱼ points to the register containing tape symbol w_{ub,j}
p₁, p₂, . . . pₖ records the sequence of prime directed edges that were link matched. Each pⱼ is determined by its pe_number stored in the prime edge linked list.
w_{0,j} . . . w_{idx,j} . . . w_{ub,j} represents the tape of the execution node and the tape head points to alphabet symbol w_{idx,j}
   (q_{0,j}, a_{0,j}) (q_{1,j}, a_{1,j}), . . . , (q_{Nj,j}, a_{Nj,j}) is the composition of the prime input command sequences corresponding to the prime directed edges p₁, p₂, . . . , pₖ that were link matched as described in the definition of the composition of prime input command sequences

In an embodiment, each of the steps of method 1500 is a distinct step. In another embodiment, although depicted as distinct steps in FIG. 15A, steps 1502-1518 may not be distinct steps. In other embodiments, method 2800 may not have all of the above steps and/or may have other steps in addition to or instead of those listed above. The steps of method 1500 may be performed in another order. Subsets of the steps listed above as part of method 1500 may be used to form their own method.

### Immortality Dynamic Register Machine Program

This section presents a complete formal description of a dynamic register machine program, called the IDRM, that determines for a periodic Turing Machine, whether it is a halting machine or contains an immortal periodic configuration. This embodiment of a computing system is achieved with a program composed of 1590 instructions that are selected from the Constant (C m n), Successor (S m), Transfer (T m n), Address (A m n), Jump (J m n q), Delete (D m n), and Update (U m n q) Instructions. Mathematical concepts and computational methods are described in sections 1 through 8.

The dynamic register machine instructions and program execution were described in section 0. The design of this program has been described above. Due to the lack of space and U.S.P.T.O. font requirements, the program comments are listed first rather than next to or above the program instruction, which is a common practice in computer programs.

In instruction number 0, register 0 stores the register number of the terminating zero register that indicates the end of the Turing program. In instruction number 3, register 21 stores the jump address which is 6. In instruction number 3, check if terminating zero register contains zero. If not, exit IDRM program with ERROR in TURING PROGRAM.

In instruction 6, the terminating zero register is ok. Now check that this register number is >156 where stored the Turing program begins. In instruction 10, test if terminating register <=156, then exit ERROR TURING PROGRAM. In instruction number 14, register 21 stores the jump address. In instruction 16, prepare to find the maximum alphabet and state values in Turing program, In instruction 17, register 30 stores the maximum alphabet value. In instruction 18, register 29 stores the maximum state value.

In instruction 21, register 34 contains state q in Turing command (q a r b m). In instruction 23, register 35 contains alphabet symbol a in Turing command (q a r b m). In instruction number 25, register 36 contains state r in Turing command (q a r b m). In instruction number 27, register 37 contains alphabet symbol b in Turing command (q a r b m).

In instruction 29, register 38 contains move symbol m in Turing command (q a r b m). In instruction 31, if state q=0, then end of valid Turing program or invalid program. In instruction 33, store new state value from Turing program in register 0. In instruction 34, register 29 contains the current maximum state value. In instruction 35, register 20 stores the continue address 38 after the maximum subroutine exit.

Instructions 36 and 37 jump to program instruction 109 where the maximum subroutine starts. Instruction 38 copies the new maximum state value from register 2 into register 29. In instructions 41 and 42, if alphabet symbol a=0 in (q a r b m), then jump to instruction 1570 where “Error Turing program” is written to registers 0 through 19 in ASCII format.

In instruction 42, store new alphabet a value in (q a r b m) from Turing program in register 0. In instruction 43, store current maximum alphabet value in register 1. In instruction 44, register 20 stores the continue address 47 after max subroutine exit. In instruction 46, jump to program instruction 109 where the max subroutine starts. In instruction 47, copy new maximum alphabet value from register 2 into register 30.

In instructions 49 and 50, if state value r=0, (q a r b m), exit with ERROR. It is an invalid Turing program. In instruction 51, store current state r from Turing command in register 0. In instruction 51, store maximum state in register 0. In instruction 53, register 20 stores the continue address 56 after max subroutine exit. In instruction 56, copy new maximum state value from register 2 into register 29. In instruction 59, if symbol b=0, in (q a r b m) exit with ERROR, Invalid Turing program.

In instruction 60, store new alphabet “b” value in (q a r b m) from Turing program in register 0. In instruction 61, store current maximum alphabet value in register 1. In instruction 64, jump to program instruction 109 where the max subroutine starts. In instruction 65, copy new maximum alphabet value from register 2 into register 30. In instruction 68, check if move symbol m=1, LEFT move, in (q a r b m). In instruction 71, check if move symbol m=2, RIGHT move, in (q a r b m).

In instruction 72, if an invalid move symbol, exit with ERROR. Invalid Turing program In instruction 74, increment reg 33 to indirectly point to q in next (q a r b m) command. In instruction 76, jump to Line 21 to start checking the next command (q a r b m). In instruction 77, Turing program commands start at register 156.

Starting at instruction 78, now that maximum state and alphabet values are determined use these in a state and alphabet loop to check that there is a valid Turing program starting at register 156. In instruction 83, start Q_count loop. Q_COUNT is iterated from 2 to MAX_Q. The halt state is represented with 1, so Q_COUNT is initialized to 2. In instruction 87, the start of of alphabet A_COUNT loop. The alphabet symbols ranges from 1 to |A|=MAX_A. In instruction 90, store q from (q a r b m) command in register 34. In instruction 92, store a in command (q a r b m) in register 35.

In instruction 98, check that q=Q_COUNT in register 23. In instruction 100, if (q !=Q_COUNT), then it is an invalid Turing program. Exit with ERROR. In instruction 102, check that a=A_COUNT in register 25. In instruction 104, if (a !=A_COUNT), then it is an invalid Turing program. Exit with ERROR. In instruction 105, register 18 stores the number of insert instructions for Update (U m 18 q). In instruction 106, register 19 stores the number of instructions to delete in (D m 19). In instruction 107, line 127 is where the A OFFSETS program is located. In instruction 108, jump to A offsets.

Starting at instruction 109, the MAXIMUM program, compares registers 0 and 1. It returns the maximum of registers 0 and 1 in register 2. The A_offsets are determined and stored by instructions 127 to 153. In particular, the A_offsets A_{—}2, A_{—}3, . . . , A_|Q| are stored at (R (R 39)), (R (+(R 39) 1)), and so on. In instruction 128, register 156 contains 2 which is the first Turing command (2 1 r b m) in a valid Turing program. In instruction 135, offset A_k is stored in the next register, with A_{—}2 in (R (R 39)). In instruction 138, add 5 to register 0 so that it points to the next Turing command (q a r b m).

Instructions 154 to 296 set up a scratch pad of registers to execute prime directed edge search method 8.34 described in section 8. Instructions 154 to 167 set up registers to record the prime input command sequence. Instructions 168 to 190 set up registers to record current prospective head node. Instructions 191 to 212 set up registers to record the current prospective tail node. Instructions 213 to 233 set up registers to record the execution tape during the computation of a prospective prime directed edge.

Instructions 234 to 254 set up registers to store an iteration tape, which is used to iterate through every tape patter in A^{2|Q|+1}. Instructions 255 to 265 set up registers to record the tape head moves during computation of the prospective prime edge. Instructions 266 to 292 set up registers to compute the window of execution.

Instructions 293 to 296 set up memory pointers to record the number of prime edges found so far and store a linked list of prime edges. In Instruction 296 a free heap pointer is stored in register 155. Instructions 297 to 858 perform the Prime directed edge search method as defined in 8.34 Instructions 297 to 313 initialize the tape A^{2|Q|+1} to all 1's. Instructions 331 to 349 copy the iterated tape pattern, starting at the register pointed to by register 68. Instruction 334 stores the value of 2|Q|+1 in register 2. Instructions 350 to 367 initialize the prospective head node state and the tape symbols. Instructions 371 to 395 initialize register 33 to the correct command (q a r b m) in the Turing command table.

The current state q of the Turing machine is stored in register 65. The current tape symbol a is stored in register 66. Instructions 396 to 408 store (qₖ, aₖ) in the register that is pointed to by the contents of register 51. Instructions 409 to 483 execute one computational step of the Turing machine whose command table starts at register 156.

Instruction 484 increments register 48 which stores the number of computational steps for this prospective prime directed edge. Instructions 485 to 496 check to see if state qₖ₊₁ has already been visited. If state qₖ₊₁ has already been visited, jump to 497. Instructions 497 to 509 store (q_{N}, a_{N}) starting at the register pointed to by the contents of register 51. Instructions 510 to 550 compute the window of execution. Instructions 551 to 578 increment the tape pattern which is an element of A^{2|Q|+1}. This enables the program to search every element in A^{2|Q|+1} as a prospective head node.

Instructions 579 to 778 copy this new prime directed edge found to the end of the prime directed edge linked list. Instructions 779 and 780 update the prime directed edge linked list pointers. Instructions 781 to 839 check if the new head node just found is the same as the head node at the end of the prime directed edge linked list. If yes, then the new prime directed edge is the same as the last one found and it is ignored.

The prime directed edge just found is new and so it is added to the end of the primed directed edge linked list. This occurs in instructions 840 to 854. The number of prime directed edges found so far is incremented and stored in register 81. In instruction 857, Jump back to instruction 314 where the next tape pattern is examined to decide if the current state and new tape pattern determine a new prime directed edge. Instructions 858 to 875 set up an array of m prime edge pointers.

Instructions 876, 877 test if register 0 contains m, the number of prime directed edges. Instructions 878 to 885 initialize registers so that register 33 points to the next prime directed edge pointer, register 155 points to the free heap, and register 99 points to the head node of the edge sequence linked list. In instruction 884, Register 96 stores the number of current edge sequences in E(k). In instruction 885, register 97 is initialized to 1 and stores the number of distinct prime edges composed together in every element of E(1).

Instructions 888 to 903 set up the h_node, t_node and s_node pointers. Instructions 904 to 910 store state r_j. Instructions 911 to 918 store idx_j. Instructions 919 to 926 store ub_j. Instructions 927 to 938 store lb_ptr_j. Instructions 939 to 945 compute idx_ptr_j. Instructions 946 to 951 store idx_ptr_j. Instructions 952 to 957 compute ub_ptr_j. Instructions 958 to 963 store ub_ptr_j. Instructions 964 to 969 store p_{1,j} which equals j. Instructions 970 to 987 store w_{0,j} . . . w_{idx,j} . . . w_{ub,j}. Instructions 988 to 1004 store (q_{0,j}, a_{0,j}) . . . (q_{Nj,j}, a_{Nj,j})

Instructions 1005 to 1016 update pointers and pointers to jump back to instruction 886. In instructions 1015 and 1016, the program jumps back to instruction 886 and repeats this loop for the j+1st prime edge that is stored in E(1). Instruction 1018 is the start of the loop where E(k+1) is constructed from E(k). In instructions 1021 and 1022, check if E(k)=empty set i.e. if the number of edge sequences=0. If E(k)=empty set, jump to instruction 1551 and write HALT, using the ASCII representation, in registers 0 to 4.

Instruction 1028 corresponds to the start of for loop: for each E([p₁, p₂, . . . , pₖ], k) in E(k) in method 8.34. Instruction 1032 is the beginning of the for loop: for each prime directed edge (Δⱼ [symbol] Γⱼ) in prime edge set P if Δⱼ [symbol] Γⱼ link matches with Πₚ₍ₖ₎ then in method 8.34 is executed starting at instruction 1070. Instructions 1070 to 1461 test for an overlap match between the current prime edge found in the loop beginning at instruction 1032 and the execution node.

Instructions 1475 to 1537 search for a consecutive repeating state cycle in (q_{0,j}, a_{0,j}), (q_{1,j}, a_{1,j}), . . . , (q_{Nj,j}, a_{Nj,j}). if E([p₁, p₂, . . . , pₖ, pₖ₊₁], k+1) contains a consecutive repeating state cycle, as stated in 8.34, is executed in instructions 1475 to 1537. Instruction 1551 is reached if the Turing machine was valid and it is a halting machine. Instruction 1551 stores “H” in register 0. ASCII code 72=“H”. Instruction 1552 stores “A” in register 1. ASCII code 65=“A”. Instruction 1553 stores “L” in register 2. ASCII code 76=“L”. Instruction 1554 stores “T” in register 3. ASCII code 84=“T”. Instruction 1555 stores address 1590 in register 21. And instruction 1556 jumps to end of the IDRM program.

Instruction 1557 is reached if the Turing machine was valid and it has an immortal periodic point. Instruction 1557 stores “I” in register 0. ASCII code 73=“I”. Instruction 1558 stores “M” in register 1. ASCII code 77=“M”. Instruction 1559 stores “M” in register 2. ASCII code 77=“M”. Instruction 1560 stores “O” in register 3. ASCII code 79=“O”. Instruction 1561 stores “R” in register 4. ASCII code 82=“R”. Instruction 1562 stores “T” in register 5. ASCII code 84=“T”. Instruction 1563 stores “A” in register 6. ASCII code 65=“A”. Instruction 1564 stores “L” in register 7. ASCII code 76=“L”. Instruction 1565 stores the length of one repeat of the consecutive repeating state cycle. Instruction 1566 stores the register where the first repeat of the state cycle begins.

Instruction 1567 stores the register where the second repeat of the state cycle begins. Instruction 1568 stores address 1590 in register 21. Instruction 1569 jumps to the end of the IDRM program. Instruction 1570 is reached if the Turing program is in an invalid format. Instruction 1570 stores “E” in register 0. ASCII code 69=“E”. Instruction 1571 stores “R” in register 1. ASCII code 82=“R”. Instruction 1572 stores “R” in register 2. ASCII code 82=“R”. Instruction 1573 stores “O” in register 3. ASCII code 79=“O”. Instruction 1574 stores “R” in register 4. ASCII code 82=“R”. Instruction 1575 stores “ ” in register 5. ASCII code 32=“ ”. Instructions 1576 through 1589 store “TURING PROGRAM” in registers 6 through 19, using ASCII format as described in the previous instructions.

The complete IDRM program description starts below. The first column shows the instruction number starting at 0. The second column shows the dynamic register machine instruction. When the last number is reached (e.g., number 24 on this page), the table continues on the right side of the page (e.g., number 25 on this page).

| Number | Instruction |
|---|---|
| 0 | (A 1 0) |
| 1 | (C 2 0) |
| 2 | (C 21 6) |
| 3 | (J 1 2 21) |
| 4 | (C 21 1570) |
| 5 | (J 0 0 21) |
| 6 | (T 9 0) |
| 7 | (C 33 156) |
| 8 | (C 1 0) |
| 9 | (C 21 1570) |
| 10 | (J 1 9 21) |
| 11 | (C 21 16) |
| 12 | (J 1 33 21) |
| 13 | (S 1) |
| 14 | (C 21 9) |
| 15 | (J 0 0 21) |
| 16 | (C 26 1) |
| 17 | (C 30 0) |
| 18 | (C 29 0) |
| 19 | (C 31 0) |
| 20 | (C 32 0) |
| 21 | (A 34 33) |
| 22 | (S 33) |
| 23 | (A 35 33) |
| 24 | (S 33) |
| 25 | (A 36 33) |
| 26 | (S 33) |
| 27 | (A 37 33) |
| 28 | (S 33) |
| 29 | (A 38 33) |
| 30 | (C 0 0) |
| 31 | (C 21 77) |
| 32 | (J 34 0 21) |
| 33 | (T 0 34) |
| 34 | (T 1 29) |
| 35 | (C 20 38) |
| 36 | (C 21 109) |
| 37 | (J 0 0 21) |
| 38 | (T 29 2) |
| 39 | (C 0 0) |
| 40 | (C 21 1570) |
| 41 | (J 35 0 21) |
| 42 | (T 0 35) |
| 43 | (T 1 30) |
| 44 | (C 20 47) |
| 45 | (C 21 109) |
| 46 | (J 0 0 21) |
| 47 | (T 30 2) |
| 48 | (C 0 0) |
| 49 | (C 21 1570) |
| 50 | (J 36 0 21) |
| 51 | (T 0 36) |
| 52 | (T 1 29) |
| 53 | (C 20 56) |
| 54 | (C 21 109) |
| 55 | (J 0 0 21) |
| 56 | (T 29 2) |
| 57 | (C 0 0) |
| 58 | (C 21 1570) |
| 59 | (J 37 0 21) |
| 60 | (T 0 37) |
| 61 | (T 1 30) |
| 62 | (C 20 65) |
| 63 | (C 21 109) |
| 64 | (J 0 0 21) |
| 65 | (T 30 2) |
| 66 | (C 0 1) |
| 67 | (C 21 74) |
| 68 | (J 38 0 21) |
| 69 | (C 0 2) |
| 70 | (C 21 74) |
| 71 | (J 38 0 21) |
| 72 | (C 21 1570) |
| 73 | (J 0 0 21) |
| 74 | (S 33) |
| 75 | (C 21 21) |
| 76 | (J 0 0 21) |
| 77 | (C 33 156) |
| 78 | (C 23 1) |
| 79 | (T 8 29) |
| 80 | (S 8) |
| 81 | (T 9 30) |
| 82 | (S 9) |
| 83 | (S 23) |
| 84 | (C 21 105) |
| 85 | (J 23 8 21) |
| 86 | (C 25 0) |
| 87 | (S 25) |
| 88 | (C 21 83) |
| 89 | (J 25 9 21) |
| 90 | (A 34 33) |
| 91 | (S 33) |
| 92 | (A 35 33) |
| 93 | (S 33) |
| 94 | (S 33) |
| 95 | (S 33) |
| 96 | (S 33) |
| 97 | (C 21 101) |
| 98 | (J 34 23 21) |
| 99 | (C 21 1570) |
| 100 | (J 0 0 21) |
| 101 | (C 21 87) |
| 102 | (J 35 25 21) |
| 103 | (C 21 1570) |
| 104 | (J 0 0 21) |
| 105 | (C 18 1) |
| 106 | (C 19 1) |
| 107 | (C 21 127) |
| 108 | (J 9 9 21) |
| 109 | (C 21 125) |
| 110 | (J 0 1 21) |
| 111 | (C 2 0) |
| 112 | (J 1 2 21) |
| 113 | (C 21 122) |
| 114 | (J 0 2 21) |
| 115 | (S 2) |
| 116 | (C 21 122) |
| 117 | (J 0 2 21) |
| 118 | (C 21 125) |
| 119 | (J 1 2 21) |
| 120 | (C 21 115) |
| 121 | (J 0 0 21) |
| 122 | (T 2 1) |
| 123 | (C 21 126) |
| 124 | (J 0 0 21) |
| 125 | (T 2 0) |
| 126 | (J 0 0 20) |
| 127 | (T 39 33) |
| 128 | (C 0 156) |
| 129 | (T 1 30) |
| 130 | (C 23 1) |
| 131 | (C 5 2) |
| 132 | (T 6 33) |
| 133 | (C 7 0) |
| 134 | (C 22 136) |
| 135 | (U 5 18 22) |
| 136 | (D 22 19) |
| 137 | (C 2 0) |
| 138 | (S 0) |
| 139 | (S 0) |
| 140 | (S 0) |
| 141 | (S 0) |
| 142 | (S 0) |
| 143 | (S 2) |
| 144 | (C 21 148) |
| 145 | (J 1 2 21) |
| 146 | (C 21 138) |
| 147 | (J 1 1 21) |
| 148 | (S 33) |
| 149 | (S 23) |
| 150 | (C 21 154) |
| 151 | (J 23 29 21) |
| 152 | (C 21 131) |
| 153 | (J 0 0 21) |
| 154 | (S 33) |
| 155 | (T 48 33) |
| 156 | (S 33) |
| 157 | (T 50 33) |
| 158 | (C 0 0) |
| 159 | (T 1 29) |
| 160 | (S 1) |
| 161 | (S 0) |
| 162 | (S 33) |
| 163 | (S 33) |
| 164 | (C 21 168) |
| 165 | (J 0 1 21) |
| 166 | (C 21 161) |
| 167 | (J 0 0 21) |
| 168 | (S 33) |
| 169 | (T 56 33) |
| 170 | (C 0 1) |
| 171 | (C 28 0) |
| 172 | (T 1 29) |
| 173 | (S 0) |
| 174 | (S 28) |
| 175 | (S 33) |
| 176 | (C 21 180) |
| 177 | (J 0 1 21) |
| 178 | (C 21 173) |
| 179 | (J 0 0 21) |
| 180 | (T 57 33) |
| 181 | (C 0 1) |
| 182 | (T 1 29) |
| 183 | (S 0) |
| 184 | (S 28) |
| 185 | (S 33) |
| 186 | (C 21 190) |
| 187 | (J 0 1 21) |
| 188 | (C 21 183) |
| 189 | (J 0 0 21) |
| 190 | (T 58 33) |
| 191 | (S 28) |
| 192 | (S 33) |
| 193 | (S 33) |
| 194 | (T 62 33) |
| 195 | (C 0 1) |
| 196 | (T 1 29) |
| 197 | (S 0) |
| 198 | (S 33) |
| 199 | (C 21 203) |
| 200 | (J 0 1 21) |
| 201 | (C 21 197) |
| 202 | (J 0 0 21) |
| 203 | (T 63 33) |
| 204 | (C 0 1) |
| 205 | (T 1 29) |
| 206 | (S 0) |
| 207 | (S 33) |
| 208 | (C 21 212) |
| 209 | (J 0 1 21) |
| 210 | (C 21 206) |
| 211 | (J 0 0 21) |
| 212 | (T 64 33) |
| 213 | (S 33) |
| 214 | (S 33) |
| 215 | (T 68 33) |
| 216 | (C 0 1) |
| 217 | (T 1 29) |
| 218 | (S 0) |
| 219 | (S 33) |
| 220 | (C 21 224) |
| 221 | (J 0 1 21) |
| 222 | (C 21 218) |
| 223 | (J 0 0 21) |
| 224 | (T 69 33) |
| 225 | (C 0 1) |
| 226 | (T 1 29) |
| 227 | (S 0) |
| 228 | (S 33) |
| 229 | (C 21 233) |
| 230 | (J 0 1 21) |
| 231 | (C 21 227) |
| 232 | (J 0 0 21) |
| 233 | (T 70 33) |
| 234 | (S 33) |
| 235 | (S 33) |
| 236 | (T 72 33) |
| 237 | (C 0 1) |
| 238 | (T 1 29) |
| 239 | (S 0) |
| 240 | (S 33) |
| 241 | (C 21 245) |
| 242 | (J 0 1 21) |
| 243 | (C 21 239) |
| 244 | (J 0 0 21) |
| 245 | (T 7-3 33) |
| 246 | (C 0 1) |
| 247 | (T 1 29) |
| 248 | (S 0) |
| 249 | (S 33) |
| 250 | (C 21 254) |
| 251 | (J 0 1 21) |
| 252 | (C 21 248) |
| 253 | (J 0 0 21) |
| 254 | (T 74 33) |
| 255 | (S 33) |
| 256 | (S 33) |
| 257 | (T 46 33) |
| 258 | (C 0 0) |
| 259 | (T 1 29) |
| 260 | (S 0) |
| 261 | (S 33) |
| 262 | (C 21 266) |
| 263 | (J 0 1 21) |
| 264 | (C 21 260) |
| 265 | (J 0 0 21) |
| 266 | (S 33) |
| 267 | (S 33) |
| 268 | (T 43 33) |
| 269 | (C 0 0) |
| 270 | (T 1 28) |
| 271 | (C 2 1) |
| 272 | (C 5 2) |
| 273 | (C 7 0) |
| 274 | (T 6 33) |
| 275 | (C 22 277) |
| 276 | (U 5 18 22) |
| 277 | (D 22 19) |
| 278 | (S 0) |
| 279 | (S 2) |
| 280 | (S 33) |
| 281 | (C 21 290) |
| 282 | (J 0 1 21) |
| 283 | (C 21 287) |
| 284 | (J 2 29 21) |
| 285 | (C 21 274) |
| 286 | (J 0 0 21) |
| 287 | (T 44 33) |
| 288 | (C 21 274) |
| 289 | (J 0 0 21) |
| 290 | (S 33) |
| 291 | (S 33) |
| 292 | (A 27 44) |
| 293 | (C 81 0) |
| 294 | (T 83 33) |
| 295 | (T 85 33) |
| 296 | (T 155 33) |
| 297 | (C 71 1) |
| 298 | (C 3 1) |
| 299 | (T 2 72) |
| 300 | (C 0 0) |
| 301 | (T 1 28) |
| 302 | (C 5 2) |
| 303 | (C 7 3) |
| 304 | (T 6 2) |
| 305 | (C 22 307) |
| 306 | (U 5 18 22) |
| 307 | (D 22 19) |
| 308 | (S 0) |
| 309 | (S 2) |
| 310 | (C 21 314) |
| 311 | (J 0 1 21) |
| 312 | (C 21 304) |
| 313 | (J 0 0 21) |
| 314 | (C 0 1) |
| 315 | (T 33 72) |
| 316 | (C 1 0) |
| 317 | (C 21 328) |
| 318 | (J 1 28 21) |
| 319 | (A 3 33) |
| 320 | (C 21 324) |
| 321 | (J 0 3 21) |
| 322 | (C 21 331) |
| 323 | (J 0 0 21) |
| 324 | (S 1) |
| 325 | (S 33) |
| 326 | (C 21 317) |
| 327 | (J 0 0 21) |
| 328 | (C 21 858) |
| 329 | (J 71 29 21) |
| 330 | (S 71) |
| 331 | (T 65 71) |
| 332 | (T 0 68) |
| 333 | (T 1 72) |
| 334 | (T 2 28) |
| 335 | (C 3 0) |
| 336 | (C 5 2) |
| 337 | (C 21 349) |
| 338 | (J 2 3 21) |
| 339 | (T 6 0) |
| 340 | (T 7 1) |
| 341 | (C 22 343) |
| 342 | (U 5 18 22) |
| 343 | (D 22 19) |
| 344 | (S 0) |
| 345 | (S 1) |
| 346 | (S 3) |
| 347 | (C 21 337) |
| 348 | (J 0 0 21) |
| 349 | (A 66 73) |
| 350 | (T 53 65) |
| 351 | (T 0 56) |
| 352 | (T 1 72) |
| 353 | (T 2 28) |
| 354 | (C 3 0) |
| 355 | (C 5 2) |
| 356 | (C 21 368) |
| 357 | (J 2 3 21) |
| 358 | (T 6 0) |
| 359 | (T 7 1) |
| 360 | (C 22 362) |
| 361 | (U 5 18 22) |
| 362 | (D 22 19) |
| 363 | (S 0) |
| 364 | (S 1) |
| 365 | (S 3) |
| 366 | (C 21 356) |
| 367 | (J 0 0 21) |
| 368 | (C 48 0) |
| 369 | (T 67 69) |
| 370 | (T 51 50) |
| 371 | (C 21 551) |
| 372 | (J 65 26 21) |
| 373 | (C 0 2) |
| 374 | (T 33 39) |
| 375 | (C 21 381) |
| 376 | (J 65 0 21) |
| 377 | (S 0) |
| 378 | (S 33) |
| 379 | (C 21 375) |
| 380 | (J 0 0 21) |
| 381 | (A 0 33) |
| 382 | (T 33 0) |
| 383 | (T 1 33) |
| 384 | (S 1) |
| 385 | (A 35 1) |
| 386 | (C 21 395) |
| 387 | (J 35 66 21) |
| 388 | (S 33) |
| 389 | (S 33) |
| 390 | (S 33) |
| 391 | (S 33) |
| 392 | (S 33) |
| 393 | (C 21 383) |
| 394 | (J 0 0 21) |
| 395 | (T 47 46) |
| 396 | (C 5 2) |
| 397 | (T 6 51) |
| 398 | (C 7 65) |
| 399 | (C 22 401) |
| 400 | (U 5 18 22) |
| 401 | (D 22 19) |
| 402 | (S 51) |
| 403 | (T 6 51) |
| 404 | (T 7 67) |
| 405 | (C 22 407) |
| 406 | (U 5 18 22) |
| 407 | (D 22 19) |
| 408 | (S 51) |
| 409 | (A 34 33) |
| 410 | (S 33) |
| 411 | (A 35 33) |
| 412 | (S 33) |
| 413 | (A 36 33) |
| 414 | (S 33) |
| 415 | (A 37 33) |
| 416 | (S 33) |
| 417 | (A 38 33) |
| 418 | (A 66 67) |
| 419 | (C 21 423) |
| 420 | (J 66 35 21) |
| 421 | (C 21 1570) |
| 422 | (J 0 0 21) |
| 423 | (T 65 36) |
| 424 | (T 66 37) |
| 425 | (C 5 2) |
| 426 | (T 6 67) |
| 427 | (C 7 37) |
| 428 | (C 22 430) |
| 429 | (U 5 18 22) |
| 430 | (D 22 19) |
| 431 | (C 21 551) |
| 432 | (J 65 26 21) |
| 433 | (C 5 2) |
| 434 | (T 6 47) |
| 435 | (C 7 4) |
| 436 | (C 0 1) |
| 437 | (C 21 446) |
| 438 | (J 38 0 21) |
| 439 | (S 67) |
| 440 | (C 4 2) |
| 441 | (C 22 443) |
| 442 | (U 5 18 22) |
| 443 | (D 22 19) |
| 444 | (C 21 460) |
| 445 | (J 0 0 21) |
| 446 | (C 4 1) |
| 447 | (C 22 449) |
| 448 | (U 5 18 22) |
| 449 | (D 22 19) |
| 450 | (T 0 68) |
| 451 | (T 1 0) |
| 452 | (S 1) |
| 453 | (C 21 459) |
| 454 | (J 167 21) |
| 455 | (S 1) |
| 456 | (S 0) |
| 457 | (C 21 453) |
| 458 | (J 0 0 21) |
| 459 | (T 67 0) |
| 460 | (S 47) |
| 461 | (A 66 67) |
| 462 | (C 0 2) |
| 463 | (T 33 39) |
| 464 | (C 21 470) |
| 465 | (J 65 0 21) |
| 466 | (S 0) |
| 467 | (S 33) |
| 468 | (C 21 464) |
| 469 | (J 0 0 21) |
| 470 | (A 0 33) |
| 471 | (T 33 0) |
| 472 | (T 1 33) |
| 473 | (S 1) |
| 474 | (A 35 1) |
| 475 | (C 21 484) |
| 476 | (J 66 35 21) |
| 477 | (S 33) |
| 478 | (S 33) |
| 479 | (S 33) |
| 480 | (S 33) |
| 481 | (S 33) |
| 482 | (C 21 472) |
| 483 | (J 0 0 21) |
| 484 | (S 48) |
| 485 | (C 1 1) |
| 486 | (T 52 50) |
| 487 | (A 0 52) |
| 488 | (C 21 497) |
| 489 | (J 0 65 21) |
| 490 | (C 21 396) |
| 491 | (J 1 48 21) |
| 492 | (S 52) |
| 493 | (S 52) |
| 494 | (S 1) |
| 495 | (C 21 487) |
| 496 | (J 0 0 21) |
| 497 | (C 5 2) |
| 498 | (T 6 51) |
| 499 | (C 7 65) |
| 500 | (C 22 502) |
| 501 | (U 5 18 22) |
| 502 | (D 22 19) |
| 503 | (S 51) |
| 504 | (T 6 51) |
| 505 | (C 7 66) |
| 506 | (C 22 508) |
| 507 | (U 5 18 22) |
| 508 | (D 22 19) |
| 509 | (S 51) |
| 510 | (T 47 46) |
| 511 | (T 40 44) |
| 512 | (T 41 44) |
| 513 | (T 45 44) |
| 514 | (C 1 1) |
| 515 | (C 2 2) |
| 516 | (C 3 0) |
| 517 | (A 0 47) |
| 518 | (C 21 529) |
| 519 | (J 0 1 21) |
| 520 | (C 21 525) |
| 521 | (J 41 4521) |
| 522 | (S 45) |
| 523 | (C 21 545) |
| 524 | (J 0 0 21) |
| 525 | (S 45) |
| 526 | (S 41) |
| 527 | (C 21 545) |
| 528 | (J 0 0 21) |
| 529 | (T 9 45) |
| 530 | (C 4 1) |
| 531 | (A 5 45) |
| 532 | (T 6 43) |
| 533 | (C 21 539) |
| 534 | (J 4 5 21) |
| 535 | (S 4) |
| 536 | (S 6) |
| 537 | (C 21 533) |
| 538 | (J 0 0 21) |
| 539 | (T 45 6) |
| 540 | (C 21 544) |
| 541 | (J 40 9 21) |
| 542 | (C 21 545) |
| 543 | (J 0 0 21) |
| 544 | (T 40 45) |
| 545 | (S 3) |
| 546 | (S 47) |
| 547 | (C 21 551) |
| 548 | (J 48 3 21) |
| 549 | (C 21 517) |
| 550 | (J 0 0 21) |
| 551 | (T 33 72) |
| 552 | (C 0 0) |
| 553 | (T 1 28) |
| 554 | (A 2 33) |
| 555 | (C 21 579) |
| 556 | (J 0 1 21) |
| 557 | (C 21 568) |
| 558 | (J 2 30 21) |
| 559 | (S 2) |
| 560 | (C 5 2) |
| 561 | (T 6 33) |
| 562 | (C 7 2) |
| 563 | (C 22 565) |
| 564 | (U 5 18 22) |
| 565 | (D 22 19) |
| 566 | (C 21 579) |
| 567 | (J 0 0 21) |
| 568 | (C 5 2) |
| 569 | (T 6 33) |
| 570 | (C 2 1) |
| 571 | (C 7 2) |
| 572 | (C 22 574) |
| 573 | (U 5 18 22) |
| 574 | (D 22 19) |
| 575 | (S 0) |
| 576 | (S 33) |
| 577 | (C 21 554) |
| 578 | (J 0 0 21) |
| 579 | (C 21 856) |
| 580 | (J 65 26 21) |
| 581 | (T 82 81) |
| 582 | (S 82) |
| 583 | (T 33 85) |
| 584 | (S 33) |
| 585 | (C 5 2) |
| 586 | (T 6 33) |
| 587 | (C 7 82) |
| 588 | (C 22 590) |
| 589 | (U 5 18 22) |
| 590 | (D 22 19) |
| 591 | (S 33) |
| 592 | (T 88 33) |
| 593 | (S 33) |
| 594 | (T 89 33) |
| 595 | (S 33) |
| 596 | (T 90 33) |
| 597 | (S 33) |
| 598 | (C 42 0) |
| 599 | (C 54 0) |
| 600 | (C 60 0) |
| 601 | (T 0 40) |
| 602 | (C 21 606) |
| 603 | (J 0 44 21) |
| 604 | (C 21 607) |
| 605 | (J 0 0 21) |
| 606 | (T 54 42) |
| 607 | (C 21 611) |
| 608 | (J 0 45 21) |
| 609 | (C 21 612) |
| 610 | (J 0 0 21) |
| 611 | (T 60 42) |
| 612 | (C 21 618) |
| 613 | (J 0 41 21) |
| 614 | (S 42) |
| 615 | (S 0) |
| 616 | (C 21 602) |
| 617 | (J 0 0 21) |
| 618 | (C 5 2) |
| 619 | (T 6 33) |
| 620 | (C 7 42) |
| 621 | (C 22 623) |
| 622 | (U 5 18 22) |
| 623 | (D 22 19) |
| 624 | (S 33) |
| 625 | (C 5 2) |
| 626 | (T 6 33) |
| 627 | (C 7 71) |
| 628 | (C 22 630) |
| 629 | (U 5 18 22) |
| 630 | (D 22 19) |
| 631 | (C 5 2) |
| 632 | (T 6 88) |
| 633 | (C 7 33) |
| 634 | (C 22 636) |
| 635 | (U 5 18 22) |
| 636 | (D 22 19) |
| 637 | (S 33) |
| 638 | (C 5 2) |
| 639 | (T 6 33) |
| 640 | (C 7 54) |
| 641 | (C 22 643) |
| 642 | (U 5 18 22) |
| 643 | (D 22 19) |
| 644 | (S 33) |
| 645 | (T 55 33) |
| 646 | (S 33) |
| 647 | (T 77 33) |
| 648 | (T 78 56) |
| 649 | (C 0 0) |
| 650 | (A 1 40) |
| 651 | (C 21 657) |
| 652 | (J 0 1 21) |
| 653 | (S 0) |
| 654 | (S 78) |
| 655 | (C 21 651) |
| 656 | (J 0 0 21) |
| 657 | (T 2 42) |
| 658 | (S 2) |
| 659 | (C 1 0) |
| 660 | (C 5 2) |
| 661 | (C 21 676) |
| 662 | (J 54 1 21) |
| 663 | (C 21 683) |
| 664 | (J 2 1 21) |
| 665 | (T 6 77) |
| 666 | (T 7 78) |
| 667 | (C 22 669) |
| 668 | (U 5 18 22) |
| 669 | (D 22 19) |
| 670 | (S 77) |
| 671 | (S 78) |
| 672 | (S 33) |
| 673 | (S 1) |
| 674 | (C 21 661) |
| 675 | (J 0 0 21) |
| 676 | (T 6 55) |
| 677 | (C 7 77) |
| 678 | (C 22 680) |
| 679 | (U 5 18 22) |
| 680 | (D 22 19) |
| 681 | (C 21 663) |
| 682 | (J 0 0 21) |
| 683 | (C 5 2) |
| 684 | (T 6 33) |
| 685 | (C 7 65) |
| 686 | (C 22 688) |
| 687 | (U 5 18 22) |
| 688 | (D 22 19) |
| 689 | (C 5 2) |
| 690 | (T 6 89) |
| 691 | (C 7 33) |
| 692 | (C 22 694) |
| 693 | (U 5 18 22) |
| 694 | (D 22 19) |
| 695 | (S 33) |
| 696 | (C 5 2) |
| 697 | (T 6 33) |
| 698 | (C 7 60) |
| 699 | (C 22 701) |
| 700 | (U 5 18 22) |
| 701 | (D 22 19) |
| 702 | (S 33) |
| 703 | (T 61 33) |
| 704 | (S 33) |
| 705 | (T 77 33) |
| 706 | (T 78 68) |
| 707 | (C 0 0) |
| 708 | (A 1 40) |
| 709 | (C 21 715) |
| 710 | (J 0 1 21) |
| 711 | (S 0) |
| 712 | (S 78) |
| 713 | (C 21 709) |
| 714 | (J 0 0 21) |
| 715 | (T 2 42) |
| 716 | (S 2) |
| 717 | (C 1 0) |
| 718 | (C 5 2) |
| 719 | (C 21 734) |
| 720 | (J 60 1 21) |
| 721 | (C 21 741) |
| 722 | (J 2 1 21) |
| 723 | (T 6 77) |
| 724 | (T 7 78) |
| 725 | (C 22 727) |
| 726 | (U 5 18 22) |
| 727 | (D 22 19) |
| 728 | (S 77) |
| 729 | (S 78) |
| 730 | (S 33) |
| 731 | (S 1) |
| 732 | (C 21 719) |
| 733 | (J 0 0 21) |
| 734 | (T 6 61) |
| 735 | (C 7 77) |
| 736 | (C 22 738) |
| 737 | (U 5 18 22) |
| 738 | (D 22 19) |
| 739 | (C 21 721) |
| 740 | (J 0 0 21) |
| 741 | (C 0 0) |
| 742 | (T 49 48) |
| 743 | (C 21 749) |
| 744 | (J 48 0 21) |
| 745 | (S 0) |
| 746 | (S 49) |
| 747 | (C 21 743) |
| 748 | (J 0 0 21) |
| 749 | (C 5 2) |
| 750 | (T 6 33) |
| 751 | (C 7 49) |
| 752 | (C 22 754) |
| 753 | (U 5 18 22) |
| 754 | (D 22 19) |
| 755 | (C 5 2) |
| 756 | (T 6 90) |
| 757 | (C 7 33) |
| 758 | (C 22 760) |
| 759 | (U 5 18 22) |
| 760 | (D 22 19) |
| 761 | (S 33) |
| 762 | (T 77 33) |
| 763 | (T 78 50) |
| 764 | (C 0 0) |
| 765 | (S 49) |
| 766 | (T 6 77) |
| 767 | (T 7 78) |
| 768 | (C 22 770) |
| 769 | (U 5 18 22) |
| 770 | (D 22 19) |
| 771 | (C 21 779) |
| 772 | (J 49 021) |
| 773 | (S 77) |
| 774 | (S 78) |
| 775 | (S 33) |
| 776 | (S 0) |
| 777 | (C 21 766) |
| 778 | (J 0 0 21) |
| 779 | (S 33) |
| 780 | (T 84 83) |
| 781 | (C 21 840) |
| 782 | (J 84 85 21) |
| 783 | (T 77 84) |
| 784 | (T 78 85) |
| 785 | (S 77) |
| 786 | (S 77) |
| 787 | (S 77) |
| 788 | (S 77) |
| 789 | (S 77) |
| 790 | (S 78) |
| 791 | (S 78) |
| 792 | (S 78) |
| 793 | (S 78) |
| 794 | (S 78) |
| 795 | (A 1 77) |
| 796 | (A 2 78) |
| 797 | (C 21 801) |
| 798 | (J 1 2 21) |
| 799 | (C 21 836) |
| 800 | (J 0 0 21) |
| 801 | (S 77) |
| 802 | (S 78) |
| 803 | (A 75 77) |
| 804 | (A 76 78) |
| 805 | (C 21 809) |
| 806 | (J 75 76 21) |
| 807 | (C 21 836) |
| 808 | (J 0 0 21) |
| 809 | (S 77) |
| 810 | (S 78) |
| 811 | (A 79 77) |
| 812 | (A 80 78) |
| 813 | (C 21 817) |
| 814 | (J 79 80 21) |
| 815 | (C 21 836) |
| 816 | (J 0 0 21) |
| 817 | (S 77) |
| 818 | (S 78) |
| 819 | (S 77) |
| 820 | (S 78) |
| 821 | (C 0 0) |
| 822 | (S 1) |
| 823 | (A 79 77) |
| 824 | (A 80 78) |
| 825 | (C 21 829) |
| 826 | (J 79 80 21) |
| 827 | (C 21 836) |
| 828 | (J 0 0 21) |
| 829 | (S 77) |
| 830 | (S 78) |
| 831 | (S 0) |
| 832 | (C 21 856) |
| 833 | (J 0 1 21) |
| 834 | (C 21 823) |
| 835 | (J 0 0 21) |
| 836 | (A 0 84) |
| 837 | (T 84 0) |
| 838 | (C 21 781) |
| 839 | (J 0 0 21) |
| 840 | (C 5 2) |
| 841 | (T 6 85) |
| 842 | (C 7 33) |
| 843 | (C 22 845) |
| 844 | (U 5 18 22) |
| 845 | (D 22 19) |
| 846 | (T 85 33) |
| 847 | (S 33) |
| 848 | (T 155 33) |
| 849 | (C 0 0) |
| 850 | (T 6 85) |
| 851 | (C 7 0) |
| 852 | (C 22 854) |
| 853 | (U 5 18 22) |
| 854 | (D 22 19) |
| 855 | (S 81) |
| 856 | (C 21 314) |
| 857 | (J 0 0 21) |
| 858 | (T 86 155) |
| 859 | (T 33 86) |
| 860 | (T 84 83) |
| 861 | (C 0 0) |
| 862 | (C 5 2) |
| 863 | (C 21 876) |
| 864 | (J 0 81 21) |
| 865 | (C 7 84) |
| 866 | (T 6 33) |
| 867 | (C 22 869) |
| 868 | (U 5 18 22) |
| 869 | (D 22 19) |
| 870 | (S 0) |
| 871 | (S 33) |
| 872 | (A 2 84) |
| 873 | (T 84 2) |
| 874 | (C 21 863) |
| 875 | (J 0 0 21) |
| 876 | (C 0 0) |
| 877 | (T 155 33) |
| 878 | (S 155) |
| 879 | (T 33 86) |
| 880 | (T 91 155) |
| 881 | (S 155) |
| 882 | (T 99 155) |
| 883 | (T 93 99) |
| 884 | (C 96 1) |
| 885 | (C 97 1) |
| 886 | (C 21 1017) |
| 887 | (J 0 81 21) |
| 888 | (T 94 93) |
| 889 | (S 93) |
| 890 | (A 77 33) |
| 891 | (S 77) |
| 892 | (S 77) |
| 893 | (T 88 77) |
| 894 | (S 77) |
| 895 | (T 89 77) |
| 896 | (S 77) |
| 897 | (T 90 77) |
| 898 | (C 5 2) |
| 899 | (T 6 93) |
| 900 | (A 7 90) |
| 901 | (C 22 903) |
| 902 | (U 5 18 22) |
| 903 | (D 22 19) |
| 904 | (S 93) |
| 905 | (T 6 93) |
| 906 | (A 7 89) |
| 907 | (C 22 909) |
| 908 | (U 5 18 22) |
| 909 | (D 22 19) |
| 910 | (S 93) |
| 911 | (T 6 93) |
| 912 | (A 78 89) |
| 913 | (S 78) |
| 914 | (T 7 78) |
| 915 | (C 22 917) |
| 916 | (U 5 18 22) |
| 917 | (D 22 19) |
| 918 | (A 102 78) |
| 919 | (S 93) |
| 920 | (T 6 93) |
| 921 | (S 77) |
| 922 | (T 7 77) |
| 923 | (C 22 925) |
| 924 | (U 5 18 22) |
| 925 | (D 22 19) |
| 926 | (A 103 77) |
| 927 | (S 93) |
| 928 | (T 6 93) |
| 929 | (T 77 93) |
| 930 | (S 77) |
| 931 | (S 77) |
| 932 | (S 77) |
| 933 | (S 77) |
| 934 | (C 7 77) |
| 935 | (C 22 937) |
| 936 | (U 5 18 22) |
| 937 | (D 22 19) |
| 938 | (T 104 77) |
| 939 | (C 1 0) |
| 940 | (C 21 946) |
| 941 | (J 1 102 21) |
| 942 | (S 77) |
| 943 | (S 1) |
| 944 | (C 21 940) |
| 945 | (J 0 0 21) |
| 946 | (S 93) |
| 947 | (T 6 93) |
| 948 | (C 7 77) |
| 949 | (C 22 951) |
| 950 | (U 5 18 22) |
| 951 | (D 22 19) |
| 952 | (C 21 958) |
| 953 | (J 1 103 21) |
| 954 | (S 77) |
| 955 | (S 1) |
| 956 | (C 21 952) |
| 957 | (J 0 0 21) |
| 958 | (S 93) |
| 959 | (T 6 93) |
| 960 | (C 7 77) |
| 961 | (C 22 963) |
| 962 | (U 5 18 22) |
| 963 | (D 22 19) |
| 964 | (S 93) |
| 965 | (T 6 93) |
| 966 | (C 7 96) |
| 967 | (C 22 969) |
| 968 | (U 5 18 22) |
| 969 | (D 22 19) |
| 970 | (S 93) |
| 971 | (C 1 0) |
| 972 | (A 77 89) |
| 973 | (S 77) |
| 974 | (S 77) |
| 975 | (S 77) |
| 976 | (T 6 93) |
| 977 | (T 7 77) |
| 978 | (C 22 980) |
| 979 | (U 5 18 22) |
| 980 | (D 22 19) |
| 981 | (C 21 988) |
| 982 | (J 1 103 21) |
| 983 | (S 1) |
| 984 | (S 93) |
| 985 | (S 77) |
| 986 | (C 21 976) |
| 987 | (J 0 0 21) |
| 988 | (S 93) |
| 989 | (A 77 90) |
| 990 | (C 1 1) |
| 991 | (A 49 77) |
| 992 | (S 77) |
| 993 | (T 6 93) |
| 994 | (T 7 77) |
| 995 | (C 22 997) |
| 996 | (U 5 18 22) |
| 997 | (D 22 19) |
| 998 | (C 21 1005) |
| 999 | (J 1 49 21) |
| 1000 | (S 1) |
| 1001 | (S 93) |
| 1002 | (S 77) |
| 1003 | (C 21 993) |
| 1004 | (J 0 0 21) |
| 1005 | (S 93) |
| 1006 | (T 6 94) |
| 1007 | (C 7 93) |
| 1008 | (C 22 1010) |
| 1009 | (U 5 18 22) |
| 1010 | (D 22 19) |
| 1011 | (S 0) |
| 1012 | (S 33) |
| 1013 | (S 96) |
| 1014 | (T 155 93) |
| 1015 | (C 21 886) |
| 1016 | (J 0 0 21) |
| 1017 | (T 101 81) |
| 1018 | (T 98 101) |
| 1019 | (C 101 0) |
| 1020 | (C 96 0) |
| 1021 | (C 21 1551) |
| 1022 | (J 96 98 21) |
| 1023 | (T 92 99) |
| 1024 | (T 94 92) |
| 1025 | (T 99 155) |
| 1026 | (T 100 99) |
| 1027 | (C 21 1018) |
| 1028 | (J 96 98 21) |
| 1029 | (C 87 0) |
| 1030 | (T 84 86) |
| 1031 | (C 21 1545) |
| 1032 | (J 87 81 21) |
| 1033 | (A 33 84) |
| 1034 | (S 87) |
| 1035 | (T 93 94) |
| 1036 | (S 93) |
| 1037 | (A 137 93) |
| 1038 | (S 93) |
| 1039 | (A 105 93) |
| 1040 | (S 93) |
| 1041 | (A 109 93) |
| 1042 | (S 93) |
| 1043 | (A 111 93) |
| 1044 | (S 93) |
| 1045 | (A 113 93) |
| 1046 | (S 93) |
| 1047 | (A 115 93) |
| 1048 | (S 93) |
| 1049 | (A 117 93) |
| 1050 | (C 107 0) |
| 1051 | (S 33) |
| 1052 | (A 138 33) |
| 1053 | (S 33) |
| 1054 | (T 88 33) |
| 1055 | (S 33) |
| 1056 | (T 89 33) |
| 1057 | (S 33) |
| 1058 | (T 90 33) |
| 1059 | (S 33) |
| 1060 | (A 112 33) |
| 1061 | (A 33 88) |
| 1062 | (A 106 33) |
| 1063 | (S 33) |
| 1064 | (A 110 33) |
| 1065 | (S 33) |
| 1066 | (A 116 33) |
| 1067 | (S 33) |
| 1068 | (T 114 33) |
| 1069 | (C 108 0) |
| 1070 | (C 21 1074) |
| 1071 | (J 105 106 21) |
| 1072 | (C 21 1173) |
| 1073 | (J 0 0 21) |
| 1074 | (T 118 115) |
| 1075 | (T 119 116) |
| 1076 | (T 1 109) |
| 1077 | (T 2 110) |
| 1078 | (A 3 118) |
| 1079 | (A 4 119) |
| 1080 | (C 21 1084) |
| 1081 | (J 3 4 21) |
| 1082 | (C 21 1173) |
| 1083 | (J 0 0 21) |
| 1084 | (C 21 1094) |
| 1085 | (J 1 111 21) |
| 1086 | (C 21 1098) |
| 1087 | (J 2 112 21) |
| 1088 | (S 1) |
| 1089 | (S 2) |
| 1090 | (S 118) |
| 1091 | (S 119) |
| 1092 | (C 21 1078) |
| 1093 | (J 0 0 21) |
| 1094 | (C 125 1) |
| 1095 | (C 126 0) |
| 1096 | (C 21 1100) |
| 1097 | (J 0 0 21) |
| 1098 | (C 125 0) |
| 1099 | (C 126 1) |
| 1100 | (T 1 107) |
| 1101 | (T 2 108) |
| 1102 | (C 0 0) |
| 1103 | (C 21 1112) |
| 1104 | (J 1 109 21) |
| 1105 | (C 21 1136) |
| 1106 | (J 2 110 21) |
| 1107 | (S 0) |
| 1108 | (S 1) |
| 1109 | (S 2) |
| 1110 | (C 21 1103) |
| 1111 | (J 0 0 21) |
| 1112 | (C 127 1) |
| 1113 | (C 128 0) |
| 1114 | (T 118 113) |
| 1115 | (C 0 0) |
| 1116 | (C 21 1122) |
| 1117 | (J 107 0 21) |
| 1118 | (S 0) |
| 1119 | (S 118) |
| 1120 | (C 21 1116) |
| 1121 | (J 0 0 21) |
| 1122 | (T 119 114) |
| 1123 | (C 3 0) |
| 1124 | (C 21 1130) |
| 1125 | (J 108 3 21) |
| 1126 | (S 3) |
| 1127 | (S 119) |
| 1128 | (C 21 1124) |
| 1129 | (J 0 0 21) |
| 1130 | (C 21 1160) |
| 1131 | (J 2 110 21) |
| 1132 | (S 119) |
| 1133 | (S 2) |
| 1134 | (C 21 1130) |
| 1135 | (J 0 0 21) |
| 1136 | (C 127 0) |
| 1137 | (C 128 1) |
| 1138 | (T 119 114) |
| 1139 | (C 0 0) |
| 1140 | (C 21 1146) |
| 1141 | (J 108 0 21) |
| 1142 | (S 0) |
| 1143 | (S 119) |
| 1144 | (C 21 1140) |
| 1145 | (J 0 0 21) |
| 1146 | (T 118 113) |
| 1147 | (C 3 0) |
| 1148 | (C 21 1154) |
| 1149 | (J 107 3 21) |
| 1150 | (S 3) |
| 1151 | (S 118) |
| 1152 | (C 21 1148) |
| 1153 | (J 0 0 21) |
| 1154 | (C 21 1160) |
| 1155 | (J 1 109 21) |
| 1156 | (S 118) |
| 1157 | (S 1) |
| 1158 | (C 21 1154) |
| 1159 | (J 0 0 21) |
| 1160 | (C 21 1176) |
| 1161 | (J 118 115 21) |
| 1162 | (J 119 116 21) |
| 1163 | (A 3 118) |
| 1164 | (A 4 119) |
| 1165 | (C 21 1169) |
| 1166 | (J 3 4 21) |
| 1167 | (C 21 1173) |
| 1168 | (J 0 0 21) |
| 1169 | (S 118) |
| 1170 | (S 119) |
| 1171 | (C 21 1160) |
| 1172 | (J 0 0 21) |
| 1173 | (C 120 0) |
| 1174 | (C 21 1542) |
| 1175 | (J 0 0 21) |
| 1176 | (C 120 1) |
| 1177 | (C 121 0) |
| 1178 | (C 122 0) |
| 1179 | (C 123 0) |
| 1180 | (C 124 0) |
| 1181 | (C 21 1189) |
| 1182 | (J 120 127 21) |
| 1183 | (C 21 1195) |
| 1184 | (J 120 126 21) |
| 1185 | (C 21 1198) |
| 1186 | (J 120 125 21) |
| 1187 | (C 21 1361) |
| 1188 | (J 0 0 21) |
| 1189 | (C 21 1201) |
| 1190 | (J 120 125 21) |
| 1191 | (C 21 1204) |
| 1192 | (J 120 126 21) |
| 1193 | (C 21 1361) |
| 1194 | (J 0 0 21) |
| 1195 | (C 121 1) |
| 1196 | (C 21 1205) |
| 1197 | (J 0 0 21) |
| 1198 | (C 122 1) |
| 1199 | (C 21 1205) |
| 1200 | (J 0 0 21) |
| 1201 | (C 123 1) |
| 1202 | (C 21 1205) |
| 1203 | (J 0 0 21) |
| 1204 | (C 124 1) |
| 1205 | (T 132 100) |
| 1206 | (S 132) |
| 1207 | (S 132) |
| 1208 | (S 132) |
| 1209 | (S 132) |
| 1210 | (S 132) |
| 1211 | (S 132) |
| 1212 | (S 132) |
| 1213 | (C 3 0) |
| 1214 | (S 132) |
| 1215 | (S 3) |
| 1216 | (S 132) |
| 1217 | (C 21 1221) |
| 1218 | (J 3 97 21) |
| 1219 | (C 21 1215) |
| 1220 | (J 0 0 21) |
| 1221 | (S 132) |
| 1222 | (C 145 0) |
| 1223 | (A 78 89) |
| 1224 | (A 129 78) |
| 1225 | (S 78) |
| 1226 | (A 146 78) |
| 1227 | (S 78) |
| 1228 | (S 78) |
| 1229 | (T 142 78) |
| 1230 | (T 147 112) |
| 1231 | (C 21 1239) |
| 1232 | (J 120 121 21) |
| 1233 | (J 120 122 21) |
| 1234 | (C 21 1308) |
| 1235 | (J 120 123 21) |
| 1236 | (J 120 124 21) |
| 1237 | (C 21 1542) |
| 1238 | (J 0 0 21) |
| 1239 | (T 0 110) |
| 1240 | (C 135 0) |
| 1241 | (C 21 1247) |
| 1242 | (J 0 109 21) |
| 1243 | (S 0) |
| 1244 | (S 135) |
| 1245 | (C 21 1241) |
| 1246 | (J 0 0 21) |
| 1247 | (C 1 0) |
| 1248 | (T 118 113) |
| 1249 | (T 131 132) |
| 1250 | (C 5 2) |
| 1251 | (C 139 0) |
| 1252 | (C 3 0) |
| 1253 | (C 141 0) |
| 1254 | (T 6 131) |
| 1255 | (T 7 118) |
| 1256 | (C 22 1258) |
| 1257 | (U 5 18 22) |
| 1258 | (D 22 19) |
| 1259 | (S 131) |
| 1260 | (S 118) |
| 1261 | (S 1) |
| 1262 | (S 3) |
| 1263 | (S 141) |
| 1264 | (C 21 1268) |
| 1265 | (J 1 135 21) |
| 1266 | (C 21 1254) |
| 1267 | (J 0 0 21) |
| 1268 | (C 1 0) |
| 1269 | (T 144 142) |
| 1270 | (T 6 131) |
| 1271 | (T 7 144) |
| 1272 | (C 22 1274) |
| 1273 | (U 5 18 22) |
| 1274 | (D 22 19) |
| 1275 | (C 21 1287) |
| 1276 | (J 1 146 21) |
| 1277 | (C 21 1291) |
| 1278 | (J 1 147 21) |
| 1279 | (S 131) |
| 1280 | (S 144) |
| 1281 | (S 118) |
| 1282 | (S 1) |
| 1283 | (S 3) |
| 1284 | (S 141) |
| 1285 | (C 21 1270) |
| 1286 | (J 0 0 21) |
| 1287 | (T 140 3) |
| 1288 | (T 133 131) |
| 1289 | (C 21 1277) |
| 1290 | (J 0 0 21) |
| 1291 | (C 21 1361) |
| 1292 | (J 120 122 21) |
| 1293 | (S 131) |
| 1294 | (S 118) |
| 1295 | (T 6 131) |
| 1296 | (T 7 118) |
| 1297 | (C 22 1299) |
| 1298 | (U 5 18 22) |
| 1299 | (D 22 19) |
| 1300 | (C 21 1361) |
| 1301 | (J 3 111 21) |
| 1302 | (S 131) |
| 1303 | (S 118) |
| 1304 | (S 3) |
| 1305 | (S 141) |
| 1306 | (C 21 1295) |
| 1307 | (J 0 0 21) |
| 1308 | (C 1 0) |
| 1309 | (T 3 109) |
| 1310 | (C 5 2) |
| 1311 | (C 141 0) |
| 1312 | (T 131 132) |
| 1313 | (T 144 142) |
| 1314 | (T 6 131) |
| 1315 | (T 7 144) |
| 1316 | (C 22 1318) |
| 1317 | (U 5 18 22) |
| 1318 | (D 22 19) |
| 1319 | (C 21 1334) |
| 1320 | (J 1 146 21) |
| 1321 | (C 21 1338) |
| 1322 | (J 3 110 21) |
| 1323 | (C 21 1342) |
| 1324 | (J 1 147 21) |
| 1325 | (S 131) |
| 1326 | (S 144) |
| 1327 | (S 118) |
| 1328 | (S 1) |
| 1329 | (S 3) |
| 1330 | (S 4) |
| 1331 | (S 141) |
| 1332 | (C 21 1314) |
| 1333 | (J 0 0 21) |
| 1334 | (T 140 146) |
| 1335 | (T 133 131) |
| 1336 | (C 21 1321) |
| 1337 | (J 0 0 21) |
| 1338 | (T 118 113) |
| 1339 | (C 40) |
| 1340 | (C 21 1323) |
| 1341 | (J 0 0 21) |
| 1342 | (C 21 1361) |
| 1343 | (J 120 123 21) |
| 1344 | (S 131) |
| 1345 | (S 118) |
| 1346 | (T 6 131) |
| 1347 | (T 7 118) |
| 1348 | (C 22 1350) |
| 1349 | (U 5 18 22) |
| 1350 | (D 22 19) |
| 1351 | (C 21 1361) |
| 1352 | (J 4 111 21) |
| 1353 | (S 131) |
| 1354 | (S 118) |
| 1355 | (S 4) |
| 1356 | (S 141) |
| 1357 | (C 21 1346) |
| 1358 | (J 0 0 21) |
| 1359 | (C 21 1361) |
| 1360 | (J 0 0 21) |
| 1361 | (T 130 129) |
| 1362 | (T 134 131) |
| 1363 | (S 131) |
| 1364 | (T 136 131) |
| 1365 | (T 77 117) |
| 1366 | (S 77) |
| 1367 | (C 1 1) |
| 1368 | (T 6 136) |
| 1369 | (T 7 77) |
| 1370 | (C 22 1372) |
| 1371 | (U 5 18 22) |
| 1372 | (D 22 19) |
| 1373 | (C 21 1380) |
| 1374 | (J 1 137 21) |
| 1375 | (S 1) |
| 1376 | (S 136) |
| 1377 | (S 77) |
| 1378 | (C 21 1368) |
| 1379 | (J 0 0 21) |
| 1380 | (A 77 90) |
| 1381 | (C 1 1) |
| 1382 | (A 49 77) |
| 1383 | (S 77) |
| 1384 | (S 136) |
| 1385 | (T 6 136) |
| 1386 | (T 7 77) |
| 1387 | (C 22 1389) |
| 1388 | (U 5 18 22) |
| 1389 | (D 22 19) |
| 1390 | (S 137) |
| 1391 | (S 136) |
| 1392 | (S 77) |
| 1393 | (C 21 1398) |
| 1394 | (J 1 49 21) |
| 1395 | (S 1) |
| 1396 | (C 21 1385) |
| 1397 | (J 0 0 21) |
| 1398 | (T 6 100) |
| 1399 | (C 7 136) |
| 1400 | (C 22 1402) |
| 1401 | (U 5 18 22) |
| 1402 | (D 22 19) |
| 1403 | (T 136 100) |
| 1404 | (S 136) |
| 1405 | (C 5 2) |
| 1406 | (T 6 136) |
| 1407 | (C 7 137) |
| 1408 | (C 22 1410) |
| 1409 | (U 5 18 22) |
| 1410 | (D 22 19) |
| 1411 | (S 136) |
| 1412 | (T 6 136) |
| 1413 | (C 7 130) |
| 1414 | (C 22 1416) |
| 1415 | (U 5 18 22) |
| 1416 | (D 22 19) |
| 1417 | (S 136) |
| 1418 | (T 6 136) |
| 1419 | (C 7 140) |
| 1420 | (C 22 1422) |
| 1421 | (U 5 18 22) |
| 1422 | (D 22 19) |
| 1423 | (S 136) |
| 1424 | (T 6 136) |
| 1425 | (C 7 141) |
| 1426 | (C 22 1428) |
| 1427 | (U 5 18 22) |
| 1428 | (D 22 19) |
| 1429 | (S 136) |
| 1430 | (T 6 136) |
| 1431 | (C 7 132) |
| 1432 | (C 22 1434) |
| 1433 | (U 5 18 22) |
| 1434 | (D 22 19) |
| 1435 | (S 136) |
| 1436 | (T 6 136) |
| 1437 | (C 7 133) |
| 1438 | (C 22 1440) |
| 1439 | (U 5 18 22) |
| 1440 | (D 22 19) |
| 1441 | (S 136) |
| 1442 | (T 6 136) |
| 1443 | (C 7 134) |
| 1444 | (C 22 1446) |
| 1445 | (U 5 18 22) |
| 1446 | (D 22 19) |
| 1447 | (T 93 94) |
| 1448 | (S 93) |
| 1449 | (S 93) |
| 1450 | (S 93) |
| 1451 | (S 93) |
| 1452 | (S 93) |
| 1453 | (S 93) |
| 1454 | (S 93) |
| 1455 | (C 3 0) |
| 1456 | (S 136) |
| 1457 | (S 93) |
| 1458 | (T 6 136) |
| 1459 | (T 7 93) |
| 1460 | (C 22 1462) |
| 1461 | (U 5 18 22) |
| 1462 | (D 22 19) |
| 1463 | (S 3) |
| 1464 | (S 136) |
| 1465 | (C 21 1469) |
| 1466 | (J 3 97 21) |
| 1467 | (C 21 1458) |
| 1468 | (J 0 0 21) |
| 1469 | (T 6 136) |
| 1470 | (C 7 138) |
| 1471 | (C 22 1473) |
| 1472 | (U 5 18 22) |
| 1473 | (D 22 19) |
| 1474 | (S 101) |
| 1475 | (C 151 1) |
| 1476 | (C 0 0) |
| 1477 | (C 21 1484) |
| 1478 | (J 0 137 21) |
| 1479 | (S 0) |
| 1480 | (S 0) |
| 1481 | (S 151) |
| 1482 | (C 21 1477) |
| 1483 | (J 0 0 21) |
| 1484 | (C 150 0) |
| 1485 | (C 21 1538) |
| 1486 | (S 150) |
| 1487 | (J 150 151 21) |
| 1488 | (S 150) |
| 1489 | (J 150 151 21) |
| 1490 | (T 148 134) |
| 1491 | (S 148) |
| 1492 | (C 153 0) |
| 1493 | (T 149 148) |
| 1494 | (C 0 0) |
| 1495 | (C 21 1507) |
| 1496 | (J 0 150 21) |
| 1497 | (S 0) |
| 1498 | (S 0) |
| 1499 | (S 149) |
| 1500 | (S 149) |
| 1501 | (S 153) |
| 1502 | (S 153) |
| 1503 | (C 21 1485) |
| 1504 | (J 153 137 21) |
| 1505 | (C 21 1495) |
| 1506 | (J 0 0 21) |
| 1507 | (T 77 148) |
| 1508 | (T 78 149) |
| 1509 | (C 0 0) |
| 1510 | (T 154 153) |
| 1511 | (A 3 77) |
| 1512 | (A 4 78) |
| 1513 | (C 21 1517) |
| 1514 | (J 3 4 21) |
| 1515 | (C 21 1527) |
| 1516 | (J 0 0 21) |
| 1517 | (S 77) |
| 1518 | (S 78) |
| 1519 | (S 0) |
| 1520 | (S 154) |
| 1521 | (C 21 1557) |
| 1522 | (J 0 150 21) |
| 1523 | (C 21 1485) |
| 1524 | (J 154 137 21) |
| 1525 | (C 21 1511) |
| 1526 | (J 0 0 21) |
| 1527 | (S 148) |
| 1528 | (S 148) |
| 1529 | (S 149) |
| 1530 | (S 149) |
| 1531 | (C 21 1485) |
| 1532 | (S 153) |
| 1533 | (J 153 137 21) |
| 1534 | (S 153) |
| 1535 | (J 153 137 21) |
| 1536 | (C 21 1507) |
| 1537 | (J 0 0 21) |
| 1538 | (A 9 100) |
| 1539 | (T 100 9) |
| 1540 | (T 155 100) |
| 1541 | (S 155) |
| 1542 | (S 84) |
| 1543 | (C 21 1031) |
| 1544 | (J 0 0 21) |
| 1545 | (S 96) |
| 1546 | (A 95 94) |
| 1547 | (T 94 95) |
| 1548 | (C 21 1027) |
| 1549 | (J 0 0 21) |
| 1550 | (S 97) |
| 1551 | (C 0 72) |
| 1552 | (C 1 65) |
| 1553 | (C 2 76) |
| 1554 | (C 3 84) |
| 1555 | (C 21 1590) |
| 1556 | (J 0 0 21) |
| 1557 | (C 0 73) |
| 1558 | (C 1 77) |
| 1559 | (C 2 77) |
| 1560 | (C 3 79) |
| 1561 | (C 4 82) |
| 1562 | (C 5 84) |
| 1563 | (C 6 65) |
| 1564 | (C 7 76) |
| 1565 | (T 8 150) |
| 1566 | (T 9 148) |
| 1567 | (T 10 149) |
| 1568 | (C 21 1590) |
| 1569 | (J 0 0 21) |
| 1570 | (C 0 69) |
| 1571 | (C 1 82) |
| 1572 | (C 2 82) |
| 1573 | (C 3 79) |
| 1574 | (C 4 82) |
| 1575 | (C 5 32) |
| 1576 | (C 6 84) |
| 1577 | (C 7 85) |
| 1578 | (C 8 82) |
| 1579 | (C 9 73) |
| 1580 | (C 10 78) |
| 1581 | (C 11 71) |
| 1582 | (C 12 32) |
| 1583 | (C 13 80) |
| 1584 | (C 14 82) |
| 1585 | (C 15 79) |
| 1586 | (C 16 71) |
| 1587 | (C 17 82) |
| 1588 | (C 18 65) |
| 1589 | (C 19 77) |

The following patents describe active element machines, which are incorporated herein by reference, Patent Cooperation Treaty Application, Serial Number PCT/US06/26159 (Docket #11-11), entitled “Active Element Machine Computation,” filed Jul. 3, 2006; U.S. patent application Ser. No. 11/477,201 (Docket #11-9), entitled, “Register and Active Element Machines: Commands, Programs, Simulators, and Translators,” filed Jun. 27, 2006; U.S. Provisional Application Ser. No. 60/699,244 (Docket #11-10), “Abstract Register and Active Element Machines Commands, Programs, Simulators, and Translators,” entitled filed Jul. 14, 2005; U.S. patent application Ser. No. 11/178,665 (Docket #11-3) entitled, “Active Element Machine Computation,” filed Jul. 11, 2005; U.S. patent application Ser. No. 10/791,249 (Docket #11-2), entitled “Effector Machine Computation,” filed Mar. 2, 2004; and U.S. Provisional Patent Application Ser. No. 60/456,715, filed Mar. 24, 2003.

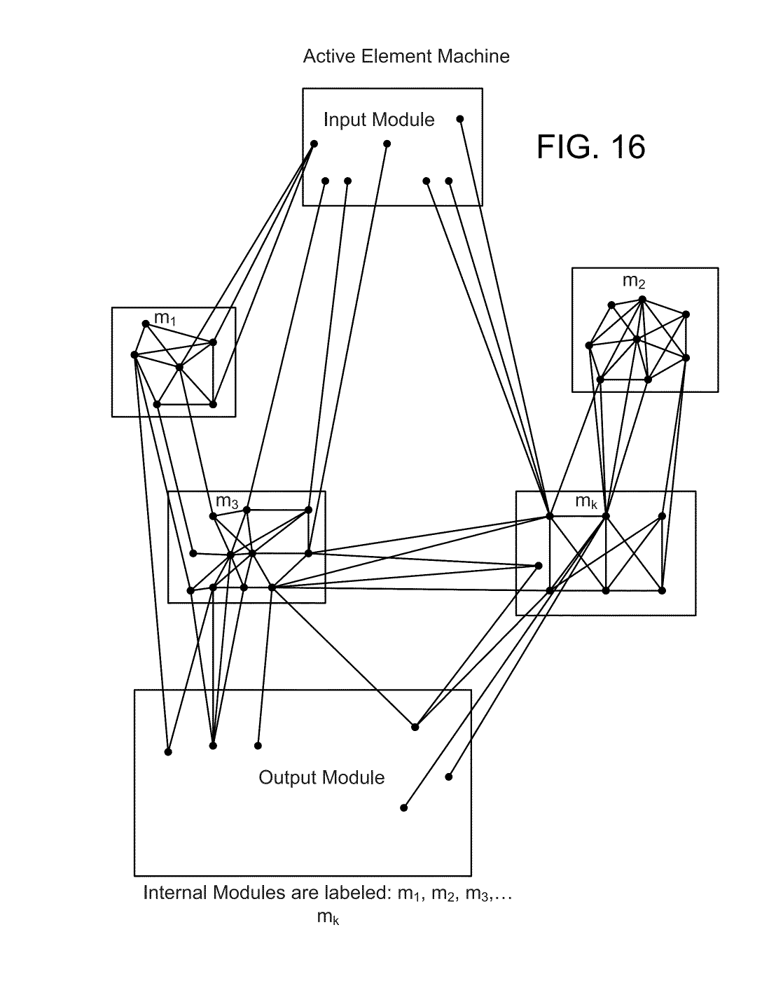

FIG. 16 shows an example of an active element machine. Each dot in the FIG. 16 represents an active element. Each active element is capable of receiving and sending messages. The active elements are arranged in a network including input active elements, which receive input from other machines, devices or parts of the same machine.

For example input active elements may receive input from a keyboard, tracking device, microphone, and/or a network of machines, such as the internet. Some of the active elements produce the output of the active element machine and may communicate with a monitor, speaker, and/or a network of other machines, for example. Optionally, the active element machine may also include computation active elements, which only send messages to and receive messages from other active elements.

Each active element may receive input from a plurality of active elements and send messages to a plurality of active elements. In response to receiving a set of one or more signals, if the sum of the signals received from other active elements cross a preset threshold within a given window of time, the active element fires, sending messages to other active elements.

The connections between the active elements may be altered and the pulse width and amplitude, may be changed while the active element machine is running. The basic instruction set for the active element machine addresses individual active elements connecting and disconnecting active elements to one another and altering the signals sent along the connections.

The active element machine instructions includes time as a parameter allowing the timing of the execution of the instructions to be timed to occur at precise times. The active element machine is a massively parallel processing machine in which instructions may be processed simultaneously. The active element machine may be programmed using a conventional compiler, which converts the convention programming language (e.g, C, JAVA, Visual BASIC) in the basic instructions set of the active element machine. Optionally the active elements may be grouped into different modules having different functions.

Alternatively, the active element machine may be given a training set of input-output pairs, and the active element machine implements an algorithm of changing its structure until a machine architecture is found that best implements the training set. Optionally the active elements may be grouped into different modules which during the training may be altered and/or switched with one another to create mutations and permutations of prior machines to experiment with which machine implements the training set the best.

In FIG. 16, the modules of the active element machine are labeled m₁ to mₖ. The number of active elements in each module may vary. Although in FIG. 16, there are relatively few active elements and modules, there may be any number of active elements in an active element machine and any number of modules.

Further, each module may have any number of active elements. Any of the machine and/or methods of this specification may be implemented on an active element machine. In other embodiments, active element machine 1600 may include additional components and/or may not include all of the components of FIG. 16.

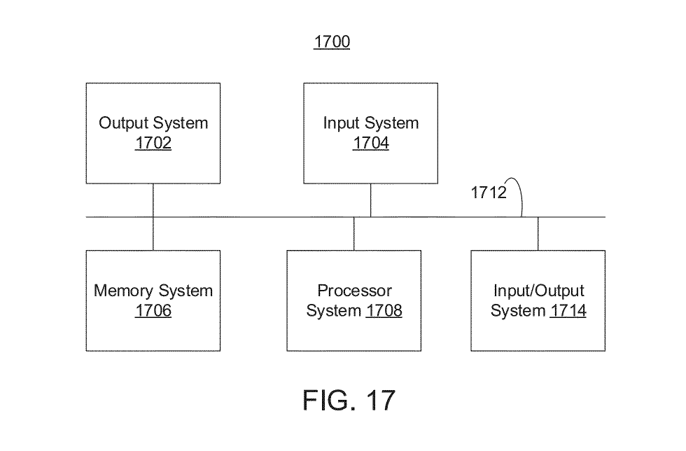

FIG. 17 shows a block diagram of a machine 1700 that may run any of the methods, algorithms, and/or other machine of this specification. The machine 1700 may include output system 1702, input system 1704, memory system 1706, processor system 1708, communications system 1712, and input/output device 1714. In other embodiments, machine 1700 may include additional components and/or may not include all of the components listed above.

Machine 1700 is an example of machine that may be used for hardware of the specification. Although active element machine of FIG. 16 may be built in hardware, the active element machine FIG. 16 may simulated on machine 1700, and the virtual version of the active element machine of FIG. 16 may run the systems and methods of this specification. Alternatively, machine 1700 may be simulated on the active element machine of FIG. 16, and the methods and systems of this specification may be run on the virtual version of machine 1700 that is running on the active element machine of FIG. 16.

Output system 1702 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 1704 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 1706 may include, for example, any one of, some of, any combination of, or all of a long term storage system, such as a hard drive; a short term storage system, such as random access memory; a removable storage system, such as a floppy drive or a removable drive; and/or flash memory. Memory system 1706 may include one or more machine-readable mediums that may store a variety of different types of information.

The term machine-readable medium is used to refer to any non-transient medium capable carrying information that is readable by a machine. One example of a machine-readable medium is a non-transient computer-readable medium. Another example of a machine-readable medium is paper having holes that are detected that trigger different mechanical, electrical, and/or logic responses.

Processor system 1708 may include any one of, some of, any combination of, or all of multiple parallel processors, a single processor, a system of processors having one or more central processors and/or one or more specialized processors dedicated to specific tasks.

Communications system 1712 communicatively links output system 1702, input system 1704, memory system 1706, processor system 1708, and/or input/output system 1714 to each other. Communications system 1712 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 1714 may include devices that have the dual function as input and output devices. For example, input/output system 1714 may include one or more touch sensitive screens, which display an image and therefore are an output device and accept input when the screens are pressed by a finger or stylus, for example.

The touch sensitive screens may be sensitive to heat and/or pressure. One or more of the input/output devices may be sensitive to a voltage or current produced by a stylus, for example. Input/output system 1714 is optional, and may be used in addition to or in place of output system 1702 and/or input device 1704.

### ALTERNATIVES AND EXTENSIONS

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
receiving, at a machine, a set of machine instructions, the machine including one or more machine computation elements, the set of machine instructions including a preset sequence in which the machine instructions are invoked prior to being modified;
in response, invoking, by the machine computation elements of the machine, the set of machine instructions on the machine;
as part of invoking the set of machine instructions,
automatically implementing, by the machine, based on the set of machine instructions and the preset sequence, a machine instruction, from the set of machine instructions, that modifies the set of machine instructions, while the set of machine instructions is being invoked.

2. The method of claim 1, implementing the machine instruction that modifies machine instructions further comprises automatically deleting one or more machine instructions of the set of machine instructions, while the set of machine instructions are being invoked.

3. The method of claim 2, where implementing the automatically deleting of the one more instructions of the set of machine instructions, includes at least automatically deleting the instruction that is performing the deleting, while the set of machine instructions are being invoked.

4. The method of claim 1, where implementing the machine instruction that modifies machine instructions further comprises automatically inserting an instruction into the set of machine instructions, while the set of machine instructions are being invoked.

5. The method of claim 4, where implementing the machine instruction that modifies machine instructions further comprises automatically creating one or more the machine instructions being inserted prior to automatically inserting the one or more machine instructions of the set of machine instructions into the set of machine instructions, while the set of machine instructions are being invoked.

6. The method of claim 1, where implementing the machine instruction that modifies machine instructions further comprises automatically altering the preset sequence in which the set of machine instructions are invoked, while the set of machine instructions are being invoked.

7. A method comprising:
determining, by a machine, an input and an output of a machine instruction, the machine including one or more machine computation elements;
determine by the machine a numerical representation of the input and of the output;
determining, by the one or more machine computation elements, a matrix function, which when applied to the numerical representation of the input results in the output;
computing by the machine a composite matrix function by applying a first matrix function to a second matrix function, the composite matrix function representing a series of at least two matrix function to obtain a machine representation of a series of machine instruction implemented in a particular sequence.

8. The method of claim 7, further comprising:
determining, by the machine, whether an infinite loop is present by at least determining values of a set of at least two input values, which when inserted as input to the composite matrix function results in the at least two input values as output values.

9. The method of claim 8, the determining of whether the infinite loop is present further comprising, determining, by the machine, a range of possible input values of the composite matrix function;
determining a range of possible output values for the composite matrix that correspond to the possible input values; and
determining whether the particular sequence in which the series of machine instruction is implemented results in an infinite loop, based on
whether the set of at least two input values is inside of the range of possible output values that corresponds to the possible input values, and
whether the set of two least input values is outside of the range of possible output values that corresponds to the possible input values.

10. The method of claim 7, the input values including at least one value representing a state of the machine and at least one value representing data being operated upon by a computer instruction represented by the matrix function;
the matrix function including at least
a matrix that is multiplied by the input values, and
an array of values that are added to a result of the matrix being multiplied by the input values;
the array of values characterizing a current pattern of data stored by the machine, in addition to the input values by which the matrix is multiplied.

11. A method comprising:
storing in a machine a collection of pairs of nodes, each pair of nodes forming a machine instruction, each node of each pair of nodes having a one-to-one correspondence to one another, where
a first node of the pair is an input node and a second node of the pair in an output node,
the input node storing a set of three or more input values,
at least one input value of the three or more input values representing a state of the machine prior to executing the pair of nodes forming the machine instruction, and
at least two input values of the three or more input values representing an input data pattern, and
the output node storing three or more output values, at least one output value of the three more output values representing a state of the machine after executing the pair of nodes forming the machine instruction, and
at least two output values of the three or more output values representing output pattern data;
executing, by the machine, the machine instruction by at least
reading, by the machine, an input data pattern from data that the machine instructions operate upon, which is different than the execution nodes pairs, therein forming a current input pattern read;
determining, by the machine, what state the machine is currently in;
determining, by the machine, a node pair having an input node having
an input value for a current state of the machine that matches what state the machine is currently in, and
a pattern of input values for input data that includes at least portion that matches at least a portion of the current pattern read;
updating, by the machine, the state of the machine to the output state;
updating, by the machine, the data that the machine instructions operate upon to include the output data pattern of the output node.

12. The method of claim 11, the input node storing an input read location, which is an input data location within the input data pattern to which the machine points prior to executing the machine instruction, and the output node storing an output read location which is an output data location within the output data pattern to which the machine points after executing the machine instruction;
where the determining of the pattern of input values for input data that includes at least the portion that matches at least the portion of the current pattern read includes at least determining that a read location of the data pattern read matches the read location of the input data pattern of the input node; and where
the updating, by the machine, of the data that the machine instructions operate upon, to include the output data pattern of the output node, includes at least updating a current read location to the read location indicated by the output node.

13. A method comprising:
forming, by a machine, a collection of pairs of nodes, each pair of nodes being a computer instruction of a computer program, each node of each pair of nodes having a one-to-one correspondence to one another, where
a first node of the pair is an input node and a second node of the pair in an output node,
the input node storing a set of three or more input values,
at least one input value of the three or more input values representing a state of the machine prior to executing the pair of nodes forming the machine instruction, and
at least two input values of the three or more input values representing an input data pattern, and
the output node storing three or more output values, at least one output value of the three more output values representing a state of the machine after executing the pair of nodes forming the machine instruction, and
at least two output values of the three or more output values representing output pattern data.

14. The method of claim 13, further comprising:
forming, by the machine, one or more chains of pairs of nodes, each chain of pairs of nodes, being a sequence of machine instructions;
determining, by the machine, whether the one or more chains of pairs of nodes are associated with sequence of states that is repeated in succession; and
if the one or more chains of pairs of nodes includes at least one sequence of states that is repeated in succession, indicating by the machine that an infinite loop is present.

15. The method of claim 14, the forming the one or more chains of pairs of nodes being formed by at least
determining, by the machine, whether an output node of a current end pair of nodes matches with an input node of another pair of nodes that is not part of the chain, the chain having at least the current end pair of nodes in the chain;
after the determining of whether the output node of the current end pair matches, if another pair of nodes has an input node that matches, linking, by the machine, the other pair of nodes to the current end pair of nodes in the chain of nodes, updating, by the machine, an indication to indicate that the other pair of nodes in what is now the current end pair of nodes, and repeating the determining whether the output node of the current pair of end nodes matches another pair of nodes.

16. The method of claim 13, further comprising:
converting, by a machine, an original computer program into a collection of pairs of nodes;
each pair of nodes forming a new machine instruction, the collection of pairs of nodes forming a new collection of machine instructions that replaces an original set of computer instructions in which the original computer program was written.

17. The method of claim 13, the forming of the collection of pairs of nodes further comprising:
forming, by the machine, a pair of nodes including at least
(a) determining, by the machine, a current data pattern, if step (a) is being performed a first time while forming the pair of nodes, store the current data pattern is the initial data pattern;
(b) determining, by the machine, a current state of the machine, if step (b) is being performed a first time while forming the pair of nodes, the current of the machine is the initial state;
(c) storing, by the machine, the current state of the machine as a first state in a sequence of states associated with the pair of nodes;
(d) determining, by the machine, a currently applicable machine instruction of an original program that matches the current state and current data pattern;
(e) determining, by the machine, a new state of the machine and a new data pattern resulting from applying the applicable instruction;
(f) determining, by the machine, whether the new state occurred before in the sequence of states associated with the pair of nodes;
(g) if the new state did not occur before, in the sequence of states associated with the node pair, adding by the machine, the new state to the sequence of states, updating the current state, by setting a value of the current state to be a value of the new state, and repeating steps (d)-(g); and
if the new state did occur before in the sequence of states associated with the pair of nodes,
saving by the machine, the current data pattern as the output data pattern of the output node,
saving, by the machine, the current state as the output state of the output node,
saving, by the machine, the initial data pattern as the input data pattern of the input node, and
saving, by the machine, the initial state as the input state of the input node.

18. The method claim 13, machine being a dynamic register machine, which runs set of dynamic register machine instructions, the dynamic register machine instructions being arranged in a sequence in which the dynamic register machine instructions are run, the dynamic register machine instructions are different than the collection of pairs of nodes being performed and are different than the computer program from which the collection of nodes are being formed; as part of running the dynamic register machine instructions, the dynamic register machine alters the dynamic register machine instructions as the dynamic register machine instructions are running.
